(19) United States
(12) Patent Application Publication
(10) Pub. No.: US 2025/0308817 A1
(43) Pub. Date: Oct. 2, 2025

(54) OPERATION MECHANISM CAPABLE OF BEING OPERATED AT MULTIPLE SIDES, ISOLATION SWITCH AND SWITCH APPLIANCE

(71) Applicant: SHANGHAI LIANGXIN ELECTRICAL CO., LTD, Shanghai (CN)

(72) Inventors: Qingsong Fu, Shanghai (CN); Shanbo Ren, Shanghai (CN); Zuoyong Gong, Shanghai (CN); Li Ba, Shanghai (CN)

(21) Appl. No.: 18/864,032

(22) PCT Filed: May 11, 2023
(86) PCT No.: PCT/CN2023/093413

§ 371 Date: Nov. 8, 2024

(30) Foreign Application Priority Data
May 11, 2022 (CN) 202210513281.5
May 11, 2022 (CN) 202221208556.6
May 12, 2022 (CN) 202210518964.X
May 12, 2022 (CN) 202210520648.6
Aug. 17, 2022 (CN) 202222171077.8
Dec. 9, 2022 (CN) 202223315680.5
Feb. 22, 2023 (CN) 202320294427.1
Apr. 26, 2023 (CN) 202320983774.5

(51) Int. Cl. H01H 21/36; H01H 9/26; H01H 9/44; H01H 21/22

(52) U.S. Cl. CPC H01H 21/36; H01H 9/26; H01H 9/44; H01H 21/22

(57) ABSTRACT

Provided in the present application are an operation mechanism capable of being operated at multiple sides, an isolation switch and a switch appliance, relating to the technical field of low-voltage appliances. A user can perform corresponding operation on the operation mechanism capable of being operated at multiple sides on different sides of the isolation switch, so as to achieve switching-on and switching-off control of the isolation switch. On the basis, each operation assembly in the operation mechanism capable of being operated at multiple sides can keep a stable and reliable transmission relationship with a transmission part, and then the problem of transmission failure or even jamming caused by the fact that the transmission part moves excessively and is separated from the operation assembly is avoided.

### CROSS-REFERENCE TO RELATED APPLICATION

The present disclosure claims priorities of Chinese patent application No. 2022105132815, filed with the Chinese Patent Office on May 11, 2022, entitled “SWITCH UNIT AND SWITCH APPLIANCE”; Chinese patent application No. 2022212085566, filed with the Chinese Patent Office on May 11, 2022, entitled “CONTACT ASSEMBLY, SWITCH UNIT, AND SWITCH APPLIANCE”; Chinese patent application No. 2022105206486, filed with the Chinese Patent Office on May 12, 2022, entitled “OPERATION MECHANISM CAPABLE OF BEING OPERATED AT MULTIPLE SIDES AND ISOLATION SWITCH”; Chinese patent application No. 202210518964X, filed with the Chinese Patent Office on May 12, 2022, entitled “OPERATION MECHANISM CAPABLE OF BEING OPERATED AT MULTIPLE SIDES AND ISOLATION SWITCH”; Chinese patent application No. 2022221710778, filed with the Chinese Patent Office on Aug. 17, 2022, entitled “SIGNAL TRIGGERING STRUCTURE AND ISOLATION SWITCH”; Chinese patent application No. 2022233156805, filed with the Chinese Patent Office on Dec. 9, 2022, entitled “OPERATION HANDLE AND ISOLATION SWITCH”; Chinese patent application No. 2023209837745, filed with the Chinese Patent Office on Apr. 26, 2023, entitled “AIRTIGHT HANDLE ASSEMBLY AND ISOLATION SWITCH”; and Chinese patent application No. 2023202944271, filed with the Chinese Patent Office on Feb. 22, 2023, entitled “ELECTRICAL OPERATION STRUCTURE OF ISOLATION SWITCH AND ISOLATION SWITCH”.

### TECHNICAL FIELD

The present disclosure relates to the technical field of low-voltage appliances, and specifically to an operation mechanism capable of being operated at multiple sides, an isolation switch, and a switch appliance.

### BACKGROUND ART

With the rapid development of the economy, people's living standards have improved significantly, and they have a more comprehensive understanding of electricity safety. In order to improve electricity safety, an isolation switch is usually accessed to the circuit, so that the appliance device is isolated from the electrical part when maintained by cutting off the power source by the isolation switch, and an effective isolation distance can be kept.

In order to meet the diversity of use scenarios of the isolation switch, multiple operation assemblies are usually distributed at different sides of the isolation switch, so as to control the switching-off and switching-on actions of the isolation switch by driving any one side of the operation assembly when needed, so the multiple operation assemblies must act synchronously. The prior method to keep the multiple operation assemblies acting synchronously usually is that the operation assemblies at different sides all cooperatively transmit with a transmission member. In this way, when the operation assembly at one side acts, operation assemblies at the other side can be driven to move synchronously by the transmission member. However, during actual cooperation, the transmission member is easy to move excessively to separate from the operation assembly, which results in problems of easy transmission failure and even being stuck for the operation assembly.

### SUMMARY

In order to overcome deficiencies in the prior art above, the object of the present disclosure is to provide an operation mechanism capable of being operated at multiple sides, an isolation switch, and a switch appliance.

In order to realize the above object, the technical solutions adopted in the embodiments of the present disclosure are as follows.

One aspect of the embodiments of the present disclosure is to provide an isolation switch including an operation mechanism capable of being operated at multiple sides, wherein the operation mechanism capable of being operated at multiple sides includes a holding assembly, a base, and a front operation assembly and a side operation assembly rotationally arranged on the base, wherein the front operation assembly and the side operation assembly are synchronously in a switching-off or switching-on position by a linkage of a transmission member, and the holding assembly limits the transmission member and the side operation assembly to keep a transmission relationship.

Optionally, the isolation switch further includes a switch unit, and the switch unit includes a unit housing (second housing), a moving contact rotationally arranged in the unit housing, and a static contact and a magnetic assembly fixedly arranged in the unit housing respectively, wherein the moving contact rotates relative to the unit housing to form a curved rotation path that cooperates with the static contact to be switching-off and switching-on and the magnetic assembly is located at an outer side of the curved rotation path, wherein the magnetic assembly includes a first housing and a magnet fixedly arranged in the first housing; a bending plate is arranged on the first housing; and an outer wall of the first housing cooperates with an inner wall of the bending plate to form an airflow channel, wherein the airflow channel is located on the curved rotation path for blowing away an airflow of an electric arc between the moving contact and the static contact.

Optionally, two bending plates are provided, wherein two bending plates are oppositely arranged on two sides of the first housing along a rotation axial direction of the moving contact, and two adjacent side edges of two bending plates cooperate to form a rotation channel for the moving contact to pass through.

Optionally, each bending plate includes a first plate body fixedly connected to the first housing and a second plate body fixedly connected to the first plate body, wherein first plate bodies of two bending plates both extend toward one side close to the rotation axial direction of the moving contact, and second plate bodies of two bending plates both extend toward one side close to each other.

Optionally, the magnet includes a first magnet and a second magnet, wherein the first magnet and the second magnet are arranged in the first housing in a stacked manner along the rotation axial direction of the moving contact, and a magnetic pole of the first magnet close to the second magnet has the same magnetism with a magnetic pole of the second magnet close to the first magnet.

Optionally, the magnetic assembly is located on one side close to the static contact, and the static contact includes an extension part extending into the airflow channel and being located on the curved rotation path.

Optionally, a position limitation part is arranged in the first housing, wherein the position limitation part is configured to limit a movement of the magnet inserted into the first housing; and the magnetic assembly further includes a cover plate, and the first housing is provided with an opening, wherein the magnet passes through the opening to be accommodated in the first housing, and the cover plate covers the first housing to seal the opening.

Optionally, the isolation switch further includes a switch unit including a second housing and a contact assembly, wherein a moving contact of the contact assembly is rotationally mounted in the second housing, and a static contact of the contact assembly is fixedly mounted in the second housing; and the contact assembly includes the moving contact and the static contact, and the moving contact is driven to rotate to cooperate with the static contact for switching off and switching on, wherein when the moving contact and the static contact switch between states of the switching off and the switching on, one side of the moving contact for contacting the static contact and one side of the static contact for contacting the moving contact are parallel to each other or basically parallel.

Optionally, one side of the static contact for contacting the moving contact includes a first contact segment and a second contact segment connected to the first contact segment, wherein when the moving contact and the static contact switch between the states of the switching off and the switching on, one side of the moving contact for contacting the static contact and the first contact segment are parallel to each other or basically parallel, and spacing between one side of the second contact segment close to the first contact segment and the moving contact is smaller than spacing between one side of the second contact segment away from the first contact segment and the moving contact.

Optionally, spacing between the second contact segment and the moving contact is gradually increased along one side of the second contact segment close to the first contact segment to one side of the second contact segment away from the first contact segment.

Optionally, one side of the static contact for contacting the moving contact further includes a third contact segment connected to the first contact segment, wherein the third contact segment is located on one side of the first contact segment away from the second contact segment, and when the moving contact and the static contact switch between the states of the switching off and the switching on, spacing between one end of the third contact segment close to the first contact segment and the moving contact is smaller than spacing between one side of the third contact segment away from the second contact segment and the moving contact.

Optionally, the isolation switch further includes an electrical operation module sequentially connected to the operation mechanism, wherein the electrical operation module drives the operation mechanism to act; the electrical operation module is in transmission with the operation mechanism by a splicing structure; and the electrical operation module includes a motor, a gear assembly, and a shaft assembly connected sequentially, wherein the shaft assembly includes a second shaft connected to the gear assembly and a first shaft connected to the operation mechanism, and the first shaft and the second shaft are coaxially connected; the motor drives the operation mechanism to act by the gear assembly, the second shaft, and the first shaft sequentially; and the first shaft is in linkage with a first microswitch and a second microswitch, wherein when the isolation switch is switching-off or switching-on, the first microswitch or second microswitch is configured to output signals to the motor, and the motor stops running.

Optionally, the isolation switch further includes a signal triggering structure, and the signal triggering structure includes a third housing, and a rotary shaft and a third microswitch arranged in the third housing, wherein the third microswitch is fixedly connected to a side wall of the third housing; the rotary shaft is provided with a boss in a radial direction; and the third microswitch is provided with a button on a side surface for controlling opening and closing of the third microswitch, wherein the rotary shaft is driven to rotate the boss, and the boss pushes the button to press the button; a first sliding plate is arranged on one side of the rotary shaft corresponding to the boss; a side surface of the first sliding plate is provided with a pressing part; and the boss presses the button by the pressing part, wherein the boss is driven to rotate to push the first sliding plate to move in a direction away from the rotary shaft, so that the pressing part presses the button; and an elastic member is arranged between one side of the first sliding plate away from the rotary shaft and housing, wherein when the boss pushes the first sliding plate to move in the direction away from the rotary shaft, the elastic member accumulates an elastic potential energy.

Optionally, the isolation switch further includes an operation handle, and the operation handle includes a base, a first sealing member, a second sealing member, and a body rotationally connected to the base, wherein the base is fixedly connected to a cabinet body at one side away from the body and sealed by the first sealing member, and the second sealing member is arranged between the body and the base; one side of the body close to the base is provided with a limiting hole adapted to a main shaft of the isolation switch, and the base is provided with a first through hole communicated with the limiting hole and for the main shaft to pass through; and the body is driven to rotate on the base, and the main shaft can drive the isolation switch to switch on or switch off.

Optionally, the operation handle further includes a locking mechanism arranged on the body, and the locking mechanism is configured to lock or unlock the body; a blind hole is concavely arranged on one surface of the base close to the body, wherein when the isolation switch is at a switching-on position, a stopper of the locking mechanism passes through the body and is located outside the blind hole; and when the isolation switch is at a switching-off position, the stopper passes through the body and can at least partially extend into the blind hole to lock the body when driven, wherein the body is provided with an accommodation chamber and a stop hole communicated with the accommodation chamber; and the locking mechanism includes a latch located in the accommodation chamber and rotationally connected to the body and a stopper passing through the stop hole, wherein when the isolation switch is at the switching-on position, one end of the stopper abuts against the latch, and the other end abuts against one surface of the base facing the body; when the body is driven to rotate so that the stop hole is corresponding to the blind hole, the latch is driven to rotate relative to the body; and when the isolation switch is at the switching-off position, the latch can drive the stopper to move towards the base and the stopper is partially snapped in the blind hole.

Optionally, the isolation switch further includes an airtight handle assembly, and the airtight handle assembly includes an operation handle, a stopper, and at least two reset members, wherein one end of the reset members is fixed on the stopper and the other end is fixed on the operation handle; the operation handle is configured to drivingly connect to the operation mechanism, and the operation handle is provided with a through hole; and the stopper reciprocally slides in the through hole, and two ends of a sliding path of the stopper correspond to a first position and a second position respectively, wherein when the stopper is at the first position, the reset member is in a natural state, and the operation handle can rotate reciprocally, so as to switch between a switching-on state and a switching-off state; and when the stopper leaves the first position, the reset member is compressed, and the operation handle is fixed by the stopper, wherein the stopper switches between the first position and the second position, so as to switch between the switching-off state and the switching-off padlock state, wherein a sealing structure is arranged between the stopper and the through hole, and at least two reset members are evenly arranged around the sealing structure, wherein when the stopper switches between the first position and the second position, the sealing structure is at least partially located in the through hole and wraps the stopper, so to seal a gap between the stopper and the through hole.

Another aspect of embodiments of the present disclosure is to provide an operation mechanism capable of being operated at multiple sides, including a base and a front operation assembly and a side operation assembly rotationally arranged on the base, wherein the front operation assembly is in linkage with the side operation assembly by the transmission member to be synchronously on the switching-off or switching-on position; and the base is provided with an elastic assembly cooperating with the transmission member, wherein the elastic assembly deforms to provide a force to the transmission member, so that transmission member and the side operation assembly keep a transmission relationship.

Optionally, the side operation assembly is provided with a first transmission part, and the transmission member is provided with a first mating part cooperating with the first transmission part, wherein the side operation assembly is configured to drive the transmission member to slide relative to the base via the first transmission part and the first mating part cooperating with each other, and the elastic assembly is configured to abut against the transmission member to deform when the side operation assembly is at the switching-off position or switching-on position, so that the first mating part cooperates with the first transmission part.

Optionally, the elastic assembly includes a switching-on elastic assembly and a switching-off elastic assembly arranged on the base, wherein the switching-on elastic assembly is configured to provide a force to the transmission member when the side operation assembly is at the switching-on position, and the switching-off elastic assembly is configured to provide a force to the transmission member when the side operation assembly is at the switching-off position.

Optionally, the switching-on elastic assembly and the switching-off elastic assembly are separately arranged on two opposite sides of the transmission member, and both the switching-on elastic assembly and the switching-off elastic assembly are arranged on the sliding path of the transmission member.

Optionally, the first transmission part is a transmission groove arranged on the side operation assembly, and the first mating part is a protrusion arranged on the transmission member, wherein the side operation assembly drives the protrusion via a groove wall of the transmission groove, so as to drive the transmission member to slide relative to the base.

Optionally, the elastic assembly includes a spiral spring and a mounting base snapped to the base, and a mounting part is arranged on the mounting base, wherein one end part of the spiral spring is sleeved on an outer periphery of the mounting part and in interference fit with the mounting part, and the other end of the spiral spring cooperates with the transmission member.

Optionally, the elastic assembly includes a snapping member, an elastic plate, and a mounting base snapped to the base, wherein the snapping member is configured to snap a fixing end of the elastic plate to the mounting base, and a free end of the elastic plate cooperates with the transmission member.

Another aspect of embodiments of the present disclosure is to provide an operation mechanism capable of being operated at multiple sides, including the base and the front operation assembly and the side operation assembly rotationally arranged on the base, wherein the front operation assembly is in linkage with the side operation assembly by the transmission member to be synchronously on the switching-off or switching-on position; and the side operation assembly is provided with an abutting part cooperating with the transmission member, and the abutting part limits the transmission member and the side operation assembly to keep a transmission relationship.

Optionally, the side operation assembly is provided with a first transmission part with a transmission wall; the transmission member is provided with a first mating part; and the first mating part is provided with a mating wall cooperating with the transmission wall, wherein the side operation assembly is configured to drive the transmission member to slide relative to the base via the transmission wall and the mating wall cooperating with each other, and the abutting part is configured to abut against the transmission member when the side operation assembly is at the switching-off position or the switching-on position, so to limit the mating wall to locate at a rotation path of the transmission wall.

Optionally, the abutting part includes a switching-on abutting part and a switching-off abutting part separately arranged on the side operation assembly, wherein the switching-on abutting part is configured to abut against one end of the transmission member to limit a position when the side operation assembly is at the switching-on position, and the switching-off abutting part is configured to abut against the other end of the transmission member to limit a position when the side operation assembly is at the switching-off position.

Optionally, the first transmission part is the transmission groove arranged on the side operation assembly, and the first mating part is the protrusion arranged on the transmission member, wherein the transmission wall includes two opposite groove walls of the transmission groove; the mating wall includes two opposite side walls of the protrusion; and the two groove walls of the transmission groove cooperate with the two side walls of the protrusion in a one-to-one transmission method.

Optionally, the abutting part is a protrusion lug, and an accommodating hole for accommodating the protrusion lug is arranged on the transmission member, wherein the protrusion lug is configured to abut against a hole wall of the accommodating hole when the side operation assembly is at the switching-off position or the switching-on position, so as to limit the transmission member and the side operation assembly to be in transmission.

Optionally, a rotation axis of the front operation assembly is perpendicular to that of the side operation assembly, and the front operation assembly includes a rotary shaft rotationally arranged on the base and an extension member fixedly arranged on the rotary shaft, wherein the extension member is provided with a second transmission part, and the transmission member is provided with a second mating part cooperating with the second transmission part.

Another aspect of the embodiments of the present disclosure is to provide an isolation switch including a switch body and any one of the above operation mechanisms capable of being operated at multiple sides, wherein the operation mechanism capable of being operated at multiple sides and the switch body are arranged in the stacked manner, and the operation mechanism capable of being operated at multiple sides is drivingly connected to the moving contact in the switch body.

Another aspect of the embodiments of the present disclosure is to provide a switch appliance (isolation switch) including the operation mechanism and the switch unit, wherein a plurality of switch units are provided, and the plurality of switch units are sequentially arranged in the stacked manner; and the operation mechanism is drivingly connected to the moving contacts of each switch unit and is configured to drive moving contacts of the plurality of switch units to rotate synchronously, wherein the switch unit includes a unit housing, the moving contact rotationally arranged in the unit housing, and a static contact and a magnetic assembly fixedly arranged in the unit housing respectively; the moving contact rotates relative to the unit housing to form a curved rotation path cooperating with the switching off and the switching on of the static contact; and the magnetic assembly is located at the outer side of the curved rotation path, wherein the magnetic assembly includes a first housing and a magnet fixedly arranged in the first housing; a bending plate is arranged on the first housing; and the outer wall of the first housing cooperates with the inner wall of the bending plate to form the airflow channel, wherein the airflow channel is located on the curved rotation path for blowing away the airflow of the electric arc between the moving contact and the static contact.

Optionally, two bending plates are provided, wherein two bending plates are oppositely arranged on two sides of the first housing along the rotation axial direction of the moving contact, and two adjacent side edges of two bending plates cooperate to form the rotation channel for the moving contact to pass through.

Optionally, each bending plate includes the first plate body fixedly connected to the first housing and the second plate body fixedly connected to the first plate body, wherein the first plate bodies of two bending plates both extend toward one side close to the rotation axial direction of the moving contact, and the second plate bodies of two bending plates both extend toward one side close to each other.

Optionally, the magnet includes a first magnet and a second magnet, wherein the first magnet and the second magnet are arranged in the first housing in a stacked manner along the rotation axial direction of the moving contact, and a magnetic pole of the first magnet close to the second magnet has the same magnetism with a magnetic pole of the second magnet close to the first magnet.

Optionally, the magnetic assembly is located on one side close to the static contact, and the static contact includes an extension part extending into the airflow channel and being located on the curved rotation path.

Optionally, the position limitation part is arranged in the first housing, wherein the position limitation part is configured to limit the movement of the magnet inserted into the first housing; and the magnetic assembly further includes the cover plate, and the first housing is provided with the opening, wherein the magnet passes through the opening to be accommodated in the first housing, and the cover plate covers the first housing to seal the opening.

Another aspect of the embodiments of the present disclosure is to provide a switch appliance including the operation mechanism and the switch unit, wherein a plurality of switch units are provided, and the plurality of switch units are sequentially arranged in the stacked manner; and the operation mechanism is drivingly connected to the moving contacts of each switch unit and is configured to drive moving contacts of the plurality of switch units to rotate synchronously, wherein the switch unit includes the second housing and the contact assembly; the moving contact of the contact assembly is rotationally mounted in the second housing; and the static contact of the contact assembly is fixedly mounted in the second housing, wherein the contact assembly includes the moving contact and the static contact, and the moving contact is driven to rotate to cooperate with the static contact for switching on and switching off, wherein when the moving contact and the static contact switch between states of the switching off and the switching on, one side of the moving contact for contacting the static contact and one side of the static contact for contacting the moving contact are parallel to each other or basically parallel.

Optionally, one side of the static contact for contacting the moving contact includes a first contact segment and a second contact segment connected to the first contact segment, wherein when the moving contact and the static contact switch between the states of the switching off and the switching on, one side of the moving contact for contacting the static contact and the first contact segment are parallel to each other or basically parallel, and spacing between one side of the second contact segment close to the first contact segment and the moving contact is smaller than spacing between one side of the second contact segment away from the first contact segment and the moving contact.

Optionally, the spacing between the second contact segment and the moving contact is gradually increased along one side of the second contact segment close to the first contact segment to one side of the second contact segment away from the first contact segment.

Optionally, one side of the static contact for contacting the moving contact further includes a third contact segment connected to the first contact segment, wherein the third contact segment is located on one side of the first contact segment away from the second contact segment, and when the moving contact and the static contact switch between the states of the switching off and the switching on, spacing between one end of the third contact segment close to the first contact segment and the moving contact is smaller than spacing between one side of the third contact segment away from the second contact segment and the moving contact.

Another aspect of the embodiments of the present disclosure is to provide an isolation switch including a handle and an electrical operation structure of the isolation switch connected sequentially, and a switch unit, wherein the handle is configured to drive the isolation switch to be switching-off or switching-on; the electrical operation structure of the isolation switch includes an electrical operation module and the operation mechanism connected sequentially, wherein the electrical operation module drives the operation mechanism to act; the electrical operation module is in transmission with the operation mechanism by the splicing structure; and the electrical operation module includes a motor, a gear assembly, and a shaft assembly connected sequentially, wherein the shaft assembly includes a second shaft connected to the gear assembly and a first shaft connected to the operation mechanism, and the first shaft and the second shaft are coaxially connected; the motor drives the operation mechanism to act by the gear assembly, the second shaft, and the first shaft sequentially; and the first shaft is in linkage with a first microswitch and a second microswitch, wherein when the isolation switch is switching-off or switching-on, the first microswitch or second microswitch is configured to output signals to the motor, and the motor stops running.

Another aspect of the embodiments of the present disclosure is to provide an isolation switch including a signal triggering structure and a switch unit connected to the signal triggering structure, wherein a microswitch of the signal triggering structure indicates the states of switching off and switching on for the switch unit, and the signal triggering structure includes the third housing, and the rotary shaft and the third microswitch arranged in the third housing, wherein the third microswitch is fixedly connected to the side wall of the third housing; the boss is arranged on the rotary shaft in the radial direction; and the third microswitch is provided with a button on a side surface for controlling opening and closing of the third microswitch, wherein the rotary shaft is driven to rotate the boss, and the boss pushes the button to press the button; the first sliding plate is arranged on one side of the rotary shaft corresponding to the boss; the side surface of the first sliding plate is provided with the pressing part; and the boss presses the button by the pressing part, wherein the boss is driven to rotate to push the first sliding plate to move in the direction away from the rotary shaft, so that the pressing part presses the button; and the elastic member is arranged between one side of the first sliding plate away from the rotary shaft and housing, wherein when the boss pushes the first sliding plate to move in the direction away from the rotary shaft, the elastic member accumulates the elastic potential energy.

Another aspect of the embodiments of the present disclosure is to provide an isolation switch including an operation mechanism, a contact unit, and an operation handle, wherein the operation handle and the operation mechanism are drivingly connected; the operation mechanism and the contact unit are drivingly connected; and the operation handle can drive the contact unit to switch on or switch off by driving the operation mechanism to move, wherein the operation handle includes the base, the first sealing member, the second sealing member, and the body rotationally connected to the base; the base is fixedly connected to a cabinet body at one side away from the body and sealed by the first sealing member, and the second sealing member is arranged between the body and the base; one side of the body close to the base is provided with a limiting hole adapted to a main shaft of the isolation switch, and the base is provided with a first through hole communicated with the limiting hole and for the main shaft to pass through; and the body is driven to rotate on the base, and the main shaft can drive the isolation switch to switch on or switch off.

Optionally, the operation handle further includes a locking mechanism arranged on the body, and the locking mechanism is configured to lock or unlock the body; a blind hole is concavely arranged on one surface of the base close to the body, wherein when the isolation switch is at the switching-on position, the stopper of the locking mechanism passes through the body and is located outside the blind hole; and when the isolation switch is at the switching-off position, the stopper passes through the body and can at least partially extend into the blind hole to lock the body when driven, wherein the body is provided with the accommodation chamber and the stop hole communicated with the accommodation chamber; and the locking mechanism includes the latch located in the accommodation chamber and rotationally connected to the body and the stopper passing through the stop hole, wherein when the isolation switch is at the switching-on position, one end of the stopper abuts against the latch, and the other end abuts against one surface of the base facing the body; when the body is driven to rotate so that the stop hole is corresponding to the blind hole, the latch is driven to rotate relative to the body; and when the isolation switch is at the switching-off position, the latch can drive the stopper to move towards the base and the stopper is partially snapped in the blind hole.

Another aspect of the embodiments of the present disclosure is to provide an isolation switch including the operation mechanism, the contact unit, and the airtight handle assembly, wherein the operation mechanism is drivingly connected to the contact unit, and the operation handle in the airtight handle assembly can drive the contact unit to switch on or switch off by driving the operation mechanism to move, wherein the airtight handle assembly includes the operation handle, the stopper, and at least two reset members, wherein one end of the reset members is fixed on the stopper and the other end is fixed on the operation handle; the operation handle is configured to drivingly connect to the operation mechanism, and the operation handle is provided with the through hole; and the stopper reciprocally slides in the through hole, and two ends of the sliding path of the stopper correspond to the first position and the second position respectively, wherein when the stopper is at the first position, the reset member is in a natural state, and the operation handle can rotate reciprocally, so as to switch between a switching-on state and a switching-off state; and when the stopper leaves the first position, the reset member is compressed, and the operation handle is fixed by the stopper, wherein the stopper switches between the first position and the second position, so as to switch between the switching-off state and the switching-off padlock state, wherein the sealing structure is arranged between the stopper and the through hole, and at least two reset members are evenly arranged around the sealing structure, wherein when the stopper switches between the first position and the second position, the sealing structure is at least partially located in the through hole and wraps the stopper, so to seal the gap between the stopper and the through hole.

The present disclosure includes the following beneficial effects.

The present disclosure provides an operation mechanism capable of being operated at multiple sides, an isolation switch, and a switch appliance, wherein the user can perform corresponding operation on the operation mechanism capable of being operated at multiple sides on different sides of the isolation switch, so as to realize the switching-on and switching-off control of the isolation switch. On this basis, each operation assembly and transmission member in the operation mechanism capable of being operated at multiple sides can keep a stable and reliable transmission relationship in the present disclosure, and then the problems of transmission failure or even jamming caused by the fact that the transmission member moves excessively to be separated from the operation assembly is avoided.

### BRIEF DESCRIPTION OF DRAWINGS

In order to more clearly illustrate the technical solutions in the embodiments of the present disclosure, the drawings to be used in the embodiments will be briefly introduced below. It should be understood that the following drawings only show certain embodiments of the present disclosure, and therefore should not be regarded as a limitation of the scope. For a person of ordinary skill in the art, other relevant drawings can be obtained according to these drawings without inventive efforts.

FIG. 1 shows a structure schematic diagram of an isolation switch provided by the embodiments of the present disclosure;

FIG. 2 shows a structure schematic diagram of an operation mechanism capable of being operated at multiple sides provided by the embodiments of the present disclosure;

FIG. 3 shows another structure schematic diagram of an operation mechanism capable of being operated at multiple sides provided by the embodiments of the present disclosure;

FIG. 4 shows another structure schematic diagram of an operation mechanism capable of being operated at multiple sides provided by the embodiments of the present disclosure;

FIG. 5 shows an explosion diagram of an operation mechanism capable of being operated at multiple sides provided by the embodiments of the present disclosure;

FIG. 6 shows a matching schematic diagram of a side operation assembly and a transmission member provided by the embodiments of the present disclosure;

FIG. 7 shows another matching schematic diagram of a side operation assembly and a transmission member provided by the embodiments of the present disclosure;

FIG. 8 shows a matching sectional diagram of a side operation assembly and a transmission member provided by the embodiments of the present disclosure;

FIG. 9 shows a structure schematic diagram of an elastic assembly provided by the embodiments of the present disclosure;

FIG. 10 shows another structure schematic diagram of an elastic assembly provided by the embodiments of the present disclosure;

FIG. 11 shows a structure schematic diagram of a spiral spring provided by the embodiments of the present disclosure;

FIG. 12 shows a matching schematic diagram of a front operation assembly and a transmission member provided by the embodiments of the present disclosure;

FIG. 13 shows an explosion diagram of another operation mechanism capable of being operated at multiple sides provided by embodiments of the present disclosure;

FIG. 14 shows another structure schematic diagram of another operation mechanism capable of being operated at multiple sides provided by the embodiments of the present disclosure;

FIG. 15 shows another structure schematic diagram of another operation mechanism capable of being operated at multiple sides provided by the embodiments of the present disclosure;

FIG. 16 shows another explosion diagram of another operation mechanism capable of being operated at multiple sides provided by embodiments of the present disclosure;

FIG. 17 shows a matching schematic diagram of another side operation assembly and transmission member provided by the embodiments of the present disclosure;

FIG. 18 shows a matching sectional diagram of another side operation assembly and transmission member provided by the embodiments of the present disclosure;

FIG. 19 shows a structure schematic diagram of an electrical operation structure of an isolation switch provided by the embodiments of the present disclosure when it is switching-on;

FIG. 20 shows a structure schematic diagram of an electrical operation structure of an isolation switch provided by the embodiments of the present disclosure when it is switching-off;

FIG. 21 shows another structure schematic diagram of an electrical operation structure of an isolation switch provided by the embodiments of the present disclosure when it is switching-off;

FIG. 22 shows a structure schematic diagram of an electrical operation module of an electrical operation structure of an isolation switch provided by the embodiments of the present disclosure when it is switching-off;

FIG. 23 shows a structure schematic diagram of an operation mechanism of an electrical operation structure of an isolation switch provided by the embodiments of the present disclosure when it is switching-off;

FIG. 24 shows an internal structure schematic diagram of an operation mechanism of an electrical operation structure of an isolation switch provided by the embodiments of the present disclosure when it is switching-off;

FIG. 25 shows another internal structure schematic diagram of an operation mechanism of an electrical operation structure of an isolation switch provided by the embodiments of the present disclosure when it is switching-off;

FIG. 26 shows another internal structure schematic diagram of an operation mechanism of an electrical operation structure of an isolation switch provided by the embodiments of the present disclosure when it is switching-off;

FIG. 27 shows another internal structure schematic diagram of an operation mechanism of an electrical operation structure of an isolation switch provided by the embodiments of the present disclosure when it is switching-off;

FIG. 28 shows an internal structure schematic diagram of an electrical operation module of an electrical operation structure of an isolation switch provided by the embodiments of the present disclosure when it is switching-off;

FIG. 29 shows another internal structure schematic diagram of an electrical operation module of an electrical operation structure of an isolation switch provided by the embodiments of the present disclosure when it is switching-off;

FIG. 30 shows another internal structure schematic diagram of an electrical operation module of an electrical operation structure of an isolation switch provided by the embodiments of the present disclosure when it is switching-off;

FIG. 31 shows a structure schematic diagram of a first shaft of an electrical operation structure of an isolation switch provided by the embodiments of the present disclosure when it is switching-off;

FIG. 32 shows an internal structure schematic diagram of an operation mechanism of an electrical operation structure of an isolation switch provided by the embodiments of the present disclosure when it is switching-on;

FIG. 33 shows an internal structure schematic diagram of an electrical operation module of an electrical operation structure of an isolation switch provided by the embodiments of the present disclosure when it is switching-on;

FIG. 34 shows another internal structure schematic diagram of an electrical operation module of an electrical operation structure of an isolation switch provided by the embodiments of the present disclosure when it is switching-on;

FIG. 35 shows a schematic diagram of another isolation switch provided by the embodiments of the present disclosure;

FIG. 36 shows a structure schematic diagram of a signal triggering structure provided by the embodiments of the present disclosure;

FIG. 37 shows a structure schematic diagram of another signal triggering structure provided by the embodiments of the present disclosure;

FIG. 38 shows another structure schematic diagram of another signal triggering structure provided by the embodiments of the present disclosure;

FIG. 39 shows another structure schematic diagram of a signal triggering structure provided by the embodiments of the present disclosure;

FIG. 40 shows a structure schematic diagram of a first sliding plate provided by the embodiments of the present disclosure;

FIG. 41 shows a structure schematic diagram of a microswitch provided by the embodiments of the present disclosure;

FIG. 42 shows a structure schematic diagram of another signal triggering structure provided by the embodiments of the present disclosure;

FIG. 43 shows another structure schematic diagram of another signal triggering structure provided by the embodiments of the present disclosure;

FIG. 44 shows a structure schematic diagram of an operation handle provided by the embodiments of the present disclosure when it is switching-on;

FIG. 45 shows a structure schematic diagram of an operation handle provided by the embodiments of the present disclosure when it is switching-off;

FIG. 46 shows another structure schematic diagram of an operation handle provided by the embodiments of the present disclosure when it is switching-off;

FIG. 47 shows a structure schematic diagram of an operation handle provided by the embodiments of the present disclosure when it is switching-on and locked;

FIG. 48 shows a structure schematic diagram of a base of an operation handle provided by the embodiments of the present disclosure;

FIG. 49 shows a structure schematic diagram of an operation handle body provided by the embodiments of the present disclosure;

FIG. 50 shows a structure schematic diagram of a locking mechanism, a main shaft, a pressure plate, a casing, and a cabinet body of an operation handle provided by the embodiments of the present disclosure:

FIG. 51 shows a sectional diagram of an airtight handle assembly in a switching-on state provided by the embodiments of the present disclosure;

FIG. 52 shows a partial sectional diagram of an airtight handle assembly in a switching-on state provided by the embodiments of the present disclosure;

FIG. 53 shows a schematic diagram of a stopper in an airtight handle assembly matching with a spring provided by the embodiments of the present disclosure;

FIG. 54 shows another partial sectional diagram of an airtight handle assembly in a switching-on state provided by the embodiments of the present disclosure;

FIG. 55 shows a partial sectional diagram of an airtight handle assembly in a switching-off state provided by the embodiments of the present disclosure;

FIG. 56 shows a partial sectional diagram of an airtight handle assembly provided by the embodiments of the present disclosure when it is in a switching-off padlock state;

FIG. 57 shows a structure schematic diagram of a switch unit provided by the embodiments of the present disclosure;

FIG. 58 shows another structure schematic diagram of a switch unit provided by the embodiments of the present disclosure;

FIG. 59 shows a structure schematic diagram of a moving contact and a static contact in a switching-off state provided by the embodiments of the present disclosure;

FIG. 60 shows a structure schematic diagram of a moving contact and a static contact in a switching-on state provided by the embodiments of the present disclosure;

FIG. 61 shows a structure schematic diagram of a moving contact and a static contact when shifting between a switching-off state and a switching-on state provided by the embodiments of the present disclosure;

FIG. 62 shows a structure schematic diagram of a magnetic assembly provided by the embodiments of the present disclosure;

FIG. 63 shows another structure schematic diagram of a magnetic assembly provided by the embodiments of the present disclosure;

FIG. 64 shows another structure schematic diagram of a magnetic assembly provided by the embodiments of the present disclosure;

FIG. 65 shows another structure schematic diagram of a magnetic assembly provided by the embodiments of the present disclosure;

FIG. 66 shows a structure schematic diagram of a moving contact and a static contact in a switching-off state provided by the embodiments of the present disclosure;

FIG. 67 shows a structure schematic diagram of a moving contact and a static contact in a switching-on state provided by the embodiments of the present disclosure;

FIG. 68 shows a structure schematic diagram of a moving contact and a static contact when shifting between a switching-off state and a switching-on state provided by the embodiments of the present disclosure;

FIG. 69 shows a structure schematic diagram of a static contact provided by the embodiments of the present disclosure;

FIG. 70 shows a structure schematic diagram of a contact assembly provided by the embodiments of the present disclosure;

FIG. 71 shows another structure schematic diagram of a contact assembly provided by the embodiments of the present disclosure;

FIG. 72 shows another structure schematic diagram of a contact assembly provided by the embodiments of the present disclosure; and

FIG. 73 shows a structure schematic diagram of a switch unit provided by the embodiments of the present disclosure.

Reference numbers: 101—side operation assembly; 102—operation mechanism capable of being operated at multiple sides; 103—switch body; 1031—switch unit; 104—front operation assembly; 105—base; 106—second energy—storage assembly; 107—first energy—storage assembly; 108—elastic assembly; 109—extension member; 110—transmission member; 111—first mating part; 112—first transmission part; 113—second mating part; 114—second transmission part; 115—switching-on elastic assembly; 116—switching-off elastic assembly; 117—mounting base; 118—recess part; 119—elastic plate; 120—first groove wall; 121—second groove wall; 122—first side wall; 123—second side wall; 124—snapping member; 125—mounting part; 126—spiral spring; 127—fixing end of the spiral spring; 128—free end of spiral spring; 129—abutting part; 130—switching-on abutting part; 131—switching-off abutting part; 132—accommodating hole; 01—isolation switch; 201—electrical operation structure; 202—fixing shaft; 203—fixing hole; 204—operation mechanism; 205—electrical operation module; 206—handle; 207—mark; 208—housing; 209—third connecting block; 210—second shaft; 211—third shaft; 212—fourth shaft; 213—spring seat; 214—spring; 215—sliding plate; 216—rotary table; 217—first transmission block; 218—protrusion; 219—second connecting block; 220—second transmission block; 221—second groove; 222—through hole; 223—third groove; 224—sliding—plate boss; 225—connecting hole; 226—first microswitch; 227—second microswitch; 228—connecting table; 229—first shaft; 230—second gear; 231—motor; 232—first gear; 233—third gear; 234—handle shaft; 235—first boss; 236—second pendulum rod; 237—first pendulum rod; 238—first groove; 239—first connecting block; 313—signal triggering structure; 305—third housing; 306—first sub—housing; 308—second sub—housing; 304—rotary shaft; 303—boss; 309—limiting table; 307—first sliding plate; 310—pressing part; 312—cylinder member; 301—third microswitch; 302—button; 311—elastic member; 10—base of the handle; 11—first through hole; 12—annular groove; 13—blind hole; 14—oil groove; 20—first sealing member; 30—second sealing member; 40—handle body; 41—position limitation part; 42—annular protrusion; 43—accommodation chamber; 44—stop hole; 45—avoidance groove; 50—pressure plate; 51—avoidance chamber; 60—third sealing member; 70—locking mechanism; 71—latch; 15—lock hole; 72—stopper; 80—fourth sealing member; 90—handle casing; 91—second through hole; 92—avoidance hole; 16—cabinet body; 17—main shaft; 401—airtight handle assembly; 402—operation handle; 403—abutting surface; 404—cylinder part; 405—second sealing ring; 406—through hole; 407—first sealing ring; 408—first annular protrusion; 409—annular sealing ring; 410—second annular protrusion; 411—restoring part; 412—first protrusion; 413—second groove; 414—first spring; 415—first groove; 416—limiting groove; 417—first stop hole; 418—square shaft; 501—magnetic assembly; 502—first housing; 503—bending plate; 504—moving contact; 505—unit housing; 506—static contact; 507—first plate body; 508—second plate body; 509—first snapping part; 510—first magnet; 511—second magnet; 512—second snapping part; 513—cover plate; 515—position limitation part; e—rotation axial direction; f—curved rotation path; c—airflow channel; d—rotation channel; 601—contact assembly; 602—first contact segment; 603—second contact segment; 604—third contact segment; 605—first contact sheet; 606—second contact sheet; 607—first guide part; 608—second guide part; g—rotation direction; and h—contact region.

### DETAILED DESCRIPTION OF EMBODIMENTS

In order to make the purpose, technical solutions, and advantages of the embodiments of the present disclosure clearer, the technical solutions in the embodiments of the present disclosure will be described clearly and completely as follows in conjunction with drawings in the embodiments of the present disclosure. It is clear that the embodiments described are only partial embodiments of the present disclosure, and not all of the embodiments. The components in embodiments of the present disclosure generally described and shown in the drawings herein can be arranged and designed in various different configurations.

Therefore, the following detailed description of the embodiments of the present disclosure arranged in the drawings is not intended to limit the scope of the present disclosure for which protection is claimed, but only represents selected embodiments of the present disclosure. It is to be noted that various features in the embodiments of the present disclosure can be combined with each other without conflict, and the combined embodiments still remain within the scope of protection of the present disclosure.

In the description of the present disclosure, it should be noted that orientations or positional relationships indicated by terms, such as “middle”, “up”, “down”, “left”, and “right”, are the orientations or positional relationships based on the drawings, or the orientation or positional relationship that the product of the present disclosure is customarily placed in use, and therefore is not to be understood as a limitation of the present disclosure. Additionally, the terms “first”, “second”, and “third”, etc., are used only to distinguish descriptions, and are not to be understood as indicating or implying a relative importance.

In the description of the present disclosure, it should further be noted that unless other expressly specifications and limitations, the terms “arrange” and “communicate” are to be understood in a broad sense, e.g., it can be a direct connection, an indirect connection through an intermediate medium, or a communication inside two elements. For a person of ordinary skill in the art, the specific meaning of the above terms in the present disclosure can be understood according to specific situations.

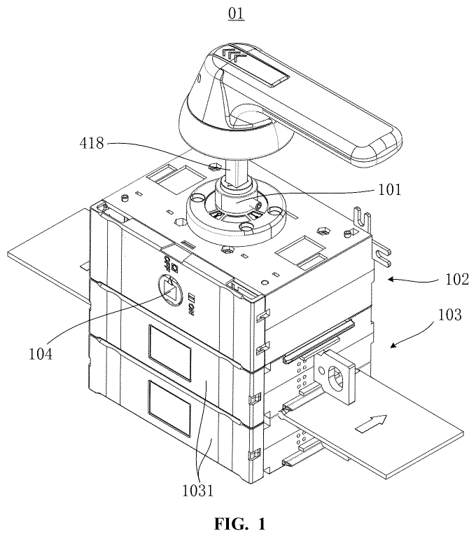

The present disclosure provides an isolation switch 01, for example, as shown in FIG. 1, which includes a switch body 103 and an operation mechanism stacked in sequence, wherein the operation mechanism can drive the switch body 103 to switch on or switch off, and the switch body 103 can include a plurality of stacked switch units 1031. When performing an electric operation, for example, as shown in FIG. 35, an electrical operation module 205 can be arranged on one side of the operation mechanism, wherein the electrical operation module 205 can drive the switch body 103 to switch on or switch off correspondingly according to a remotely issued switching-on or switching-off signal via the operation mechanism. When performing a manual operation, a manual operating member can be added, and the manual operating member can directly drive the switch body 103 to switch on or switch off via the operation mechanism. For example, as shown in FIG. 35, the manual operating member can also be installed on one side of the electrical operation module 205, and then drive the switch body 103 to switch on or switch off after passing through the electrical operation module 205 firstly and then passing through the operation mechanism. The isolation switch 01 and the assembles thereof in the present disclosure will be described in detail below.

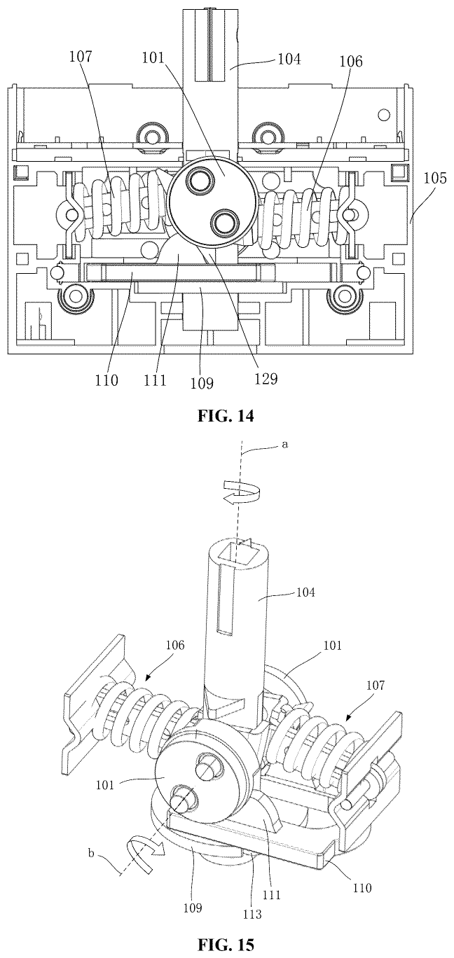

Referring to FIG. 1 to FIG. 18, an isolation switch 01 and the operation mechanism that can be applied in the isolation switch 01 are provided, wherein the operation mechanism is the operation mechanism capable of being operated at multiple sides 102, and the user can perform corresponding operation on the operation mechanism 102 capable of being operated at multiple sides on different sides of the isolation switch 01, so as to realize the switching-on and switching-off control of the isolation switch 01. On the basis, each operation assembly and transmission member 110 in the operation mechanism 102 capable of being operated at multiple sides can keep the stable and reliable transmission relationship in the present disclosure, and then the problem of transmission failure or even jamming caused by the fact that the transmission member 110 moves excessively to be separated from the operation assembly is avoided. The embodiments of the present disclosure will be described below in conjunction with the specific drawings.

As shown in FIG. 1, the isolation switch 01 includes a switch body 103 and the operation mechanism 102 capable of being operated at multiple sides, wherein the operation mechanism 102 capable of being operated at multiple sides and the switch body 103 are arranged in the stacked manner, and the operation mechanism 102 capable of being operated at multiple sides is drivingly connected to a moving contact 504 in the switch body 103. Therefore, when the user operates the operation mechanism, the moving contact 504 in the switch body 103 can be driven to move synchronously. When the moving contact 504 is in contact with a static contact 506 in the switch body 103, the isolation switch 01 is in a switching-on state; and When the moving contact 504 detaches from the static contact 506 in the switch body 103, the isolation switch 01 is in a switching-off state.

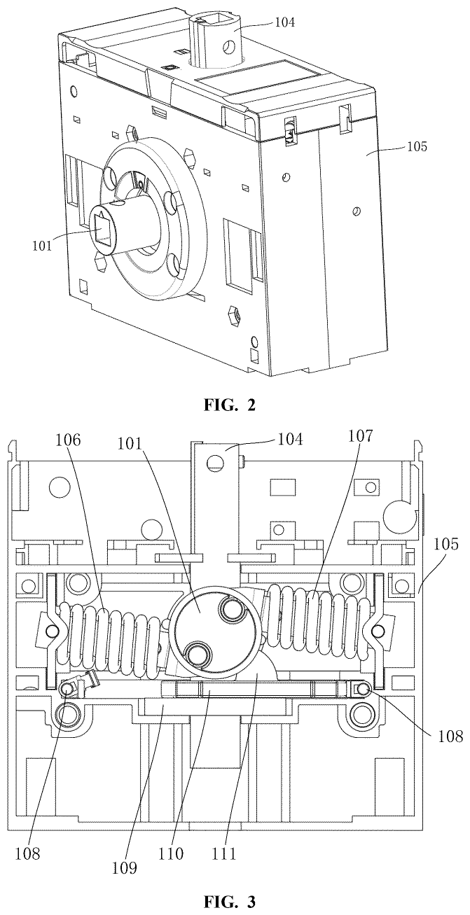

As shown in FIG. 2, an operation mechanism 102 capable of being operated at multiple sides is provided, and it includes a base 105, a transmission member 110, a front operation assembly 104, and a side operation assembly 101, wherein the base 105 can be a base table, or a housing (such as the third housing 305 in the subsequent embodiment, i.e., a housing for accommodating the operation mechanism), which is not specified in the present disclosure. It should be understood that when the base 105 is the housing, the operation mechanism 102 capable of being operated at multiple sides can be protected well, thereby improving the reliability and stability of the isolation switch 01.

The front operation assembly 104 and the side operation assembly 101 are rotationally arranged on the base 105 respectively, wherein the front operation assembly 104 is located on the front surface of the base 105, and the side operation assembly 101 is located on the base 105 at the side surface adjacent to the front surface. Therefore, the user can operate on the operation mechanism 102 capable of being operated at multiple sides at the front surface or the side surface respectively, so as to realize the switching-on action or the switching-off action for the operation mechanism 102 capable of being operated at multiple sides. For example, as shown in FIG. 2, the base 105 is a rectangular housing, wherein the front operation assembly 104 is located at the front surface of the rectangular housing, and the side operation assembly 101 is located on the rectangular housing at the side surface adjacent to the front surface.

In order to ensure the synchronization of the movements for the front operation assembly 104 and the side operation assembly 101, as shown in FIG. 3 or FIG. 13 to FIG. 14, the front operation assembly 104 is in linkage with the side operation assembly 101 by the transmission member 110. Therefore, when the front operation assembly 104 moves toward the switching-on direction, it can drive the side operation assembly 101 by the transmission member 110 to move toward the switching-on direction together. Of course, when the side operation assembly 101 moves toward the switching-on direction, it can also drive the front operation assembly 104 by the transmission member 110 to move toward the switching-on direction together. Similarly, when either the front operation assembly 104 or the side operation assembly 101 moves toward the switching-off direction, they can also keep the synchronized movement by the transmission member 110, i.e., the front operation assembly 104 and the side operation assembly 101 will be synchronously at the switching-on position or the switching-off position.

In order to ensure the reliability and stability of the transmission, the holding assemblies with different structures can be provided to maintain the stable and reliable transmission relationship for each operation assembly and the transmission member 110. For example, FIG. 3 to FIG. 11 show that the holding assembly is disposed to be an elastic assembly 108; and for example, FIG. 13 to FIG. 18 show that the holding assembly is disposed to be an abutting part 129. For ease of understanding, each will be described below.

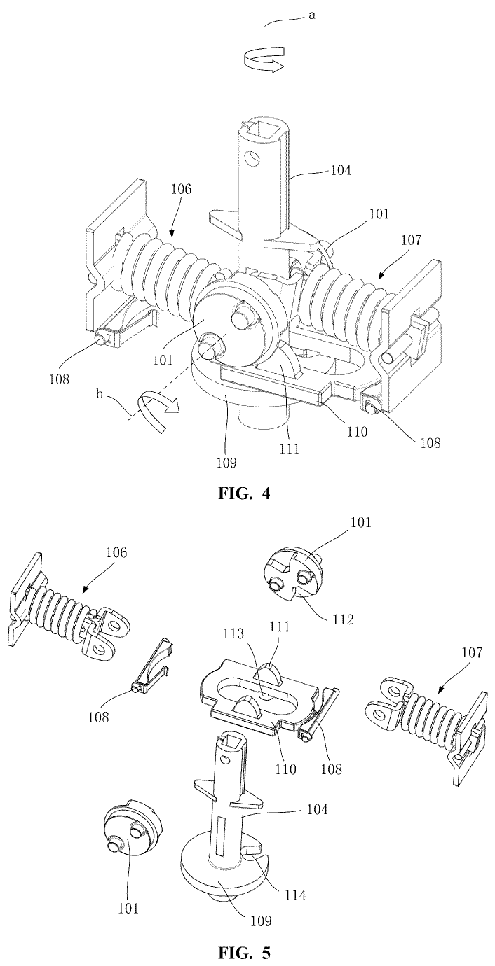

Optionally, when each operation assembly and the transmission member 110 maintain the stable and reliable transmission relationship by the elastic assembly 108, as shown in FIG. 4 and FIG. 5, the base 105 is provided with an elastic assembly 108, wherein the elastic assembly 108 is located on a movement path of the transmission member 110 and cooperates with the transmission member 110. In this way, during the process of the transmission member 110 following the front operation assembly 104 or the side operation assembly 101, the transmission member 110 will be in contact with the elastic assembly 108 and extrude the elastic assembly 108 to deform it. Therefore, on the one hand, the elastic assembly 108 can limit the movement of the transmission member 110 by the force generated by the deformation, so that the transmission member 110 and the side operation assembly 101 can maintain the transmission relationship, which avoids the excessive movement so as to detach from the side operation assembly 101, so that the constrained transmission member 110 can also maintain a transmission relationship with the front operation assembly 104. On the other hand, the elastic assembly 108 can softly limit the transmission member 110, wherein they contact softly during the limiting process, so as to avoid the possible damage caused by hard contact. Additionally, a fit accuracy of the elastic assembly 108 and the transmission member 110 can further be compensated for by the deformation, which reduces the assembly requirement for the elastic assembly 108 and the transmission member 110.

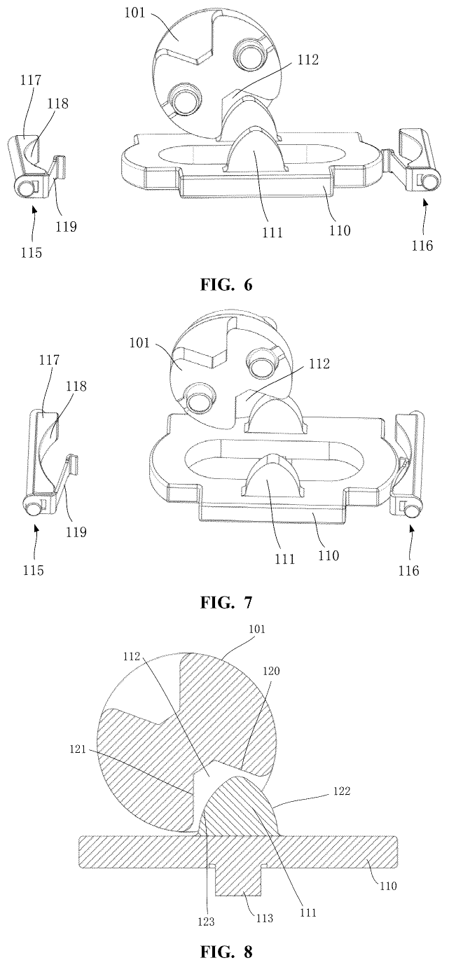

As shown in FIG. 6 or FIG. 7, in order to realize the transmission cooperation between the side operation assembly 101 and the transmission member 110, the side operation assembly 101 can be in transmission with the transmission member 110 by the first transmission part 112 and the first mating part 111.

The side operation assembly 101 is provided with the first transmission part 112, and the transmission member 110 is provided with the first mating part 111. When the side operation assembly 101 acts, the side operation assembly 101 is driven to rotate relative to the base 105, and the first transmission part 112 follows the side operation assembly 101 to rotate. The first transmission part 112 drives the first mating part 111, which in turn drives the transmission member 110 to slide relative to the base 105 (a sliding rail adapted to the transmission member 110 can be arranged on the base 105). When the transmission member 110 slides relative to the base 105, the front operation assembly 104 will also be driven to move synchronously at the same time. Similarly, when the front operation assembly 104 is driven, the transmission member 110 will also be driven to slide, and the side operation assembly 101 is also driven to rotate synchronously. In other words, when the front operation assembly 104 and the side operation assembly 101 rotate synchronously, they can cooperate with different side surfaces of the sliding transmission member 110 respectively, so as to change the rotation direction g.

As shown in FIG. 6 to FIG. 7, when the side operation assembly 101 rotates to the switching-on position, the first transmission part 112 stops moving. The transmission member 110 will contact with the elastic assembly 108 in front of the transmission member 110 and extrude the elastic assembly 108 to deform it at this time. Therefore, the elastic assembly 108 can constrain and limit the continued sliding of the transmission member 110 by the force generated by the deformation. Meanwhile, the first mating part 111 can also keep the transmission relationship with the first transmission part 112 by utilizing the force generated by the elastic assembly 108, which avoids the excessive movement so as to detach from the side operation assembly 101.

Similarly, when the side operation assembly 101 rotates to the switching-off position, the first transmission part 112 stops moving. The transmission member 110 will contact with the elastic assembly 108 in front of the transmission member 110 and extrude the elastic assembly 108 to deform it at this time. Therefore, the elastic assembly 108 can constrain and limit the continued sliding of the transmission member 110 by the force generated by the deformation. Meanwhile, the first mating part 111 can also keep the transmission relationship with the first transmission part 112 by utilizing the force generated by the elastic assembly 108, which avoids the excessive movement so as to detach from the side operation assembly 101.

It should be understood that at the end of the action of the side operation assembly 101 (the switching-on position or the switching-off position is about to be reached), the transmission member 110 may also contact the elastic assembly 108 to deform it.

Specifically, as shown in FIG. 8, the first transmission part 112 is provided with a transmission wall, and the first mating part 111 is provided with a mating wall cooperating with the transmission wall. When the side operation assembly 101 drives the transmission member 110, the transmission fit is realized through that the transmission wall of the first transmission part 112 drives the mating wall of the first mating part 111. The same is true when the transmission member 110 drives the side operation assembly 101.

When the side operation assembly 101 rotates to the switching-on position or the switching-off position, the elastic assembly 108 limits the transmission member 110, so that the first mating part 111 keeps a transmission relationship with the first transmission part 112. That is to say, the mating wall of the first mating part 111 is still located on the rotation path of the transmission wall of the first transmission part 112 at this time, so that when the side operation assembly 101 rotates toward the switching-off position next time, the transmission member 110 can still be driven by the transmission of the first transmission part 112 and the first mating part 111. Thus, the stable and reliable transmission of the side operation assembly 101 and the transmission member 110 is ensured.

As shown in FIG. 6 and FIG. 7, in order to limit both the sliding of the transmission member 110 in the switching-on direction and the sliding in the switching-off direction, two elastic assemblies 108 can further be provided, wherein two elastic assemblies 108 are separately arranged on the switching-on elastic assembly 115 and the switching-off elastic assembly 116 on the base 105. As for the switching-on elastic assembly 115, when the side operation assembly 101 rotates to the switching-on position, the switching-on elastic assembly 115 abuts against one end of the transmission member 110 and provides it with a force, thereby limiting the excessive movement of the transmission member 110; and as for the switching-off elastic assembly 116, when the side operation assembly 101 rotates to the switching-off position, the switching-on elastic assembly 116 abuts against the other end of the transmission member 110 and provides it with a force, thereby limiting the excessive movement of the transmission member 110.

As shown in FIG. 6 and FIG. 7, for ease of fit, the switching-on elastic assembly 115 and the switching-off elastic assembly 116 are separately arranged on two opposite sides of the transmission member 110, and both the switching-on elastic assembly 115 and the switching-off elastic assembly 116 are arranged on the sliding path of the transmission member 110.

Referring to FIG. 6 to FIG. 8, the first transmission part 112 is the transmission groove arranged on the side operation assembly 101, and the first mating part 111 is a protrusion 218 arranged on the transmission member 110, wherein the transmission wall includes two opposite groove walls of the transmission groove (for ease of description, which are referred as the first groove wall 120 and the second groove wall 121 below); and the mating wall includes two opposite side walls of the protrusion 218 (for ease of description, which are referred as the first side wall 122 and the second side wall 123 below).

As shown in FIG. 4, FIG. 7 and FIG. 8, when the side operation assembly 101 rotates toward the switching-on direction (rotates along the arrow direction in FIG. 4), the first groove wall 120 of the transmission groove drives the first side wall 122 of the protrusion 218, and then the transmission member 110 is driven to slide to the left. When the side operation assembly 101 rotates to the switching-on position, in order to avoid the excessive sliding of the transmission member 110, the protrusion 218 is detached from the transmission groove, and the switching-on elastic assembly 115 located on the base 105 abuts against the transmission member 110, so that the second side wall 123 is located on the rotation path of the second groove wall 121 (the first side wall 122 is still located on the rotation path of the first groove wall 120). When the side operation assembly 101 rotates reversely, the second groove wall 121 can drive the second side wall 123, so that the transmission groove can drive the protrusion 218.

When the side operation assembly 101 rotates toward the switching-off direction (rotates along the reverse direction of the arrow in FIG. 4), the second groove wall 121 of the transmission groove drives the second side wall 123 of the protrusion 218, and then the transmission member 110 is driven to slide to the right. When the side operation assembly 101 rotates to the switching-off position, in order to avoid the excessive sliding of the transmission member 110, the protrusion 218 is detached from the transmission groove, and the switching-off elastic assembly 116 located on the base 105 abuts against the transmission member 110, so that the first side wall 122 is located on the rotation path of the first groove wall 120 (the second side wall 123 is still located on the rotation path of the second groove wall 121). When the side operation assembly 101 rotates reversely, the first groove wall 120 can drive the first side wall 122, so that the transmission groove can drive the protrusion 218.

As shown in FIG. 10 and FIG. 11, the switching-on elastic assembly 115 and/or the switching-off elastic assembly 116 includes a mounting base 117 snapped to the base 105 and a spiral spring 126, wherein the mounting base 117 is snapped to the sliding rail of the transmission member 110, so that the spiral spring 126 can be correspondingly located on the sliding path of the transmission member 110. The mounting base 117 is provided with the mounting part 125, wherein one end part of the spiral spring 126 (the fixing end 127 of the spiral spring) is arranged on the outer periphery of the mounting part 125 and in interference fit with the mounting part 125, and the other end of the spiral spring 126 (the free end 128 of the spiral spring) fits with the transmission member 110. During the movement process, the transmission member 110 will contact the other end of the spiral spring 126 and compress the spiral spring 126 to deform it, so that the spiral spring 126 provides a force to it.

As shown in FIG. 10 and FIG. 11, when one end of the spiral spring 126 (the fixing end 127 of the spiral spring) is sleeved on the mounting part 125, the spiral spring 126 sleeved at the position of the mounting part 125 should be combined together, thereby improving the stability of the connection between the spiral spring 126 and the mounting part 125.

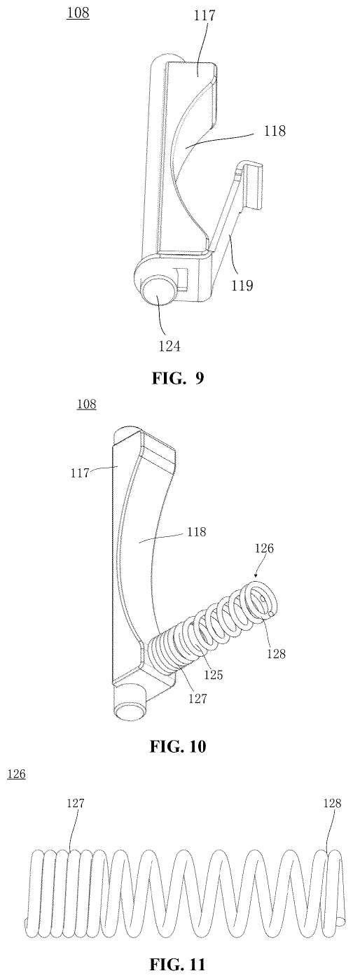

As shown in FIG. 9, the switching-on elastic assembly 115 and/or the switching-off elastic assembly 116 includes a snapping member 124, an elastic plate 119, and a mounting base 117 snapped to the base 105, wherein the snapping member 124 passes through a fixing end of the elastic plate 119 and is snapped to the mounting base 117, so that the elastic plate 119 is fixed to the mounting base 117, and the free end of the elastic plate 119 cooperates with the transmission member 110.

As shown in FIG. 7, the elastic plate 119 is located between the mounting base 117 and the transmission member 110, and a recess part 118 is arranged on one side of the mounting base 117 close to the elastic plate 119, so that during the process of the transmission member 110 extruding the elastic plate 119 to deform, the recess part 118 can provide a contraction space, which facilitates a full soft contact for them.

Referring to FIG. 4, the rotation axis a of the front operation assembly 104 is perpendicular to the rotation axis b of the side operation assembly 101. In other words, the rotary shafts of the front operation assembly 104 and the side operation assembly 101 are perpendicular.

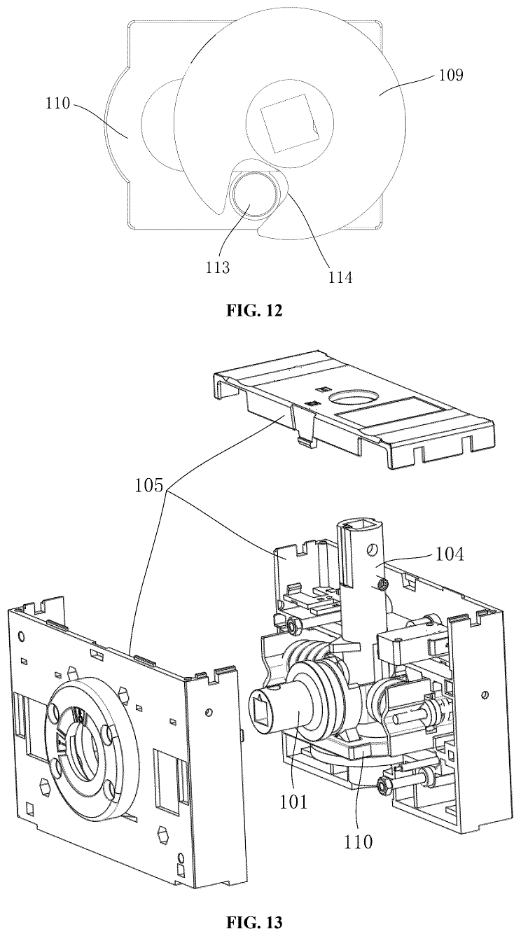

Referring to FIG. 12, the front operation assembly 104 includes a rotary shaft rotationally arranged on the base 105 and an extension member 109 fixedly arranged on the rotary shaft, wherein the extension member 109 is provided with a second transmission part 114, and the transmission member 110 is provided with a second mating part 113 cooperating with the second transmission part 114. For example, the extension member 109 is a disc, wherein the second transmission part 114 is a groove arranged on the disc; the second mating part 113 is a cylinder arranged on the transmission member 110, and the cylinder extends into the groove. Therefore, when the cylinder follows the transmission member 110 to slide relative to the base 105, the cylinder drives the groove, so the front operation assembly 104 rotates; or of course, it also can be that the front operation assembly 104 rotates, and the groove drives the cylinder, so that the transmission member 110 slides relative to the base 105. In another embodiment, the first transmission part 112 can be a first tooth part located on the side operation assembly 101; the second transmission part 114 can be a second tooth part located on the front operation assembly 104; the transmission member 110 can be a rack; the first mating part 111 can be a third tooth part located on the rack; and the second mating part 113 can be a fourth tooth part arranged on the rack, wherein the first tooth part and the third tooth part are engaged in the transmission method; the second tooth part and the fourth tooth part are engaged in the transmission method; and the third tooth part and the fourth tooth part are located on different sides of the rack, so that the conversion of the rotation directions g of the front operation assembly 104 and the side operation assembly 101 is realized. Therefore, when the side operation assembly 101 or the front operation assembly 104 drives the transmission member 110 to slide, when the transmission reaches the position of the last tooth, the elastic assembly 108 can abut against the transmission member 110 to limit its position, so as to avoid a possible condition that the third tooth part detaches from the first tooth part and the fourth tooth part detaches from the second tooth part.

Referring to FIG. 4 and FIG. 5, the side operation assembly 101 can include a rotating member, wherein the rotating member is rotationally arranged on the base 105, and a transmission groove is arranged on the rotating member. In order to improve the switching-on and switching-off speed, as shown in FIG. 4 and FIG. 5, a first energy-storage assembly 107 and a second energy-storage assembly 106 can be added, wherein the end parts of the first energy-storage assembly 107 and the second energy-storage assembly 106 are fixed to the base 105, and the other end parts of the first energy-storage assembly 107 and the second energy-storage assembly 106 are connected to the rotating member. Therefore, during the process of the rotating member rotating toward the switching-on or switching-off direction, the rotating member will drive the first energy-storage assembly 107 and the second energy-storage assembly 106 to store energy. When crossing the dead center point, the first energy-storage assembly 107 and the second energy-storage assembly 106 release the energy, so that the rotating member is driven to reach the switching-on position or the switching-off position with the help of energy release.

Referring to FIG. 4 and FIG. 5, the operation mechanism 102 capable of being operated at multiple sides includes two side operation assemblies 101, wherein two side operation assemblies 101 are fixedly connected to ensure the synchronization of rotation, and two side operation assemblies 101 are separately located on two opposite sides of the rotary shaft of the front operation assembly 104. For example, when the base 105 is a rectangular housing, two side operation assemblies 101 are rotationally arranged on two opposite sides of the rectangular housing, so as to form an operation mechanism capable of being operated at three sides including the front operation assembly 104.

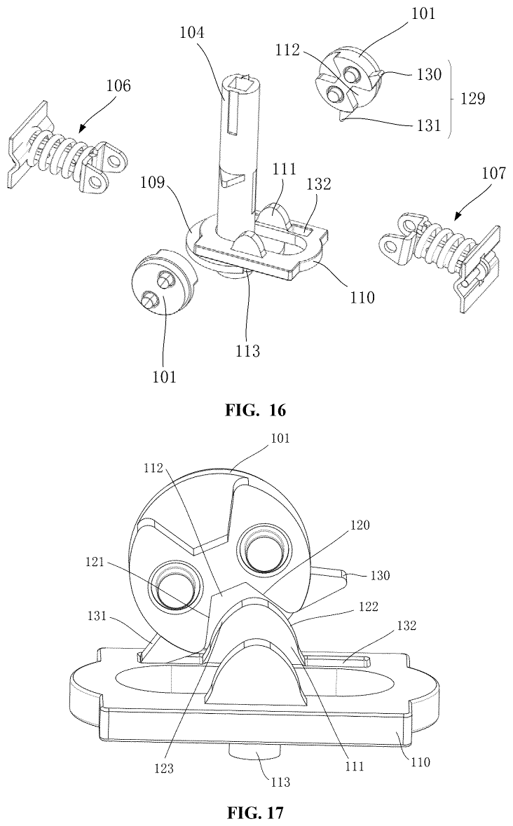

Optionally, when each operation assembly and the transmission member 110 maintain the stable and reliable transmission relationship by the abutting part 129, as shown in FIG. 16, an abutting part 129 is arranged on the side operation assembly 101, and the abutting part 129 can cooperate with the transmission member 110. Therefore, when the transmission member 110 follows the front operation assembly 104 or the side operation assembly 101 to move, the abutting part 129 can be provided to limit its position, so as to limit the movement of the transmission member 110, so that the transmission member 110 and the side operation assembly 101 can maintain the stable and reliable transmission relationship at all times. Of course, under the limitation of the abutting part 129, the transmission member 110 can also maintain a stable and reliable transmission relationship with the front operation assembly 104, which avoids the problem of transmission failure or even jamming caused by the fact that the transmission member 110 moves excessively to be separated from the operation assembly.

Referring to FIG. 17, when the side operation assembly 101 cooperates with the transmission member 110, the embodiment of the abutting part 129 and the embodiment of the foregoing elastic assembly 108 can have the same fitting method, i.e., the side operation assembly 101 is provided with the first transmission part 112, and the transmission member 110 is provided with the first mating part 111, wherein the first transmission part 112 is provided with the transmission wall, and the first mating part 111 is provided with the mating wall cooperating with the transmission wall. In this way, when the side operation assembly 101 acts, the side operation assembly 101 is driven to rotate relative to the base 105; the first transmission part 112 follows the side operation assembly 101 to rotate; and the transmission wall of the first transmission part 112 also drives the mating wall of the first mating part 111, which in turn drives the transmission member 110 to slide relative to the base 105 (the sliding rail adapted to the transmission member 110 can be arranged on the base 105). When the transmission member 110 slides relative to the base 105, the front operation assembly 104 will also be driven to move synchronously at the same time.

When the transmission relationship is maintained by the abutting part 129, the first transmission part 112 stops moving when the side operation assembly 101 rotates to the switching-on position. At this time, in order to avoid excessive sliding of the transmission member 110, the abutting part 129 located on the side operation assembly 101 can just abut against the transmission member 110, so as to limit the transmission member 110 from continuing to slide, so that the transmission member 110 stops sliding; and at this time, the mating wall of the first mating part 111 on the transmission member 110 is still located on the rotation path of the transmission wall of the first transmission part 112. In this way, the first transmission part 112 and the first mating part 111 still keep the transmission mating relationship, so that the side operation assembly 101 can still drive the transmission member 110 through the transmission of the first transmission part 112 and the first mating part 111 when rotating toward the switching-off position next time, and thereby the stable and reliable transmission of the side operation assembly 101 and the transmission member 110 is ensured.

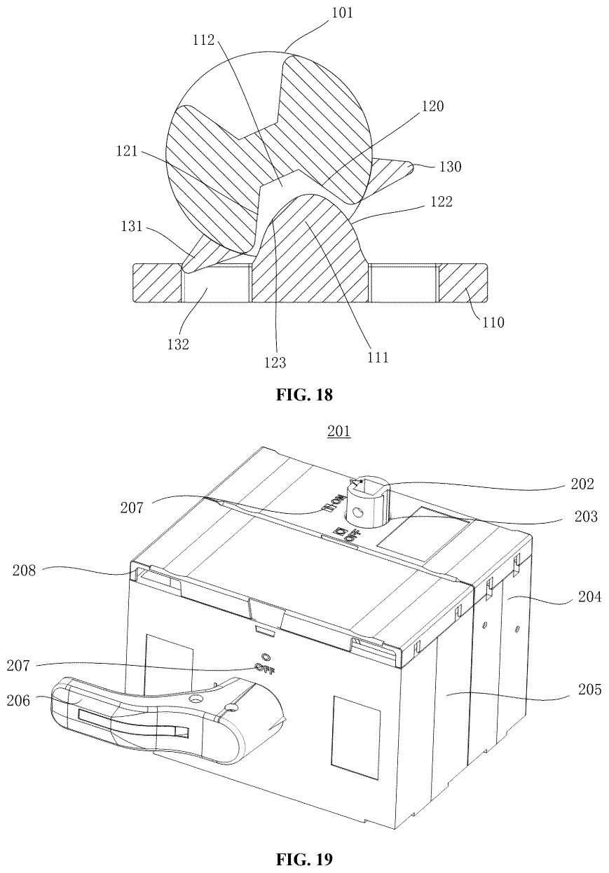

Similarly, referring to FIG. 17 and FIG. 18, when the side operation assembly 101 rotates to the switching-off position, in order to avoid excessive sliding of the transmission member 110, the abutting part 129 located on the side operation assembly 101 can just abut against the transmission member 110, so as to limit the transmission member 110 from continuing to slide; and at this time, the mating wall of the first mating part 111 on the transmission member 110 is still located on the rotation path of the transmission wall of the first transmission part 112. In this way, the first transmission part 112 and the first mating part 111 still keep the transmission mating relationship, so that the side operation assembly 101 can still drive the transmission member 110 through the transmission of the first transmission part 112 and the first mating part 111 when rotating toward the switching-on position next time, and thereby the stable and reliable transmission of the side operation assembly 101 and the transmission member 110 is ensured.

Referring to FIG. 17 and FIG. 18, two abutting parts 129 are provided, wherein two contact parts 129 are the switching-on abutting part 130 and the switching-off abutting part 131, the switching-on abutting part 130 and the switching-off abutting part 131 are arranged on the side operation assembly 101 respectively. As for the switching-on abutting part 130, when the side operation assembly 101 rotates to the switching-on position, the switching-on elastic assembly 130 just abuts against one end of the transmission member 110 to limit its position, thereby limiting the excessive movement of the transmission member 110. As for the switching-off abutting part 131, when the side operation assembly 101 rotates to the switching-off position, the switching-off elastic assembly 131 just abuts against the other end of the transmission member 110 to limit its position, thereby limiting the excessive movement of the transmission member 110.

Referring to FIG. 17 and FIG. 18, the abutting part 129 is a protrusion lug, and an accommodating hole 132 for accommodating the protrusion lug is arranged on the transmission member 110. When the side operation assembly 101 rotates to the switching-off position or the switching-on position, the protrusion lug on the side operation assembly 101 extends into the accommodating hole 132 and abuts against the hole wall of the accommodating hole 132, so as to limit the transmission member 110 from continuing to slide by the protrusion lug, which avoids the excessive movement of the transmission member 110 to detach from the side operation assembly 101. It should be understood that the accommodating hole 132 can be the through hole 406, or a blind hole 13, which is not limited by the present disclosure.

Specifically, when the abutting part 129 includes a switching-off abutting part 131 and a switching-on abutting part 130, correspondingly, the switching-off abutting part 131 can be a switching-off protrusion lug; the switching-on abutting part 130 can be a switching-on protrusion lug; and the transmission member 110 is provided with two accommodating holes 132 corresponding to the switching-on protrusion lug and the switching-off protrusion lug respectively. As for the switching-on protrusion lug, when the side operation assembly 101 slides to the switching-on position, the switching-on protrusion lug just rotates into the corresponding accommodating hole 132 and abuts against the hole wall of the accommodating hole 132 to limit its position, thereby limiting the excessive movement of the transmission member 110. As for the switching-off protrusion lug, when the side operation assembly 101 slides to the switching-off position, the switching-off protrusion lug just rotates into the corresponding accommodating hole 132 and abuts against the hole wall of the accommodating hole 132 to limit its position, thereby limiting the excessive movement of the transmission member 110.

Referring to FIG. 17 and FIG. 18, the first transmission part 112 is the transmission groove arranged on the side operation assembly 101, and the first mating part 111 is THE protrusion 218 arranged on the transmission member 110, wherein the transmission wall includes two opposite groove walls of the transmission groove (for ease of description, which are referred as the first groove wall 120 and the second groove wall 121 below); and the mating wall includes two opposite side walls of the protrusion 218 (for ease of description, which are referred as the first side wall 122 and the second side wall 123 below).

Referring to FIG. 15 to FIG. 18, when the side operation assembly 101 rotates towards the switching-on direction (the arrow direction in FIG. 15), the first groove wall 120 of the transmission groove drives the first side wall 122 of the protrusion 218, and then the transmission member 110 is driven to slide to the left (the left in FIG. 18). When the side operation assembly 101 rotates to the switching-on position, in order to avoid the excessive sliding of the transmission member 110, the protrusion 218 is detached from the transmission groove, wherein the switching-on protrusion lug located on the side operation assembly 101 just rotates into the corresponding accommodating hole 132 and abuts against the hole wall of the accommodating hole 132 to limit its position, so that the second side wall 123 is located on the rotation path of the second groove wall 121 (the first side wall 122 is still located on the rotation path of the first groove wall 120). When the side operation assembly 101 rotates reversely, the second groove wall 121 can drive the second side wall 123, so that the transmission groove can drive the protrusion 218.

When the side operation assembly 101 rotates toward the switching-off direction (which can be opposite to the switching-on direction, such as the opposite direction of the arrow in FIG. 15), the second groove wall 121 of the transmission groove drives the second side wall 123 of the protrusion 218, and then the transmission member 110 is driven to slide to the right. When the side operation assembly 101 rotates to the switching-off position, in order to avoid the excessive sliding of the transmission member 110, the protrusion 218 is detached from the transmission groove, wherein the switching-off protrusion lug located on the side operation assembly 101 just rotates into the corresponding accommodating hole 132 and abuts against the hole wall of the accommodating hole 132 to limit its position, so that the first side wall 122 is located on the rotation path of the first groove wall 120 (the second side wall 123 is still located on the rotation path of the second groove wall 121). When the side operation assembly 101 rotates reversely, the first groove wall 120 can drive the first side wall 122, so that the transmission groove can drive the protrusion 218.

Referring to FIG. 17 and FIG. 18, in order to improve the smoothness of the transmission, the first side wall 122 and the second side wall 123 of the protrusion 218 are disposed as convex curved walls respectively, so as to facilitate the cooperation and transmission between the first groove wall 120 and the second groove wall 121 of the transmission groove.

Referring to FIG. 15, the rotation axis a of the front operation assembly 104 is perpendicular to the rotation axis b of the side operation assembly 101. In other words, the rotary shafts of the front operation assembly 104 and the side operation assembly 101 are perpendicular.

Referring to FIG. 12, the front operation assembly 104 includes the rotary shaft rotationally arranged on the base 105 and the extension member 109 fixedly arranged on the rotary shaft, wherein the extension member 109 is provided with the second transmission part 114, and the transmission member 110 is provided with the second mating part 113 cooperating with the second transmission part 114. For example, the extension member 109 is the disc, wherein the second transmission part 114 is the groove arranged on the disc; the second mating part 113 is the cylinder arranged on the transmission member 110, and the cylinder extends into the groove. Therefore, when the cylinder follows the transmission member 110 to slide relative to the base 105, the cylinder drives the groove, so the front operation assembly 104 rotates; or of course, it also can be that the front operation assembly 104 rotates, and the groove drives the cylinder, so that the transmission member 110 slides relative to the base 105. In another embodiment, the first transmission part 112 can be the first tooth part located on the side operation assembly 101; the second transmission part 114 can be the second tooth part located on the front operation assembly 104; the transmission member 110 can be the rack; the first mating part 111 can be the third tooth part located on the rack; and the second mating part 113 can be the fourth tooth part arranged on the rack, wherein the first tooth part and the third tooth part are engaged in the transmission method; the second tooth part and the fourth tooth part are engaged in the transmission method; and the third tooth part and the fourth tooth part are located on different sides of the rack, so that the conversion of the rotation directions g of the front operation assembly 104 and the side operation assembly 101 is realized. Therefore, when the side operation assembly 101 or the front operation assembly 104 drives the transmission member 110 to slide, when the transmission reaches the position of the last tooth, the elastic assembly 108 can abut against the transmission member 110 to limit its position, so as to avoid the possible condition that the third tooth part detaches from the first tooth part and the fourth tooth part detaches from the second tooth part.

Referring to FIG. 15 and FIG. 16, the side operation assembly 101 can include the rotating member, wherein the rotating member is rotationally arranged on the base 105, and the transmission groove is provided with the transmission groove, the switching-off protrusion lug, and the switching-on protrusion lug. In order to improve the switching-on and switching-off speed, as shown in FIG. 15 and FIG. 16, the first energy-storage assembly 107 and the second energy-storage assembly 106 can be added, wherein the end parts of the first energy-storage assembly 107 and the second energy-storage assembly 106 are fixed to the base 105, and the other end parts of the first energy-storage assembly 107 and the second energy-storage assembly 106 are connected to the rotating member. Therefore, during the process of the rotating member rotating toward the switching-on or switching-off direction, the rotating member will drive the first energy-storage assembly 107 and the second energy-storage assembly 106 to store energy. When crossing the dead center point, the first energy-storage assembly 107 and the second energy-storage assembly 106 release the energy, so that the rotating member is driven to reach the switching-on position or the switching-off position with the help of energy release.

Referring to FIG. 15 and FIG. 16, the operation mechanism 102 capable of being operated at multiple sides includes two side operation assemblies 101, wherein two side operation assemblies 101 are fixedly connected to ensure the synchronization of rotation, and two side operation assemblies 101 are separately located on two opposite sides of the rotary shaft of the front operation assembly 104. For example, when the base 105 is a rectangular housing, two side operation assemblies 101 are rotationally arranged on two opposite sides of the rectangular housing, so as to form an operation mechanism capable of being operated at three sides including the front operation assembly 104.

It should be understood that the above two side operation assemblies 101 can have the same transmission relationship with the transmission member 110.

Referring to FIG. 19 to FIG. 35, an isolation switch 01 and an electrical operation structure 201 that can be applied in the isolation switch 01 are provided, so as to realize the switching-on and switching-of requirement to remotely operate the isolation switch 01. Referring to FIG. 19, an electrical operation structure 201 of the isolation switch 01 is provided, including an electrical operation module 205 and the operation mechanism 204 connected sequentially, wherein the electrical operation module 205 drives the operation mechanism 204 to act, and the electrical operation module 205 is in transmission with the operation mechanism 204 by the splicing structure. The operation mechanism 204 is connected to the switch unit 1031 of the isolation switch 01. The electrical operation module 205 is remotely controlled to drive the operation mechanism 204, so that the isolation switch 01 is switching-off or switching-on. It should be understood that the operation mechanism 204 in the embodiment can be the foregoing operation mechanism 102 capable of being operated at multiple sides, so that the descriptions (e.g., FIG. 1 to FIG. 18) relative to the operation mechanism 102 capable of being operated at multiple sides can be incorporated into the embodiment without conflict.

In the embodiment of the present disclosure, the electrical operation module 205 and the operation mechanism 204 are of the same size to be spliced together. A mark 207 for the user is arranged outside the housing 208 of the operation mechanism 204, so that the user can determine whether the isolation switch 01 is in a switching-on or switching-off state by observing the mark 207.

In the embodiment, based on the form of the prior product mechanism, a power-driven operation module (referred to as the electrical operation module 205) is spliced at the left side of the operation mechanism 204, so that the body 40 can be switching-of and switching-on.

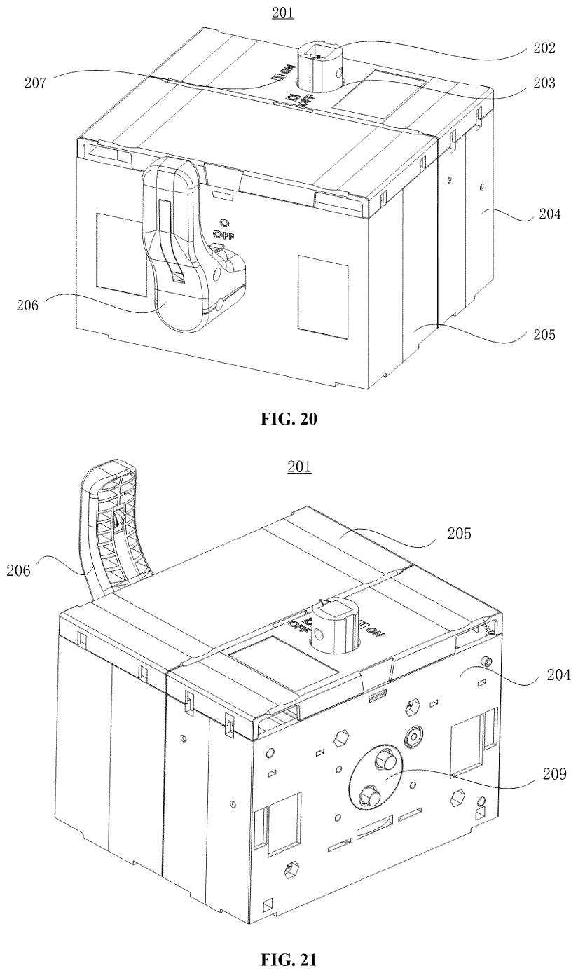

The main operation mechanism for the electrical operation module 205 in the embodiment of the present disclosure is arranged in the housing 208, wherein a connection structure is arranged between the electrical operation module 205 and the housing 208 of the operation mechanism 204, so that the electrical operation module 205 can drive the operation mechanism 204 to complete the switching-off and switching-on operations on the switch body 103. FIG. 19 shows that the electrical operation structure 201 is in the switching-on state, and FIG. 20 shows that the electrical operation structure 201 is in the switching-off state, wherein the handle 206 points to the markings 207 “ON” and “OFF” respectively to alert the user.

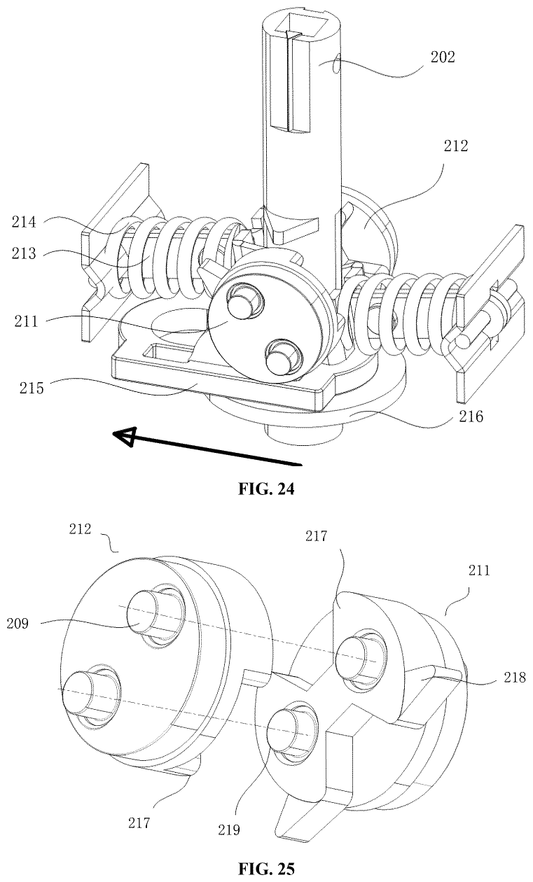

Meanwhile, as shown in FIG. 24, on the upper end of the housing 208, a fixing shaft 202 (which can be the rotary shaft 304 in other embodiments, such as the rotary shaft in the front operation assembly) extends out of the fixing hole 203 of the housing 208, and the end part of the fixing shaft 202 is also provided with a marking 207 for indicating. In the embodiment, the fixing shaft 202 can be configured to operate the operation mechanism 204, i.e., the operation mechanism 204 includes two operation modes: the third shaft 211 or the fixing shaft 202 is rotated by operating the electrical operation module 205 or the fixing shaft 202, so as to complete the switching-of or switching-on operation on the operation mechanism 204. FIG. 21 shows a schematic diagram of one side of the operation mechanism 204 in the switching-off state, wherein the operation mechanism 204 drives the switch body 103 by the fourth shaft 212.

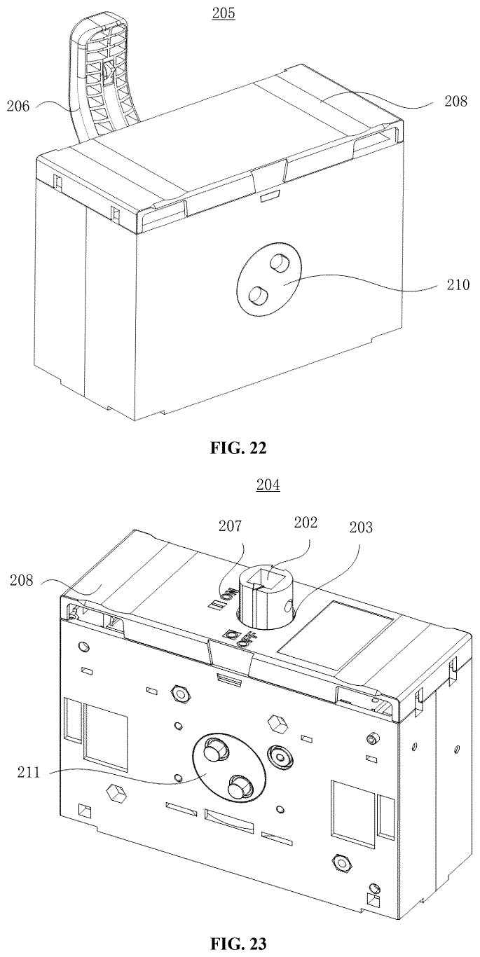

Further, FIG. 22 shows the electrical operation module 205, FIG. 23 shows the operation mechanism 204, and the connection position is as shown in figures; and FIG. 22 and FIG. 23 shows the switching-off state. The electrical operation module 205 and the operation mechanism 204 provided by the embodiments of the present disclosure can be quickly spliced and installed, i.e., the first shaft 229 and the third shaft 211 can be directly spliced together, the first shaft 229 directly drive the third shaft 211, so that the operation mechanism 204 is controlled by the control of the electrical operation module 205, so as to realize the remote control. In order to realize the solid connection, a hoe for passing through the fastener is further arranged on the housing 208 at the splicing position of the electrical operation module 205 and the operation mechanism 204, which will not be repeated herein.

In summary, an electrical operation structure 201 of the isolation switch 01 provided by the present disclosure includes: the electrical operation module 205 and the operation mechanism 204 connected sequentially, wherein the electrical operation module 205 drives the operation mechanism 204 to act, and the electrical operation module 205 is in transmission with the operation mechanism 204 by the splicing structure. The operation mechanism 204 is connected to the switch body 103 of the isolation switch 01. The electrical operation module 205 is remotely controlled to drive the operation mechanism 204, so that the switch body 103 is switching-off or switching-on. The electrical operation module 205 is provided in the present disclosure according to the requirement that the isolation switch 01 needs to be remotely controlled. The electrical operation module 205 can remotely drive the operation mechanism 204, and then drive the switch body 103 of the isolation switch 01 to be switching-off or switching-on, which meets the switching-on and switching-off requirement, so as to avoid the risk that the operator is electrically shocked due to direct operation. The remote operation can further improve the intelligence of the product; and at the same time, the electrical operation module 205 and the operation mechanism 204 provided by the present disclosure can be quickly spliced and installed, so as to reduce the installation time in use. The third shaft 211 and the fourth shaft 212 can be taken as a part of the side operation assembly in other embodiments.

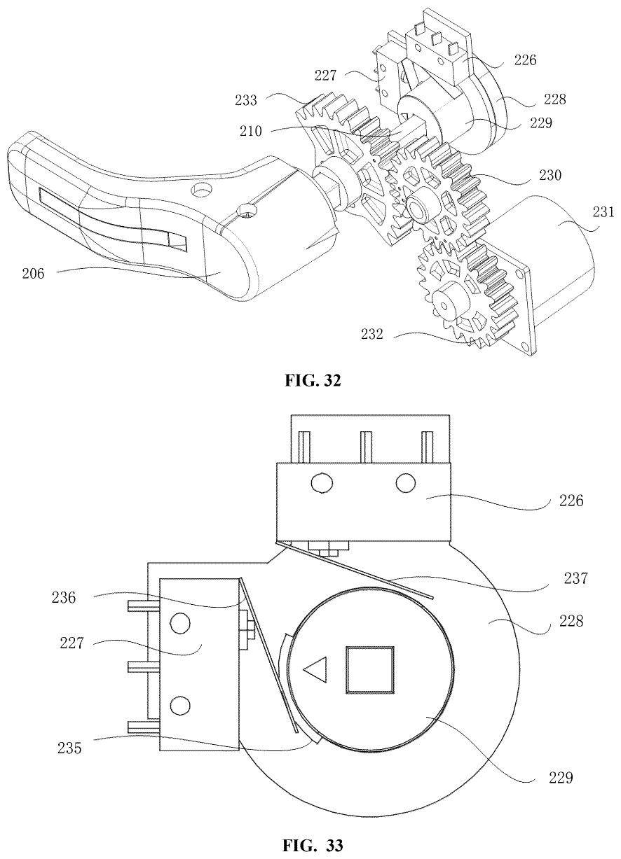

Specifically, as shown in FIG. 32, FIG. 32 shows the switching-on state, the electrical operation module 205 includes a motor 231, a gear assembly, and a shaft assembly connected in sequence, wherein the shaft assembly includes the first shaft 229 and the second shaft 210 arranged coaxially; the gear assembly is connected to the second shaft 210; and the first shaft 229 is connected to the operation mechanism 204. The motor 231 is remotely controlled to start and stop, so as to drive the operation mechanism 204 to act by the gear assembly, the second shaft 210, and the first shaft 229 in sequence.

FIG. 22 shows a structure schematic diagram of the electrical operation module 205 toward one side of the operation mechanism 204. The electrical operation module 205 is directly spliced with the operation mechanism 204 by the first shaft 229, and the first shaft 229 directly drives the operation mechanism 204. The motor 231 is remotely controlled to start and stop, and the first shaft 229 starts and stops with the motor 231.

The electrical operation module 205 further includes a first microswitch 226 and a second microswitch 227 that are in linkage with the first shaft 229.

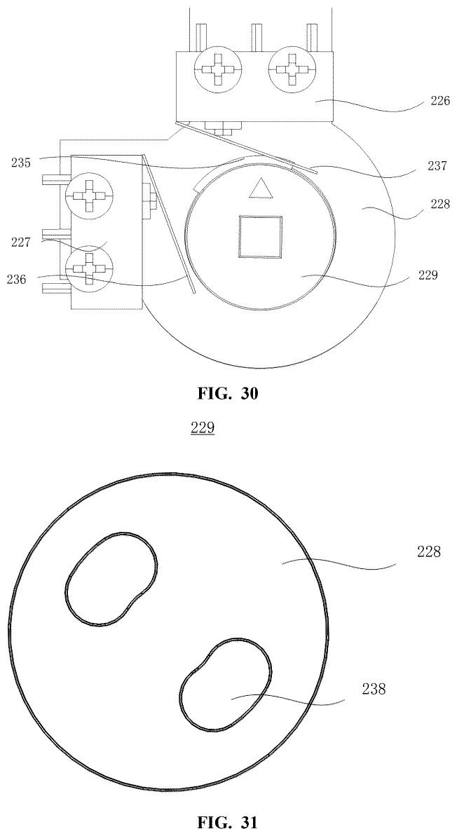

As shown in FIG. 30, FIG. 30 shows a switching-off state, wherein the first shaft 229 is at the switching-off position; the first microswitch 226 outputs a switching-off signal to the motor 231; and the motor 231 stops rotating. As shown in FIG. 33, FIG. 33 shows a switching-on state, wherein the first shaft 229 is at the switching-on position; the second microswitch 227 outputs a switching-on signal to the motor 231; and the motor 231 stops rotating.

The electrical operation module 205 in the present disclosure is driven by the motor 231, wherein the motor 231 is remotely controlled, so as to drive the first shaft 229 by the gear assembly.

Specifically, in one of the embodiments, the gear assembly includes the first gear 232, the second gear 230, and the third gear 233 sequentially connected to the motor 231, wherein the third gear 233 is connected to the second shaft 210.

Specifically, the second shaft 210 is a cross-square shaft, and the third gear 233 and the first shaft 229 are provided with square holes adapted to the cross-square shaft respectively, wherein two ends of the cross-square shaft are inserted into the square holes of the third gear 233 and the first shaft 229 respectively, so as to be connected.

FIG. 29 shows a schematic diagram of the switching-off state. The axis of each gear is parallelly arranged, and the transmission method of the gear assembly is a parallel gear transmission, wherein the third gear 233 can be a sector gear arranged from the switching-on position to the switching-off position according to the requirement in the embodiment of the present disclosure. FIG. 32 shows a schematic diagram of the switching-on state, wherein the angle difference between the switching-off position and the switching-on position is 90 degrees. Each gear only needs to rotate 90 degrees, and the sector gear can satisfy the requirement. The third gear 233 is the sector gear; the first gear 232 engages with the second gear 230; the second gear 230 engages with the third gear 233; the third gear 233 is fixedly connected to the second shaft 210; and the second shaft 210 is coaxially fixed to the first shaft 229 to control the rotation of the first shaft 229.

Specifically, in one embodiment of the present disclosure, the types of the first gear 232, the second gear 230, and the third gear 233 can further include the bevel gear, which can be used to substitute the engaging transmission. The gear assembly includes a first bevel gear connected to the motor 231, a second bevel gear that is in transmission to the first bevel gear perpendicularly, and a third bevel gear that is in transmission to the second bevel gear perpendicularly, wherein the third bevel gear is connected to the second shaft 210, which will not be described herein.

Specifically, the first shaft 229 is in linkage with the first microswitch 226 and the second microswitch 227 respectively. The isolation switch 01 is switching-off or switching-on; the first microswitch 226 or the second microswitch 227 is configured to output the signal to the motor 231; and the motor 231 stops rotating.

Exemplarily, as shown in FIG. 30, the first shaft 229 is provided with a first boss 235. When the first boss 235 abuts against a pendulum rod of the first microswitch 226, the first microswitch 226 outputs the switching-off signal; and the first boss 235 rotates to an abutting position of the pendulum rod on the second microswitch 227, the second microswitch 227 outputs the switching-on signal. FIG. 30 shows a schematic diagram of the isolation switch 01 when it is switching-off; and FIG. 32 shows a schematic diagram of the isolation switch 01 when it is switching-on.

As shown in FIG. 30, a square hole is arranged at the center position of the first shaft 229 for the insertion of the second shaft 210, so that the second shaft 210 is relatively fixed relative to the first shaft 229.

When the first shaft 229 is driven by the second shaft 210 and rotated until as shown in FIG. 30, the first boss 235 is in contact with the first pendulum rod 237 of the first microswitch 226; the first microswitch 226 sends the switching-off signal to the motor 231; and the motor 231 stops rotating and stops at the switching-off position. When the first shaft 229 rotates until as shown in FIG. 32, the first boss 235 is in contact with the second pendulum rod 236 of the second microswitch 227; the first microswitch 226 sends the switching-on signal to the motor 231; and the motor 231 stops rotating and stops at the switching-on position.

Exemplarily, as shown in FIG. 24, in one embodiment of the present disclosure, in the housing 208 of the operation mechanism 204, the operation mechanism 204 includes the third shaft 211 connected to the first shaft 229, the fourth shaft 212 connected to the third shaft 211, and the energy-storage assembly (which can be the first energy-storage assembly 107 and the second energy-storage assembly 106 in the foregoing embodiment) of the spring 214 cooperating with the third shaft 211 and the fourth shaft 212 respectively, wherein the fourth shaft 212 is configured to connect to the switch body 103. The third shaft 211 drives the fourth shaft 212 to rotate; compresses the spring 214 energy-storage assembly to store energy and release energy; and drives the switch body 103 to be switching-off and switching-on by the fourth shaft 212.

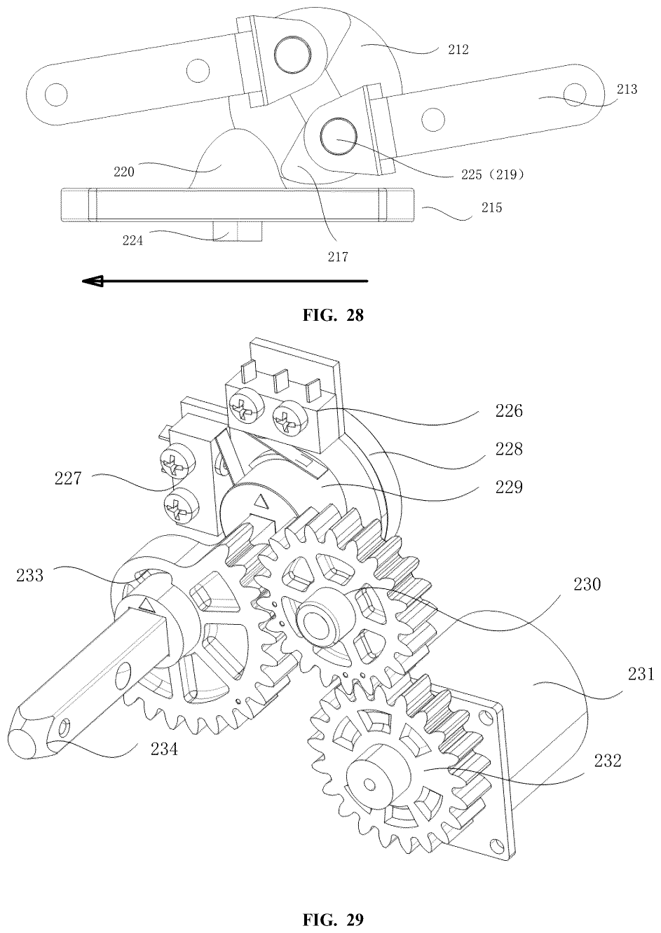

Exemplarily, as shown in FIG. 28, the third shaft 211 and the fourth shaft 212 are engaged with the sliding plate 215 respectively; the third shaft 211 rotates to drive the sliding plate 215 to slide back and forth in the first direction; and the sliding plate 215 slides to drive the fourth shaft 212 to rotate. The fixing shaft 202 passes through the sliding plate 215, and the sliding direction of the sliding plate 215 is defined by the fixing shaft 202.

Specifically, the operation mechanism 204 includes the third shaft 211 connected to the first shaft 229 by the splicing structure; and the splicing structure includes a first groove 238 arranged on the first shaft 229 and a first connecting block 239 arranged on the third shaft 211.

The third shaft 211 is connected to the first shaft 229 by the first connecting block 239, and the third shaft 211 is connected to the spring seat 213 by the second connecting block 219, wherein the spring seat 213 is provided with a connecting hole 225, which is configured to cooperate with the second connecting block 219; the fourth shaft 212 is provided with the second connecting block 219 on one side facing the third shaft 211, wherein the second connecting block 219 is configured to cooperate with the connecting hole 225; and the fourth shaft 212 is provided with the third connecting block 209 on one side facing the switch body 103, wherein the third connecting block 209 is configured to connect to the switch body 103, and to drive the switch body 103 to be switching-off or switching-on. The second connecting block 219 of the third shaft 211 and the second connecting block 219 of the fourth shaft 212 are arranged in correspondence.

Exemplarily, as shown in FIG. 25, two protrusions 218 are formed on the third shaft 211, and a second groove 221 corresponding to the protrusion 218 is formed on the sliding plate 215, wherein the protrusion 218 cooperates with the corresponding second groove 221, so that the third shaft 211 pushes the sliding plate 215 to slide back and forth in the first direction when rotating.

Specifically, the first transmission block 217 is formed on each side of the third shaft 211 and the fourth shaft 212 facing the sliding plate 215, and the second transmission blocks 220 are formed on two sides of the sliding plate 215 facing the first direction, wherein the first transmission block 217 is engaged with the second transmission block 220, so that the fourth shaft 212 is driven to rotate when the sliding plate 215 slides.

It should be noted that the sliding plate 215 of the present disclosure is pushed by the third shaft 211 and slides back and forth in the first direction, wherein the sliding plate 215 engages with the third shaft 211 and the fourth shaft 212 respectively, so that the fourth shaft 212 rotates with the third shaft 211, and the engaging rotation is smooth, wherein the first direction is a direction indicated by the arrows in each figure.

The third shaft 211 is provided with the first transmission block 217 adapted to the first transmission block 217 on the sliding plate 215, and the fourth shaft 212 is provided with the first transmission block 217 adapted to the second transmission block 220 on the sliding plate 215, wherein the first transmission block 217 is engaged with the second transmission block 220. When the third shaft 211 first starts to rotate, the third shaft 211 is provided with the protrusion 218, wherein the protrusion 218 cooperates with the second groove 221 on the sliding plate 215 to push the sliding plate 215 to slide, so that the fourth shaft 212 rotates corresponding to the third shaft 211.

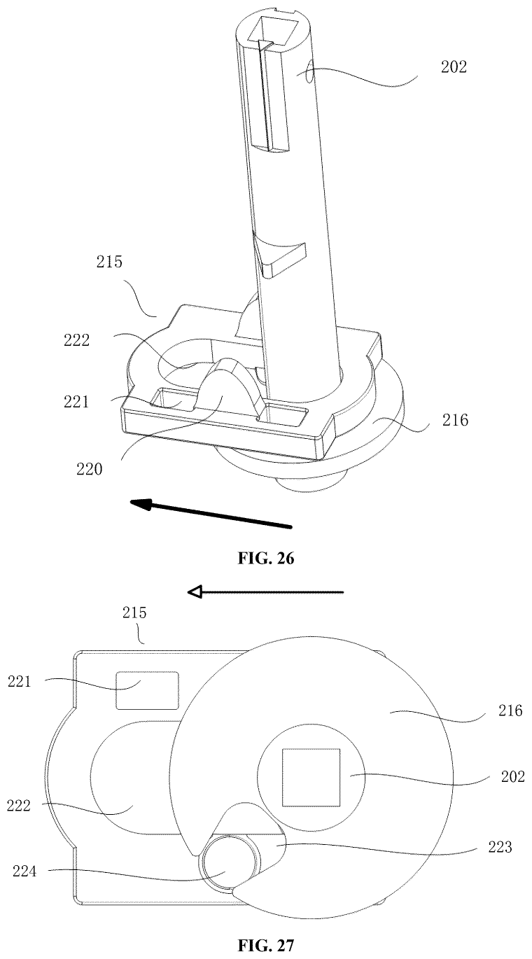

Exemplarily, as shown in FIG. 26, during the sliding process of the sliding plate 215, the center of the sliding plate 215 is provided with the through hole 222; the diameter of the through hole 222 matches the fixing shaft 202; the through hole 222 extends along the sliding direction of the sliding plate 215; and the fixing shaft 202 is limited by the fixing hole 203 and rotates inside the fixing hole 203. As shown in FIG. 27, due to the limitation of the fixing shaft 202 to the sliding plate 215, the sliding plate 215 can only slide along the extension direction of the through hole 222; and the fixing shaft 202, the third shaft 211, and the fourth shaft 212 rotate only.

Exemplarily, as shown in FIG. 27, the fixing shaft 202 is connected to the rotary table 216 under the sliding plate 215, and the rotary table 216 is provided with the third groove 223, which cooperates with the sliding plate boss 224 under the sliding plate 215. During the sliding process of the sliding plate 215, the rotary table 216 is rotated through the cooperation of the sliding-plate boss 224 and the third groove 223. It also defines the sliding direction of the sliding plate 215, and the fixing shaft 202 is further configured to operate the operation mechanism 204 at the same time.

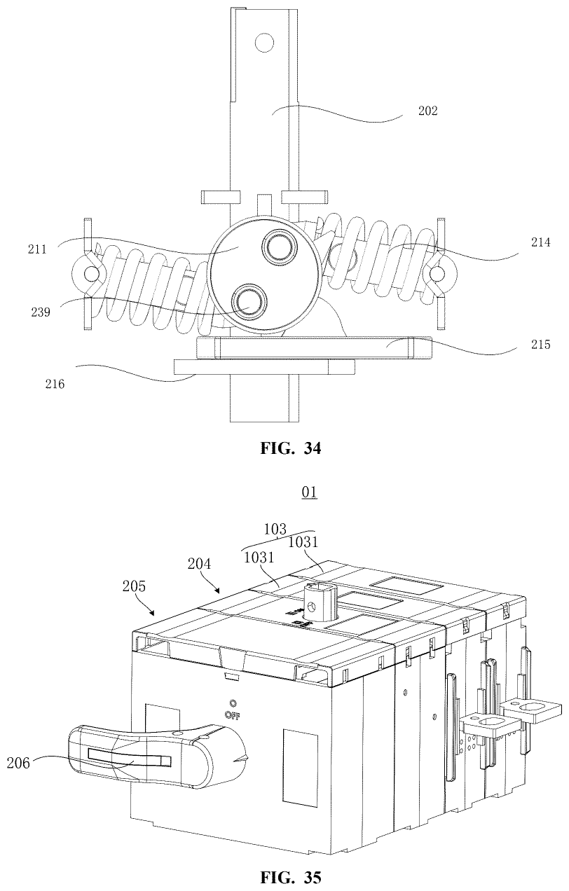

Specifically, two energy-storage assemblies (which can be the first energy-storage assembly 107 and the second energy-storage assembly 106 in the foregoing embodiments) of the spring 214 are provided, wherein two spring 214 energy-storage assemblies extend in the first direction and are connected to two sides of the third shaft 211 and the fourth shaft 212 respectively. The third shaft 211 and the fourth shaft 212 continue to rotate, so that the fourth shaft 212 rotates to the switching-off position or the switching-on position, wherein the third shaft 211 and the fourth shaft 212 drive the sliding plate 215 to slide to the maximum distance. The position of the spring 214 is shown in FIG. 28 when the isolation switch 01 is switching-off, and the position of the spring 214 is shown in FIG. 34 when the isolation switch 01 is switching-on, wherein the spring 214 is mounted on the spring seat 213.

During the rotation process of the third shaft 211 and the fourth shaft 212, such as the switching off and the switching on, the spring 214 is compressed first and then rebounds after reaching the dead point (the maximum compression state), wherein the spring 214 undergoes the process of charging energy first and then releasing the energy. The electrical operation module 205 can only rotate by 90 degrees, and the spring 214 provides the driving force when the spring 214 starts to redound, so that the third shaft 211 and the fourth shaft 212 rotate to complete the switching on. The process from switching on to switching off is similar.

The first connecting blocks 239 are protrudingly arranged on one side of the third shaft 211 facing the electrical operation module 205, wherein two first connecting blocks 239 are cylindrical and uniformly distributed on the end face of the third shaft 211 for connecting to the first shaft 229, and the first shaft 229 and the third shaft 211 are connected as shown in FIG. 31. A connecting table 228 is arranged on the end face at one side of the first shaft 229 away from the second shaft 210; the connecting table 228 is provided with the first groove 238; and the end face of the third shaft 211 is provided with the first connecting block 239 cooperating with the first groove 238. The first connecting block 239 is spliced with the first groove 238, so that the third shaft 211 is in linkage with the first shaft 229.

Specifically, a stroke of the first groove 238 is larger than a stroke of the first connecting block 239 in the rotation direction g of the first shaft 229. When the third shaft 211 is stopped rotating, the first shaft 229 continues to rotate for a preset stroke.

Exemplarily, as shown in FIG. 31, the first shaft 229 includes the connecting table 228; the first groove 238 is arranged on the connecting table 228; and the first groove 238 is designed to have an idle stroke. When the motor 231 rotates to the switching-on or switching-off position, the motor 231 cannot stop immediately due to the inertance. If it is forcibly stopped, the motor 231, the first shaft 229, and the second shaft 210 all will be damaged. Since the excess idle stroke is provided, the first shaft 229 can further rotate a little more angle until the motor 231 stops, which can improve the service life of the motor 231 and the components. The stroke of the first groove 238 is larger than the stroke of the first connecting block 239, so that when the third shaft 211 reaches the switching-on position or the switching-off position, the first shaft 229 rotates one more stroke.

Exemplarily, as shown in FIG. 31, the first groove 238 is a long strip groove, and the first connecting block 239 is a cylindrical block. When the third shaft 211 reaches the switching-on position or the switching-off position, the first shaft 229 continues to rotate the preset stroke by the long strip groove.

Specifically, the gear assembly is further connected to the handle 206 (such as the foregoing operation handle 402), wherein the handle 206 is connected to one side away from the second shaft 210, and the handle 206 controls the gear assembly to rotate, so as to drive the operation mechanism 204 to act.

In one embodiment of the present disclosure, the third gear 233 is connected to the handle 206, wherein the handle 206 is connected to one end away from the second shaft 210, and the handle 206 controls the third gear 233 to rotate, so as to drive the operation mechanism 204 to act, wherein the internal structure of the switching-off electrical operation module 205 is shown in FIG. 29; and the third gear 233 is connected to the handle shaft 234, and the handle shaft 234 is configured to mount the handle 206, wherein the internal structure of the switching-on electrical operation module 205 is shown in FIG. 32.

The electrical operation structure 201 of the isolation switch 01 provided by the present disclosure includes the following beneficial effects. 1) The electrical operation module 205 is spliced with the operation mechanism 204, wherein the assembly is fast and efficient; 2) the operation mechanism 204 compresses the energy-storage assembly of the spring 214 to realize the switching off and switching on for the contact unit, wherein the switching-on and switching-off speed is faster, and the arc extinguishing efficiency is higher; 3) in the electrical operation module 205, three groups of cylindrical gears are parallelly engaged in the transmission method along their axes; 4) the first shaft 229 is provided with the idle stroke, which avoids the risk that the motor 231 rotates too much and cannot stop; and 5) it can be operated manually by the handle 206 in case of the power failure.

As shown in FIG. 35, another aspect of the embodiment of the present disclosure is to provide an isolation switch 01 including the handle 206, the electrical operation structure 201 of the isolation switch 01 as described above, and the switch unit 1031 connected sequentially, wherein the handle 206 is configured to drive the isolation switch 01 to be switching-off or switching-on. The isolation switch 01 has the same assemblies and beneficial effects as the electrical operation structure 201 of the isolation switch 01 in the foregoing embodiment. The assemblies in the electrical operation structure 201 of the isolation switch 01 and the beneficial effects have been described in detail in the foregoing embodiments and will not be repeated herein.

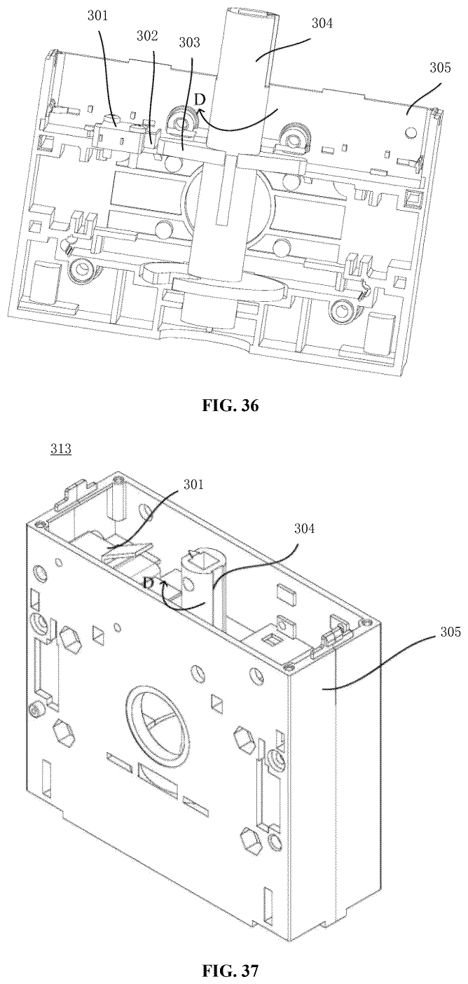

Referring to FIG. 36 to FIG. 43, an isolation switch 01 and the signal triggering structure 313 that can be applied in the isolation switch 01 are provided, so that the user can determine the switching-on and switching-off state of the isolation switch 01. As shown in FIG. 36, the signal triggering structure 313 includes the third housing 305 (which can be the foregoing housing for accommodating the operation mechanism), the rotary shaft 304 arranged in the third housing 305 (wherein the rotary shaft 304 can be the rotary shaft of the operation mechanism in the foregoing embodiment, such as the rotary shaft in the front operation assembly 104), and the third microswitch 301. The third microswitch 301 is fixedly connected to the side wall of the third housing 305; the boss 303 is arranged on the rotary shaft 304 in the radial direction; and the third microswitch 301 is provided with the button 302 on the side surface for controlling opening and closing of the third microswitch 301, wherein the rotary shaft 304 is driven to rotate the boss 303, and the boss 303 pushes the button 302 to press the button 302. It should be understood that the shaft 304 in the embodiment can be the foregoing rotary shaft 304 in the operation mechanism 102 capable of being operated at multiple sides. Therefore, without conflict, the foregoing descriptions (e.g., FIG. 1 to FIG. 18) relative to the operation mechanism 102 capable of being operated at multiple sides can be incorporated into the embodiment, and the foregoing descriptions (e.g., FIG. 19 to FIG. 35) relative to the electrical operation structure 201 can also be incorporated into the embodiment.

When the isolation switch 01 is switching-on, the rotary shaft 304 rotates in the D direction of FIG. 36 under the driving of the handle. The boss 303 is arranged on the rotary shaft 304 in the radial direction, and the boss 303 rotates with the rotation of the rotary shaft 304. Since the boss 303 protrudes out of the rotary shaft 304, the boss 303 is in contact with the button 302 of the third microswitch 301 when close to the third microswitch 301, and the button 302 is pressed when the boss 303 continues to rotate, so that the third microswitch 301 has a turning-on signal to indicate that the isolation switch 01 is in the switching-on state.

When the isolation switch 01 is switching-off, the rotary shaft 304 rotates in an opposite direction of D direction in FIG. 36 under the driving of the handle, the boss 303 moves with the rotary shaft 304 in the direction of the third microswitch 301. When the press on the button 302 is withdrawn, the button 302 extends to restore the closed state, so that the input signal of the third microswitch 301 is interrupted, which indicates that the isolation switch 01 is in the switching-off state.

In the embodiment of the present disclosure, the third microswitch 301 is arranged in the third housing 305, and the boss 303 is arranged on the rotary shaft 304 in the third housing 305. During the rotation process of the rotary shaft 304, the boss 303 pushes the button 302 of the third microswitch 301 to be in the pressed state or in the extension state, so as to realize the opening and closing for the third microswitch 301, so that the isolation switch 01 indicates the switching-off or switching-on signal.

It is to be noted that the embodiments of the present disclosure do not limit the specific form of the third microswitch 301, and the embodiments of the present disclosure do not limit the specific form of the pressing part 310 corresponding to different forms of the third microswitch 301, wherein the boss 303 can press the button 302 of the third microswitch 301 when the rotary shaft 304 rotates and drives the boss 303 to rotate.

The signal triggering structure 313 provided by the present disclosure includes the third housing 305, and the rotary shaft 304 and the third microswitch 301 arranged in the third housing 305, wherein the third microswitch 301 is fixedly connected to the side wall of the third housing 305; the boss 303 is arranged on the rotary shaft 304 in the radial direction; and the third microswitch 301 is provided with the button 302 on the side surface for controlling opening and closing of the third microswitch 301, wherein the rotary shaft 304 is driven to rotate the boss 303, and the boss 303 pushes the button 302 of the third microswitch 301 to press the button 302. When the shaft 304 rotates to be switching-on, the rotary shaft 304 drives the boss 303 to rotate, and the boss 303 pushes the button 302 of the third microswitch 301, so that the third microswitch 301 has the turning-on signal to indicate that the isolation switch 01 is in the switching-on state. When the rotary shaft 304 rotates to be switching-off, the rotary shaft 304 rotates, so that the boss 303 withdraws its pressure on the button 302, so that the signal of the third microswitch 301 is interrupted, which indicates that the isolation switch 01 is in the switching-off state. Therefore, the embodiment of the present disclosure can transmit the switching-off and the switching-on signals. Additionally, in the embodiment of the present disclosure, the third microswitch 301 is arranged in the third housing 305, wherein the opening and closing of the third microswitch 301 is realized through that the rotary shaft 304 pushes and presses the button 302 of the third microswitch 301, which reduces the volume of the isolation switch 01 compared with the prior art that the third microswitch 301 is pressed by the part of the rotary shaft 304 outside the third housing 305. The signal triggering structure 313 provided by the embodiments of the present disclosure can realize reliable transmission of the switching-on and switching-off signals under the premise of a compact product structure.

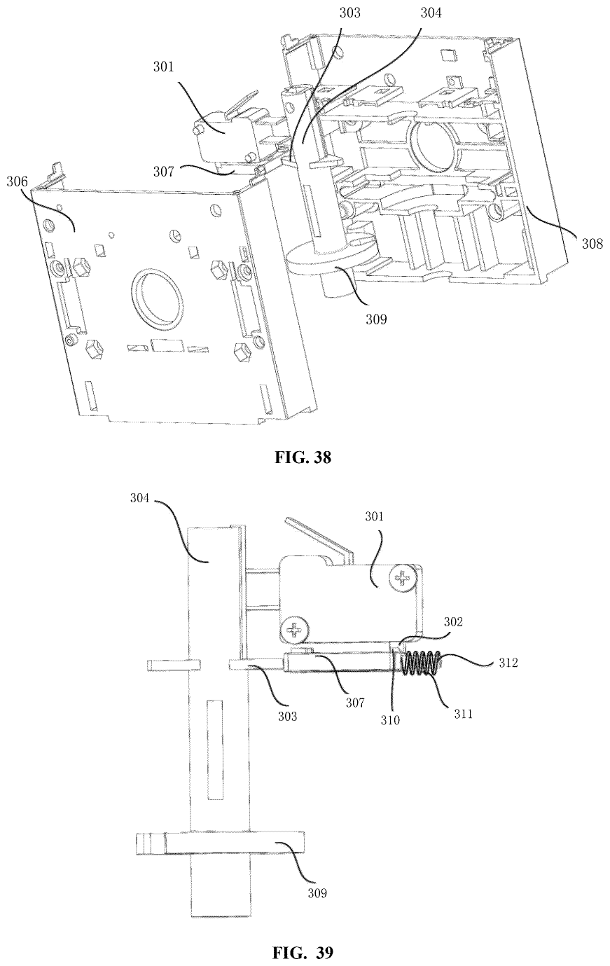

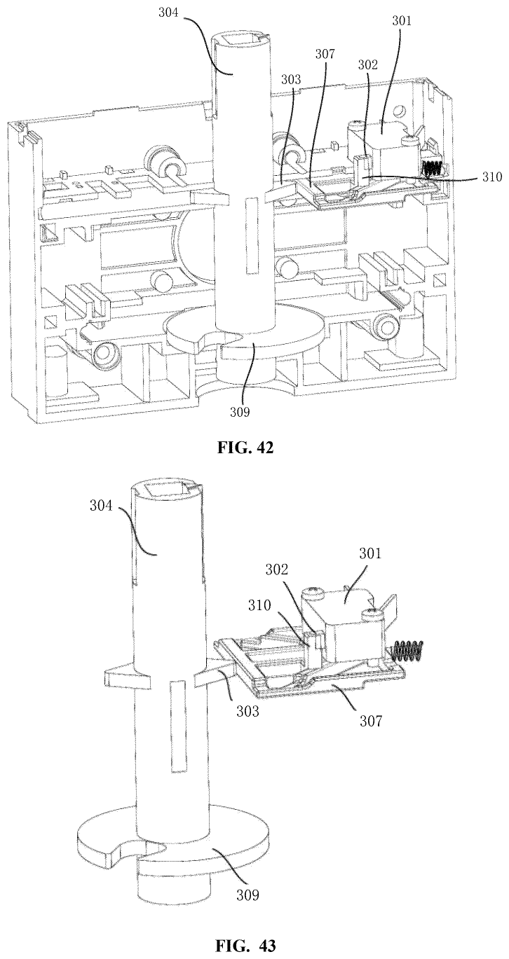

As shown in FIG. 37, FIG. 38, FIG. 39, FIG. 42, and FIG. 43, the first sliding plate 307 is arranged on one side of the rotary shaft 304 corresponding to the boss 303; the side surface of the first sliding plate 307 is provided with the pressing part 310; and the boss 303 presses the button 302 by the pressing part 310, wherein the boss 303 is driven to rotate to push the first sliding plate 307 to move in the direction away from the rotary shaft 304, so that the pressing part 310 presses the button 302; and the elastic member 311 is arranged between one side of the first sliding plate 307 away from the rotary shaft 304 and third housing 305, wherein when the boss 303 pushes the first sliding plate 307 to move in the direction away from the rotary shaft 304, the elastic member 311 accumulates the elastic potential energy.

When the isolation switch 01 is switching-on, the rotary shaft 304 rotates in the D direction of FIG. 37 under the driving of the handle, and the boss 303 rotates with the rotation of the rotary shaft 304. The first sliding plate 307 is arranged on one side of the boss 303 corresponding to the rotary shaft 304 in the third housing 305. Since the boss 303 protrudes out of the rotary shaft 304, when approaching the first sliding plate 307, the boss 303 abuts against the first sliding plate 307 and pushes the first sliding plate 307 to move in the direction away from the rotary shaft 304. During the movement of the first sliding plate 307, the pressing part 310 on the side surface of the first sliding plate 307 moves with the movement of the first sliding plate 307. During the movement of the pressing part 310, the first sliding plate 307 is in contact with the button 302 of the third microswitch 301 and presses it, so that the third microswitch 301 has the turning-on signal to indicate that the isolation switch 01 is in the switching-on state. When the first sliding plate 307 moves in the direction away from the rotary shaft 304, the end of the elastic member 311 connected to the first sliding plate 307 is pushed to move in the direction away from the rotary shaft 304, and the elastic member 311 is arranged between one side of the first sliding plate 307 away from the rotary shaft 304 and the third housing 305, so that the elastic member 311 accumulates the elastic potential energy.

When the isolation switch 01 is switching-off, the rotary shaft 304 rotates in the opposite direction of D direction in FIG. 37 under the driving of the handle, and the boss 303 moves with the rotary shaft 304 in the direction away from the first sliding plate 307. When the abutting on the first sliding plate 307 is withdrawn, since the elastic member 311 has the larger elastic potential energy, the elastic potential energy will be slowly released after the first sliding plate 307 is not subjected to the abutting force in the direction away from the rotary shaft 304, and the first sliding plate 307 is provided with a force close to the rotation direction of the rotary shaft 304, so that the first sliding plate 307 is restored to the initial position. The press of the first sliding plate 307 on the button 302 is withdrawn at this time, the button 302 extends to restore the closed state, so that the input signal of the third microswitch 301 is interrupted, which indicates that the isolation switch 01 is in the switching-off state.

Due to the existence of the elastic member 311, the first sliding plate 307 moves in the direction close to the rotary shaft 304 under the abutting of the elastic member 311, so that the press of the third microswitch 301 on the button 302 is withdrawn, and the button 302 of the third microswitch 301 naturally extends.

The embodiments of the present disclosure do not limit the specific form of the elastic member 311, wherein it only needs that the elastic potential energy can be stored when the isolation switch 01 is switching-on, and the elastic potential energy can be released when the isolation switch 01 is switching-off, so that the first sliding plate 307 can restore to the initial position.

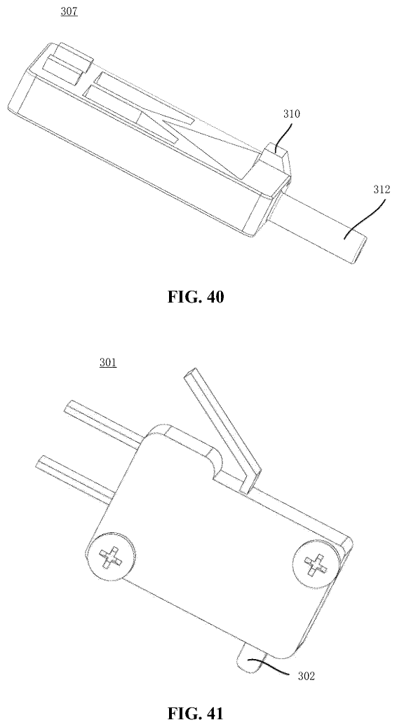

In an achievable embodiment of the present disclosure, as shown in FIG. 40 and FIG. 41, the pressing part 310 includes an inclined surface facing one side of the third microswitch 301 and an abutting surface 403 connected to the inclined surface, wherein the abutting surface 403 is parallel to the plane where the first sliding plate 307 is located. The pressing part 310 applies a pressure on the button 302 by the inclined surface and forms a stable pressing at the abutting surface 403.

Specifically, when the button 302 of the third microswitch 301 is arranged on the side surface of the third microswitch 301 close to the first sliding plate 307, one side of the pressing part 310 facing the third microswitch 301 is the inclined surface, and the pressing part 310 applies the pressure to the button 302 by the inclined surface. When the boss 303 pushes the first sliding plate 307 to move in the direction away from the rotary shaft 304, the most bottom part of the inclined surface contacts the button 302 first. During the process of the continuing movement, the contact point of the button 302 and the inclined surface gradually moves upwardly in the inclined surface until the button 302 contacts the abutting surface 403. The abutting surface 403 is parallel to the plane where the first sliding plate 307 is located, and the surface of the abutting surface 403 can stably press the button 302.

When one side of the pressing part 310 facing the third microswitch 301 is disposed to be the inclined surface, the inclined surface can provide a guide for the pressing part 310 to press the button 302, so that the button 302 can smoothly abut against the pressing part 310. In order to further improve the smooth abutting of the button 302 against the pressing part 310, the side surface of the button 302 facing the rotary shaft 304 can be disposed to be a circular arc surface.

Optionally, as shown in FIG. 42 and FIG. 43, the pressing part 310 includes a bump extending along the axial direction of the rotary shaft 304, wherein a concave surface is formed concavely on one side of the bump facing the third microswitch 301, and the concave surface matches the surface of the button 302 facing the rotary shaft 304. When the first sliding plate 307 moves away from the rotary shaft 304, the concave surface presses the button 302.

Specifically, when the button 302 of the third microswitch 301 is arranged on the side surface of the third microswitch 301 close to the rotary shaft 304, the concave surface is formed concavely in one side of the pressing part 310 facing the third microswitch 301. Wen the first sliding plate 307 drives the pressing part 310 to move in the direction away from the rotary shaft 304, the pressing part 310 is gradually close to the button 302 of the third microswitch 301 until the button 302 eventually extends into the space formed by the concave surface. The concave surface is provided, so that the button 302 can just fill the space formed by the concave surface, which avoids the lateral sliding of the button 302 due to the abutting force during the movement of the pressing part 310.

In an achievable embodiment of the present disclosure, as shown in FIG. 36, FIG. 38, and FIG. 42, two bosses 303 symmetrically arranged around the rotary shaft 304 are provided, and two side edges of the bosses 303 in the rotation direction g are bevel surfaces.

The two side edges of the bosses 303 in the rotation direction g are disposed to be the bevel surfaces, which facilitates the smooth abutting of the boss 303 against the first sliding plate 307 in the rotation process. The rotary shaft 304 rotates 90° in the D direction of FIG. 36 and FIG. 37, and the top of the boss 303 abuts against the side edge of the first sliding plate 307 until the rotary shaft 304 is at the switching-on position.

Optionally, the third housing 305 includes a first sub-housing 306 and a second sub-housing 308 covering each other, wherein the first sub-housing 306 and the second sub-housing 308 are located oppositely on two sides of the movement direction of the first sliding plate 307; the inner walls of the first sub-housing 306 and the second sub-housing 308 are separately provided with sliding grooves embedded into the first sliding plate 307 correspondingly; and the first sliding plate 307 is driven in the sliding groove to move in the direction close to or away from the rotary shaft 304.

The inner walls of the first sub-housing 306 and the second sub-housing 308 are separately provided with the sliding grooves embedded into the first sliding plate 307 correspondingly. The arrangement of the sliding groove can provide a certain guidance to the movement direction of the first sliding plate 307, which improves the stability of the movement of the first sliding plate 307.

The third housing 305 is disposed to be the first sub-housing 306 and the second sub-housing 308 covering each other, which can facilitate the assembly for the isolation switch 01. Since the isolation switch 01 is provided with a plurality of components herein, when assembling the isolation switch 01, each component is correspondingly connected to the first sub-housing 306 or the second sub-housing 308 first, and finally, the first sub-housing 306 and the second sub-housing 308 are combined and fixedly connected.

In an achievable embodiment of the present disclosure, as shown in FIG. 38, the third microswitch 301 is fixedly arranged on the side wall of the first sub-housing 306 or the second sub-housing 308. The third microswitch 301 is fixed to the side wall of the first sub-housing 306 or the second sub-housing 308, so as to improve the stability of the third microswitch 301.

Of course, when the area of the third microswitch 301 in the radial direction of the rotary shaft 304 is larger, in order to improve the stability of the fixing of the third microswitch 301, the mounting surfaces can be arranged inside the first sub-housing 306 and the second sub-housing 308. As shown in FIG. 42, the third microswitch 301 is fixedly connected to the mounting surface.

Optionally, the cylinder member 312 is protrudingly arranged on one side of the first sliding plate 307 away from the rotary shaft 304; the elastic member 311 is a compression spring; and one end of the compression spring is sleeved on the cylinder member 312 to fix to the first sliding plate 307.

In order to facilitate the fixing of the elastic member 311 to the first sliding plate 307, the elastic member 311 in the embodiments of the present disclosure is disposed to be the compression spring; the cylinder member 312 is protrudingly arranged on one side of the first sliding plate 307 away from the rotary shaft 304; and the compression spring is sleeved on the cylinder member 312. When mounting the elastic member 311, it only needs to sleeve the compression spring on the cylinder member 312, which can improve the convenience of fixing the elastic member 311 to the first sliding plate 307.

In an achievable embodiment of the present disclosure, a limiting table 309 is arranged on the rotary shaft 304 in the radial direction; a limiting surface corresponding to the limiting table 309 is arranged in the third housing 305; and the limiting surface limits the axial movement of the rotary shaft 304.

During the rotation process of the rotary shaft 304, it is difficult to avoid that the rotary shaft 304 moves in the axial direction. When the rotary shaft 304 moves in the axial direction, the boss 303 will be misaligned with the side edge of the first sliding plate 307, which results in the failure of promoting the first sliding plate 307. In order to avoid the above situation, the third housing 305 is provided with a limiting surface; the limiting table 309 is arranged on the rotary shaft 304 in the radial direction; and the limiting surface limits the axial movement of the rotary shaft 304, so as to avoid the rotary shaft 304 from moving in the axial direction.

The embodiments of the present disclosure further disclose an isolation switch 01, as shown in FIG. 1, including the signal triggering structure 313 according to any one above and the switch unit 1031 connected to the signal triggering structure 313, wherein the third microswitch 301 of the signal triggering structure 313 indicate the switching-off and switching-on states for the switch unit 1031. The isolation switch 01 has the same structure and beneficial effects as the signal triggering structure 313 in the foregoing embodiment. The structure and the beneficial effects of the signal triggering structure 313 have been described in detail in the foregoing embodiments and will not be repeated herein.

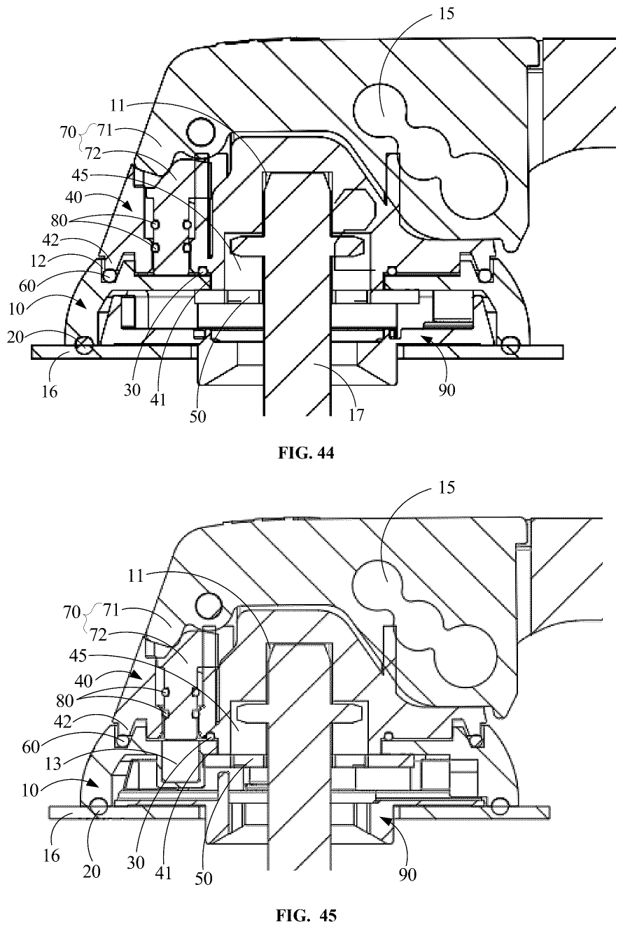

Referring to FIG. 44 to FIG. 50, an isolation switch 01 and a manual operating member that can be applied to the isolation switch 01 are provided, so to facilitate the manual operation by the user. The manual operating member can be the operation handle 402, as shown in FIG. 44 to FIG. 47. The embodiment provides an operation handle 402, wherein the operation handle 402 includes a base 10 of the handle (referred to as the base 10 below), the first sealing member 20, the second sealing member 30, and the handle body 40 (referred as the body 40 below) rotationally connected to the base 10 of the handle. The base 10 is fixedly connected to the cabinet body 16 at one side away from the body 40 and sealed by the first sealing member 20. The second sealing member 30 is arranged between the body 40 and the base 10 to realize the dynamic sealing. One side of the body 40 close to the base 10 is provided with the limiting hole adapted to the main shaft 17 (which can be the handle shaft 234 in the foregoing embodiment) of the isolation switch 01, and the base 10 is provided with the first through hole 11 communicated with the limiting hole and for the main shaft 17 to pass through. The body 40 is driven to rotate on the base 10, and the main shaft 17 can drive the isolation switch 01 to be switching-on or switching-off. The operation handle 402 has a simple structure and can be sealed reliably. It should be understood that the operation mechanism in the embodiment can be the foregoing operation mechanism 102 capable of being operated at multiple sides. Therefore, when it is without conflict, the foregoing description (e.g., FIG. 1 to FIG. 18) relative to the operation mechanism 102 capable of being operated at multiple sides can be incorporated into the embodiment; the foregoing descriptions (e.g., FIG. 19 to FIG. 35) relative to the electrical operation structure 201 can also be incorporated into the embodiment; and the foregoing descriptions (e.g., FIG. 36 to FIG. 43) relative to the signal triggering structure 313 can also be incorporated into the embodiment.

It should be noted that the operation mechanism of the isolation switch 01 and other structures are usually mounted inside the cabinet body 16, and for ease of operation, the operation handle 402 thereof is mounted outside the cabinet body 16. The operation handle 402 provided by the present disclosure is configured to drive the operation mechanism of the isolation switch 01 located in the cabinet body 16 to be switching-off and switching-on, and the structure of the operation handle 402 in the present disclosure has better gas tightness compared to the prior art.

The above cabinet body 16 refers to the body of the housing 208 of the electrical cabinet. In the embodiment, the operation handle 402 of the isolation switch 01 is exposed outside the cabinet body 16 (the other components of the isolation switch 01 are arranged inside the cabinet body 16). In this way, it can be convenient for the user to operate the product to be switching-off and switching-on by the operation handle 402 outside the cabinet body 16.

The operation handle 402 includes the base 10 fixedly connected to the cabinet body 16. In order to ensure the sealing performance between the base 10 and the cabinet body 16, in the embodiment, the operation handle 402 further includes the first sealing member 20, wherein the first sealing member 20 is located between the base 10 and the cabinet body 16. During installation, the first sealing member 20 needs to be arranged between the base 10 and the cabinet body 16 first, and then the cabinet body 16 is fixedly connected to the base 10. In this way, a static sealing between the operation handle 402 and the cabinet body 16 can be realized by the first sealing member 20.

A nut can be embedded into one surface of the base 10 close to the cabinet body 16, and the cabinet body 16 is correspondingly provided with the through hole 406. In this way, a bolt can pass through the cabinet body 16 and be fastened with the nut on the base 10.

The foregoing second sealing member 30 is arranged between the body 40 and the base 10 for sealing the body 40 and the base 10. Exemplarily, as shown in FIG. 44 and FIG. 45, the second sealing member 30 can be specifically located on one side of the base 10 facing the body 40, and the second sealing member 30 is located at the position of the base 10 close to the first through hole 11.

Further, in the embodiment, in order to facilitate the switching off or switching on for the isolation switch 01 driven by the body 40, one surface of the body 40 close to the base 10 is provided with the limiting hole adapted to the main shaft 17 of the isolation switch 01, and the base 10 is provided with the first through hole 11 communicated with the limiting hole. The center axis of the limiting hole coincides with that of the first through hole 11, and they form the space for accommodating the main shaft 17 together, as shown in FIG. 44. In this way, when the user rotates the body 40, the body 40 rotates on the base 10, so that the isolation switch 01 is switching-off or switching-on.

In summary, the operation handle 402 provided by the embodiment includes the base 10, the first sealing member 20, the second sealing member 30, and the body 40 rotationally connected to the base 10. The base 10 is fixedly connected to the cabinet body 16 at one side away from the body 40 and sealed by the first sealing member 20, and the second sealing member 30 is arranged between the body 40 and the base 10. One side of the body 40 close to the base 10 is provided with the limiting hole adapted to the main shaft 17 of the isolation switch 01, and the base 10 is provided with the first through hole 11 communicated with the limiting hole and for the main shaft 17 to pass through. The body 40 is driven to rotate on the base 10, and the main shaft 17 can drive the isolation switch 01 to be switching-on or switching-off. When it needs to be switching-off or switching-on, the user only needs to drive the body 40 to rotate, so that the body 40 rotates on the base 10. In this way, the limiting hole snapped to the body 40 can drive the main shaft 17 to rotate, so that the main shaft 17 drives the operation mechanism of the isolation switch 01 to move, thereby realizing the switching on or switching off for the isolation switch 01. The present disclosure provides the first sealing member 20 on one side of the base 10 that is away from the body 40, so that when the base 10 and the cabinet body 16 are fixedly connected, the first sealing member 20 can statically seal the cabinet body 16 and the base 10; and the second sealing member 30 is arranged between the base 10 and the body 40, so that the second sealing member 30 can dynamically seal the body 40 and the base 10 even if the body 40 rotates relative to the base 10. The structure of the operation handle 402 is arranged as above in the present disclosure. Firstly, the switching off or switching on for the isolation switch 01 can be realized by simple operations; and secondly, the two most important potential gas leakage points (i.e., a gas leakage point between the base 10 and the cabinet body 16 and a gas leakage point between the base 10 and the body 40) between the operation handle 402 and the cabinet body 16 can be reliably sealed. Compared with the prior art, the present disclosure has a better application prospect.

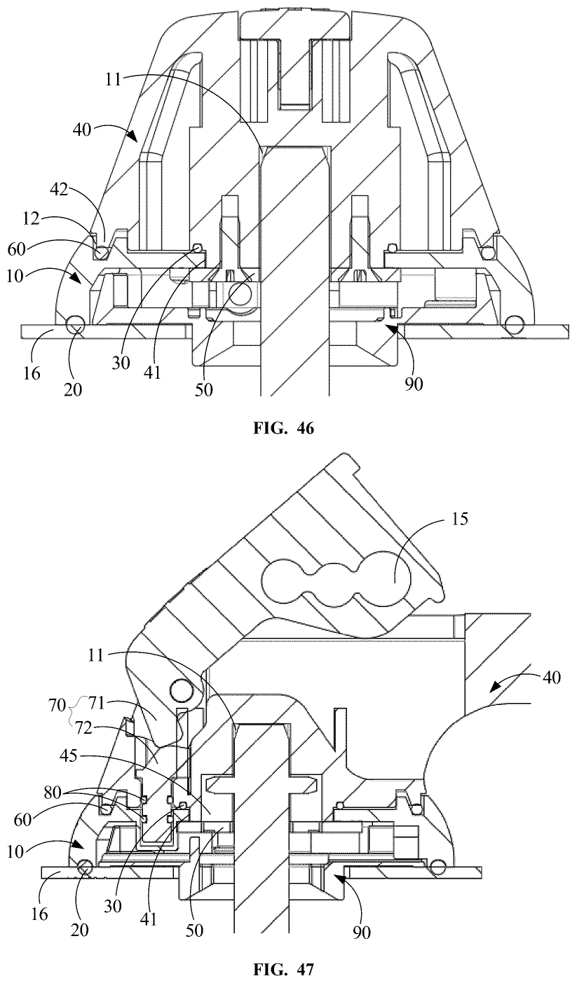

As shown in FIG. 44 and FIG. 46, optionally, the operation handle 402 further includes a pressure plate 50 fixedly connected to the body 40, wherein the pressure plate 50 is located on one side of the body 40 close to the base 10 and forms the position limitation part 41 with the body 40, and the base 10 is snapped to the position limitation part 41.

That is to say, the pressure plate 50 is fixedly connected to the body 40 and is located on one side of the body 40 close to the base 10. In the embodiment, the pressure plate 50 and the body 40 can form the position limitation part 41, and the base 10 is correspondingly snapped into the position limitation part 41. In this way, the base 10 can limit the movement of the body 40 in the axis direction of the main shaft 17, so that the body 40 can only rotate, but cannot move up and down, which avoids the body 40 from slipping off from the base 10.

Exemplarily, referring to FIG. 44, the position limitation part 41 can be arranged in an annular shape. In this way, the inner edge of the base 10 (i.e., an edge of the base 10 close to the first through hole 11) can be correspondingly snapped into the annular position limitation part 41. Of course, the annular position limitation part 41 is only an example and is not a limitation of the present disclosure. In other embodiments, a plurality of position limitation parts 41 can be provided, and the plurality of position limitation parts 41 are evenly distributed at the outer periphery of the body 40.

As shown in FIG. 44 and FIG. 47, optionally, an annular protrusion 42 is arranged on one surface of the body 40 close to the base 10, and the base 10 is provided with an annular groove 12 opposite and adapted to the annular protrusion 42. The operation handle 402 further includes a third sealing member 60, and the annular protrusion 42 is embedded around the annular groove 12 and sealed by the third sealing member 60.

In the present disclosure, the body 40 is provided with the annular protrusion 42 protrudingly facing the base 10, and the base 10 is provided with the annular groove 12 arranged concavely and inwardly. Therefore, the body 40 and the base 10 can be limited relative to each other first, and since the protrusion 218 and the concave groove are both annular, the rotation of the body 40 relative to the base 10 will not be affected; and secondly, the third sealing member 60 is arranged in the annular groove 12 in the present disclosure, so that it can further avoid the gas leakage of the base 10 and the body 40 at the annular groove 12, which can further improve the sealing performance of the base 10 and the body 40.

The second sealing member 30 in the present disclosure is located between the third sealing member 60 and the main shaft 17, and the second sealing member 30 is located at a position of the base 10 close to the main shaft 17, wherein the third sealing member 60 is located at an outer edge of the base 10. In this way, two sealing members can provide double protection for the sealing between the base 10 and the body 40, which can avoid the failure of the sealing at any one place so that the sealing performance between the body 40 and the base 10 become worser.

Referring to FIG. 44, optionally, the operation handle 402 further includes the locking mechanism 70 arranged on the body 40, and the locking mechanism 70 is configured to lock or unlock the body 40; and the blind hole 13 is concavely arranged on one surface of the base 10 close to the body 40. When the isolation switch 01 is at the switching-on position, the stopper 72 of the locking mechanism 70 passes through the body 40 and is located outside the blind hole 13, wherein the body 40 is in the unlocked state at this time. When the isolation switch 01 is at the switching-off position, the stopper 72 passes through the body 40 and can at least partially extend into the blind hole 13 to lock the body 40 when driven, wherein the user can drive the stopper 72 to move into the blind hole 13 to lock the body 40 at this time.

Specifically, in the embodiment, the locking mechanism 70 can be configured to lock the body 40 when being switching-off and to unlock the body 40 when being switching-on. In this way, it can avoid the switching on of the isolation switch 01 due to the misoperation on the body 40 by the user in the faulty or maintenance state; and when being switching-on, the switching off will not be limited in a sudden state due to the locking of the body 40.

Referring to FIG. 45, FIG. 47 and FIG. 49, optionally, the blind hole 13 is concavely arranged on one surface of the base 10 close to the body 40, wherein the body 40 is provided with the accommodation chamber 43 and the stop hole 44 communicated with the accommodation chamber 43; and the locking mechanism 70 includes the latch 71 located in the accommodation chamber 43 and rotationally connected to the body 40 and the stopper 72 passing through the stop hole 44, wherein when the isolation switch 01 is at the switching-on position, one end of the stopper 72 abuts against the latch 71, and the other end abuts against one surface of the base 10 facing the body 40; when the body 40 is driven to rotate so that the stop hole 44 is corresponding to the blind hole 13, the latch 71 is driven to rotate relative to the body 40; and when the isolation switch 01 is at the switching-off position, the latch 71 can drive the stopper 72 to move towards the base 10 and the stopper 72 is partially snapped in the blind hole 13.

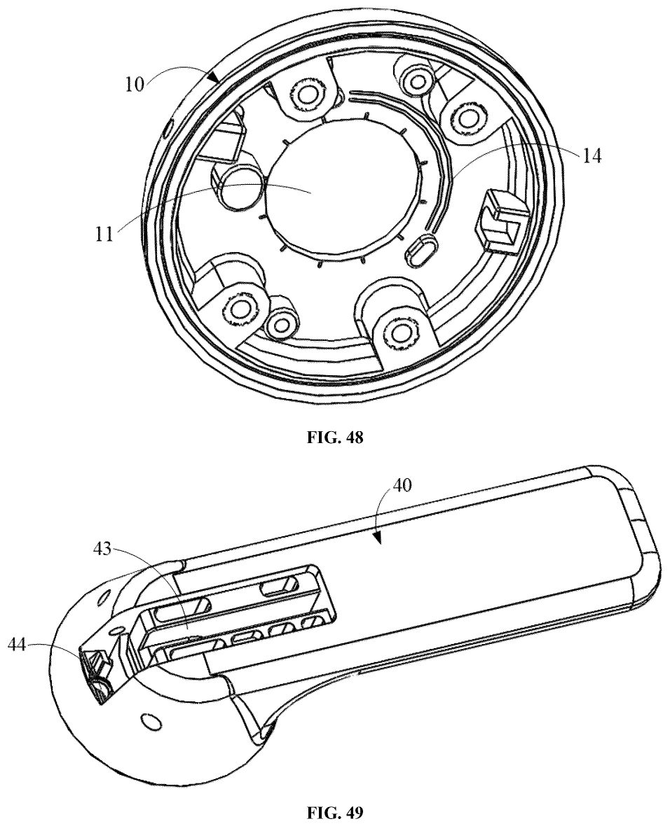

Referring to FIG. 45 and FIG. 48, it can be seen that the base 10 of the present disclosure is not provided with other through holes besides the first through hole 11, so that the problem of the poor sealing performance due to more potential gas leakage points caused by multiple through holes can be essentially solved.

The foregoing body 40 is further provided with the accommodation chamber 43 and a stop hole 44 communicated with each other, wherein the accommodation chamber 43 is configured to accommodate the latch 71; the stop hole 44 is configured to accommodate the stopper 72; and one end of the latch 71 close to the stopper 72 is hinged to the body 40.

In addition, optionally, the locking mechanism 70 can further include a reset spring (not shown in the figures), wherein one end of the reset spring is connected to the stopper 72, and the other end extends toward the base 10.

It is to be noted that when the isolation switch 01 is in the switching-on state, as shown in FIG. 44, the latch 71 is completely accommodated in the accommodation chamber 43 at this time, and the stopper 72 is located in the stop hole 44, wherein one end of the stopper 72 abuts against the latch 71, and the other end abuts against the plane of the base 10. Because the stopper 72 limits the rotation of the latch 71 at this time, so that the latch 71 cannot rotate at this time. When the body 40 is driven to rotate on the base 10 so that the isolation switch 01 is in the switching-off state, as shown in FIG. 45, the stopper 72 is driven by the body 40 to rotate to the upper part of the blind holes 13 at this time (at this time, one end of the reset spring is connected to the stopper 72, the other end abuts against the base 10, so that the stopper 72 will not fall directly into the blind hole 13 under the action of the reset spring). When the latch 71 is driven to rotate relative to the body 40 at this time, one end of the latch 71 close to the stopper 72 can push the stopper 72 to move toward the blind hole 13 at this time, so that the stopper 72 is partially snapped in the blind hole 13, as shown in FIG. 47.

In order to effectively prevent the user from operating the isolation switch 01 by mistake, optionally, a lock hole 15 is arranged on one end of the latch 71 away from the stopper 72. As shown in FIG. 47, the locking mechanism 70 further includes a locking member (not shown in the figures), wherein the locking member is configured to hang in the lock hole 15 when the lock hole 15 rotates to the outside of the accommodation chamber 43. In this way, the latch 71 is locked and cannot rotate, at which point the isolation switch 01 is locked in the switching-off state.

In order to further improve the sealing performance of the operation handle 402, optionally, the operation handle 402 further includes a fourth sealing member 80 sleeved on an outer periphery of the stopper 72. When the stopper 72 is partially seated in the blind hole 13, the base 10 and the stopper 72 are sealed by the fourth sealing member 80. Through providing the fourth sealing member 80, the sealing performance between the stopper 72 and the body 40 can be improved when rotating the latch 71.

Exemplarily, the first sealing member 20, the second sealing member 30, the third sealing member 60, and the fourth sealing member 80 in the present disclosure can be O-shaped sealing rings or U-shaped sealing rings.

Referring to FIG. 47, optionally, two fourth sealing members 80 are provided. When the stopper 72 is partially seated in the blind hole 13, a fourth sealing member 80 is configured to seal the base 10 and the stopper 72, and the other fourth sealing member 80 is configured to seal the body 40 and the stopper 72, so as to improve the sealing performance of the operation handle 402.

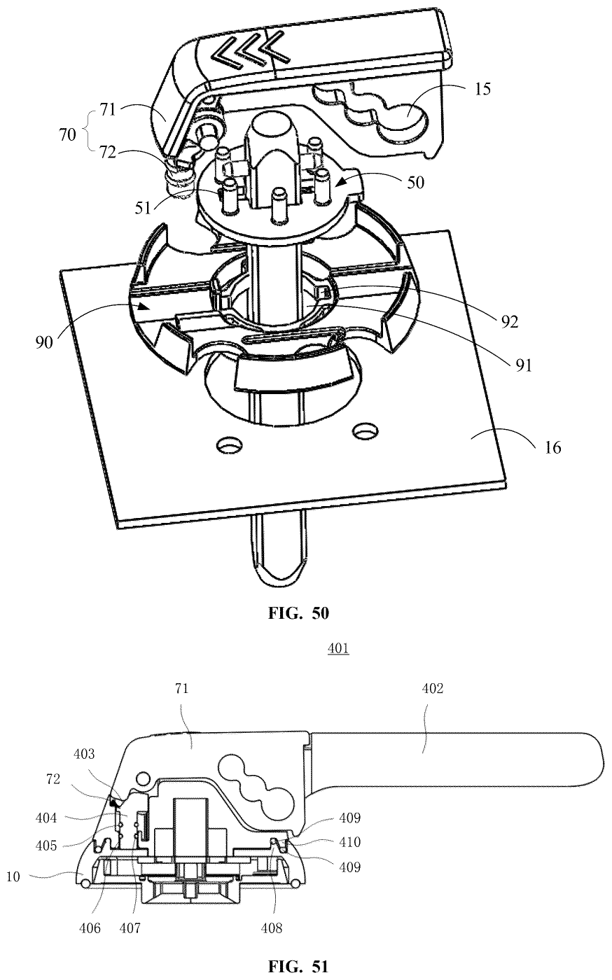

Optionally, referring to FIG. 44 and FIG. 50, the operation handle 402 further includes a handle casing 90 (referred to as the casing 90 below) fixedly connected to one surface of the base 10 departing from the body 40, wherein a second through hole 91 coaxially with the first through hole 11 is arranged at the center of the handle casing 90; the body 40 is further provided with an avoidance groove 45 communicated with the limiting hole, wherein the avoidance groove 45 is adapted to the positioning pin on the outer wall of the main shaft 17; and the casing 90 is provided with an avoidance hole 92 communicated with the second through hole 91. When the isolation switch 01 is at the switching-off position, the avoidance hole 92 is corresponding to the avoidance groove 45.

In the embodiment, the avoidance groove 45 and the avoidance hole 92 both are square. Correspondingly, when the operation handle 402 is provided with the pressure plate 50, the pressure plate 50 shall be further provided with the avoidance chamber 51 correspondingly. It is to be noted that when the isolation switch 01 is at the switching-on position, the avoidance groove 45 and the avoidance chamber 51 correspond to each other, but both of them are misaligned with the avoidance hole 92. The cabinet body 16 cannot be opened at this time, so as to play a role of protection. When the isolation switch 01 is at the switching-off position, the avoidance groove 45, the avoidance chamber 51, and the avoidance hole 92 are aligned and communicated with each other. The positioning pin on the main shaft 17 can just pass through the avoidance hole 92 on the casing 90 at this time, and at this time the cabinet door can be opened to facilitate repair or maintenance.

Additionally, in the embodiment, referring to FIG. 48, the base 10 is provided with a radial oil groove 14, wherein the oil groove 14 is configured to store the grease. In this way, the friction between the base 10 and the pressure plate 50 can be changed from the dry friction to the friction lubricated with the grease. Further, the pressure plate 50 and the body 40 in the present disclosure are fixedly connected by fastening screws, as shown in FIG. 48.

Another aspect of the present disclosure, as shown in FIG. 1, is to provide an isolation switch 01. wherein the isolation switch 01 includes an operation mechanism, a contact unit (which can be the switch unit 1031 in the foregoing embodiments), and the operation handle 402 above. The operation handle 402 and the operation mechanism are drivingly connected; the operation mechanism and the contact unit are drivingly connected; and the operation handle 402 can drive the contact unit to be switching-on or switching-off by driving the operation mechanism to move. Since the specific structure of the operation handle 402 and its beneficial effects have been described in detail above, the present disclosure will not be repeated herein.

It should be noted that in the embodiment, the above operation handle 402 can be mounted on the top of the cabinet body 16 (as shown in FIG. 1), at which time the user can operate the operation handle 402 in a lateral direction; or it can be mounted on the front surface of the cabinet body 16 (i.e., in the axis hole on the front surface of the cabinet body 16 in FIG. 1), at which time the user can operate the operation handle 402 in a forward direction. The user can choose the installation position of the operation handle 402 on demands, and the present disclosure does not specifically limit the installation position of the operation handle 402 on the cabinet body 16.

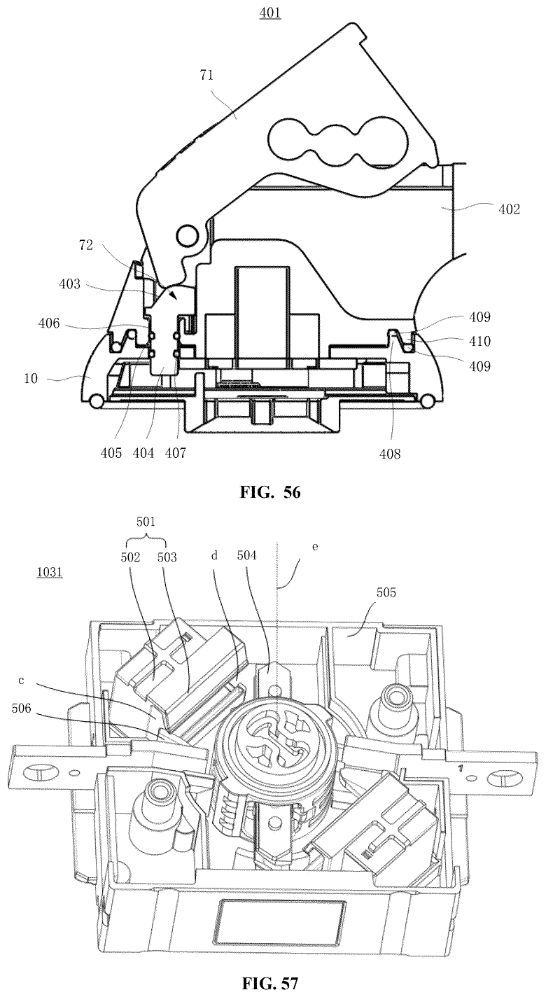

Referring to FIG. 51 to FIG. 56, an isolation switch 01 and the manual operating member that can be applied to the isolation switch 01 are provided, wherein the manual operating member can be the airtight handle assembly 401. Referring to FIG. 51 to FIG. 54, an airtight handle assembly 401 is provided, including: the operation handle 402 (exemplarily, it can be taken as the foregoing body 40), the stopper 72, and at least two reset members, wherein one end of the reset members is fixed on the stopper 72 and the other end is fixed on the operation handle 402; the operation handle 402 is configured to drivingly connect to the operation mechanism, and the operation handle 402 is provided with the through hole 406; and the stopper 72 reciprocally slides in the through hole 406, and two ends of the sliding path of the stopper 72 correspond to the first position and the second position respectively. In conjunction with FIG. 55 and FIG. 56, when the stopper 72 is at the first position, the reset member is in the natural state, and the operation handle 402 rotates reciprocally, so as to switch between the switching-on state and the switching-off state; and when the stopper 72 leaves the first position, the reset member is compressed, and the operation handle 402 is fixed by the stopper 72, wherein the stopper 72 switches between the first position and the second position, so as to switch between the switching-off state and the switching-off padlock state, wherein the sealing structure is arranged between the stopper 72 and the through hole 406, and at least two reset members are evenly arranged around the sealing structure, wherein when the stopper 72 switches between the first position and the second position, the sealing structure is at least partially located in the through hole 406 and wraps the stopper 72, so to seal the gap between the stopper 72 and the through hole 406. It should be understood that the operation mechanism in the embodiment can be the foregoing operation mechanism 102 capable of being operated at multiple sides. Therefore, when it is without conflict, the foregoing description (e.g., FIG. 1 to FIG. 18) relative to the operation mechanism 102 capable of being operated at multiple sides can be incorporated into the embodiment; the foregoing descriptions (e.g., FIG. 19 to FIG. 35) relative to the electrical operation structure 201 can also be incorporated into the embodiment; the foregoing descriptions (e.g., FIG. 36 to FIG. 43) relative to the signal triggering structure 313 can also be incorporated into the embodiment; and the foregoing descriptions (e.g., FIG. 44 to FIG. 50) relative to the operation handle 402 can also be incorporated into the embodiment.

The airtight handle assembly 401 is mounted outside the machine cabinet for manual control of the low-voltage appliance to which it belongs. The airtight handle assembly 401 includes the operation handle 402, the stopper 72, and the reset member. The airtight handle assembly 401 has three states, which are the switching-off state, the switching-on state, and the switching-off padlock state, wherein the switching-off padlock state that the operation handle 402 is fixed under the switching-off state, and it cannot be rotated to be switching-on. The switching-on state and the switching-off state are switched by rotating the operation handle 402, wherein the switching of the switching-off state to the switching-off padlock state is realized by manually driving the stopper 72, and the switching of the switching-off padlock state to the switching-off state is realized by driving the stopper 72 by the reset member.

Specifically, the operation handle 402 is provided with the through hole 406; the stopper 72 is arranged in the through hole 406, and can be driven to reciprocally move in the through hole 406 in a straight line; and two end points of the movement path of the stopper 72 correspond to the first position and the second position of the stopper 72 respectively. When the stopper 72 is at the first position, the operation handle 402 is not limited and can rotate freely, thereby realizing the switching between the switching-on state and the switching-off state. When the stopper 72 leaves the first position, i.e., when the stopper 72 is between the first position and the second position, or when it is at the second position, the operation handle 402 cannot rotate due to the limitation of the stopper 72, thereby realizing the switching from the switching-off state to the switching-off padlock state. It is to be noted that in the embodiment, the rotation manner of the stopper 72 limiting the operation handle 402 is not limited, and it only needs to lock and unlock the operation handle 402 through its own position change of the stopper 72.

A sealing structure is arranged between the stopper 72 and the through hole 406. During the reciprocal switching process of the stopper 72 between the first position and the second position, the sealing structure is entirely or partially arranged in the through hole 406 and wraps the stopper 72, so as to seal the gap between the stopper 72 and the through hole 406. In the embodiment, the specific form and the fixing position of the sealing structure are not limited, and it only needs to ensure the gas tightness requirement. The sealing structure can be a sealing ring. The sealing structure can be fixed to the outer wall of the stopper 72 and follow the movement of the stopper 72, wherein during the movement of the stopper 72, a part of the sealing structure is always located within the through hole 406 to realize the sealing; or the sealing structure can be fixed to the inner wall of the through hole 406, wherein during the movement of the stopper 72, it always wraps partial area of the stopper 72 to realize the sealing.

A reset member is further arranged between the stopper 72 and the operation handle 402, wherein when the stopper 72 is at the first position, the reset member is in the natural state; and when the stopper 72 is at the second position, and the reset member in a deformed energy storage state. When the external force applying on the stopper 72 is removed, the reset member recovers and releases the energy to drive the stopper 72 to move from the second position to the first position, so that the switching-off padlock state is switched to the switching-off state. Two reset members are provided at least and evenly distributed around the sealing structure, so that the stopper 72 is forced more uniform, and the reset process is more stable and reliable. In the embodiment, the form of the reset members is not limited. It only needs that the reset member can deform and store energy during movement of the stopper 72 from the first position to the second position, and can automatically recover and release energy after the external force is removed, so as to drive the stopper 72 to reset.

As for the airtight handle assembly 401 above, a through hole 406 for the stopper 72 to slide is arranged in the operation handle 402, and a sealing structure is arranged between the stopper 72 and the through hole 406, so that the sealing structure is always at least partially located within the through hole 406 and warps the stopper 72 during reciprocating rotation of the handle and reciprocating sliding of the stopper 72, i.e., a sealing structure for sealing is always located between the stopper 72 and the through hole 406, so that a non-sealing condition due to the misalignment of the movement will not occur, which improves the sealing stability. In case of compact space, the gas tightness is reliable in three states of switching on, switching off, and switching-off padlock, and the switching process of three states. Additionally, the reset member can be evenly arranged between the stopper 72 and the operation handle 402. When the stopper 72 is automatically restored, the switching-off padlock state can switch to the switching-off state, and the restoring process is more stable and reliable.

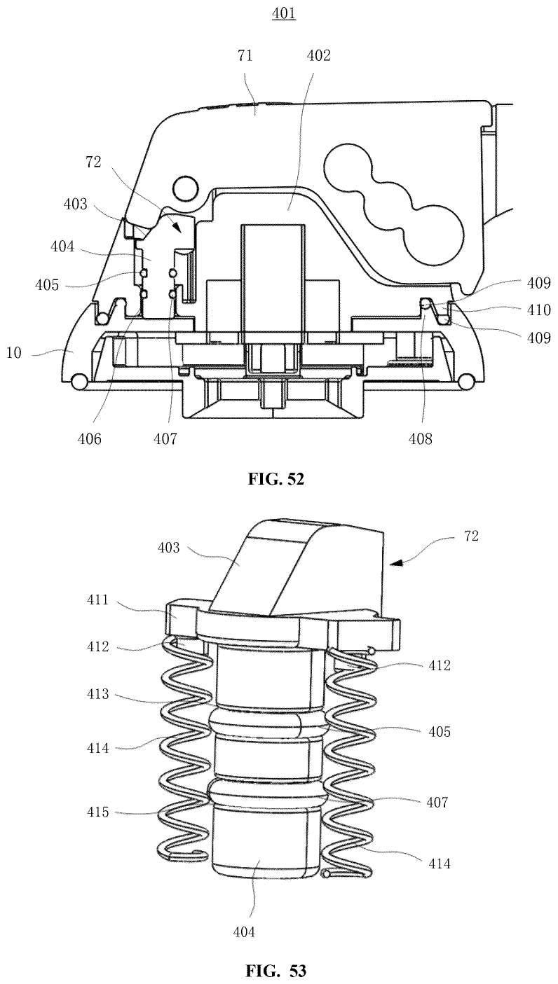

Referring to FIG. 52, FIG. 55, and FIG. 56, optionally, in an achievable embodiment of the present disclosure, the sealing structure includes a first sealing structure and a second sealing structure arranged at intervals on the outer wall of the stopper 72, wherein the stopper 72 is at the first position; the first sealing structure is located within the through hole 406; the stopper 72 is at the second position; and the second sealing structure is located within the through hole 406, so as to seal the gap between the stopper 72 and the through hole 406.

The sealing structure includes the first sealing structure and the second sealing structure independent to each other, and they are fixed on the outer wall of the stopper 72 at intervals and follow the movement of the stopper 72. When the airtight handle assembly 401 is in the switching-on state or the switching-off state, or switches between the switching-on state and the switching-off state, the stopper 72 is always at the first position. The first sealing structure is located in the through hole 406 at this time, and the second sealing structure can be located outside the through hole 406 or located in the through hole 406, wherein the first sealing structure is at least arranged between the stopper 72 and the through hole 406 for sealing. When the airtight handle assembly 401 is in the switching-off padlock state, the stopper 72 is at the second position. The second sealing structure is located in the through hole 406 at this time, and the first sealing structure can be located outside the through hole 406 or located in the through hole 406, wherein the second sealing structure is at least arranged between the stopper 72 and the through hole 406 for sealing. When the airtight handle assembly 401 switches between the switching-off state and the switching-off padlock state, the stopper 72 is between the first position and the second position. At least one of the first sealing structure and the second sealing structure is arranged in the through hole 406 at this time, and at least one of the first sealing structure and the second sealing structure is arranged between the stopper 72 and the through hole 406 for sealing.

Optionally, in an achievable embodiment of the present disclosure, the first sealing structure and the second sealing structure are arranged in parallel, wherein the distance between the first sealing structure and the second sealing structure is equal to the distance between the first position and the second position. In this way, when the stopper 72 reciprocally switches between the first position and the second position, one of the first sealing structure and the second sealing structure is always arranged in the through hole 406, and the other is arranged outside the through hole 406.

Referring to FIG. 53, optionally, in an achievable embodiment of the present disclosure, the stopper 72 includes the cylinder part 404, and the first groove 238 and the second groove 221 are arranged on the outer wall of the cylinder part 404, wherein the first sealing structure includes the first sealing ring 407 arranged within the first groove 238, and the second sealing structure includes the second sealing ring 405 arranged within the second groove 221.

The first groove 238 and the second groove 221 are annular, and the extension direction is perpendicular to the axis of the cylinder part 404. The first sealing ring 407 and the second sealing ring 405 are arranged in the first groove 238 and the second groove 221 respectively, and can be in interference fit with the through hole 406 to realize the reliable sealing. The side walls of the first groove 238 and the second groove 221 can drive the first sealing ring 407 and the second sealing ring 405 to follow the movement of the stopper 72 respectively, and play a limiting support role. The first sealing ring 407 or the second sealing ring 405 can be prevented from falling out when leaving the through hole 406.

Preferably, the first sealing ring 407 and the second sealing ring 405 have the same size and nature to realize the same sealing effect.

Referring to FIG. 52, FIG. 55, and FIG. 56, optionally, in an achievable embodiment of the present disclosure, the base 10 rotationally connected to the operation handle 402 is further provided, wherein the base 10 is configured to fix to the machine cabinet, and the base 10 provided with the first stop hole 417, wherein the stopper 72 extends into the first stop hole 417 after leaving the first position, so as to fix the operation handle 402.

The operation handle 402 is rotationally arranged on the machine cabinet by the base 10, and the base 10 is provided with the first stop hole 417 cooperating with the stopper 72. As shown in FIGS. 55 and 56, when the airtight handle assembly 401 is at the switching-off state, the position of the stopper 72 corresponds to that of the first stop hole 417. The stopper 72 is driven to leave the first position and extends into the first stop hole 417, so that the operation handle 402 is locked. As shown in FIG. 52, when the airtight handle assembly 401 is in the switching-on state, or switches from the switching-on state to the switching-off state, the stopper 72 is misaligned with the first stop hole 417, and the stopper 72 is always at the first position supported by the base 10.

Exemplarily, the base 10 is provided with a first annular groove and a first annular protrusion 408; the operation handle 402 is provided with a second annular protrusion 410 cooperating with the first annular groove and a second annular groove cooperating with the first annular protrusion 408; and annular sealing rings 409 are separately arranged between the first annular groove and the second annular protrusion 410, and between the first annular protrusion 408 and the second annular groove, so as to ensure the air tightness between them when the operation handle 402 rotates relative to the base 10.

Referring to FIG. 55 and FIG. 56, optionally, in an achievable embodiment of the present disclosure, the latch 71 rotationally arranged in the operation handle 402 is provided, wherein the latch 71 drives the stopper 72 to switch from the first position to the second position.

The rotational movement of the latch 71 is converted into the linear movement of the stopper 72 through the driving of the latch 71 and the position limitation on the stopper 72 by the through hole 406, wherein the latch 71 can be provided to facilitate the operation of the user. The switching of the stopper 72 from the second position back to the first position is realized by the reset member.

Optionally, in an achievable embodiment of the present disclosure, the latch 71 abuts against the stopper 72, so as to exert a force on the stopper 72 in a direction toward the first stop hole 417 during the rotation process. The abutting surface 403 between the stopper 72 and the latch 71 is inclined, and the inclination direction of the abutting surface 403 depends on that the latch 71 can drive the stopper 72 to move in the direction toward the first stop hole 417 during the rotation process. The abutting surface 403 is inclined, so as to facilitate the relative sliding between the stopper 72 and the latch 71.

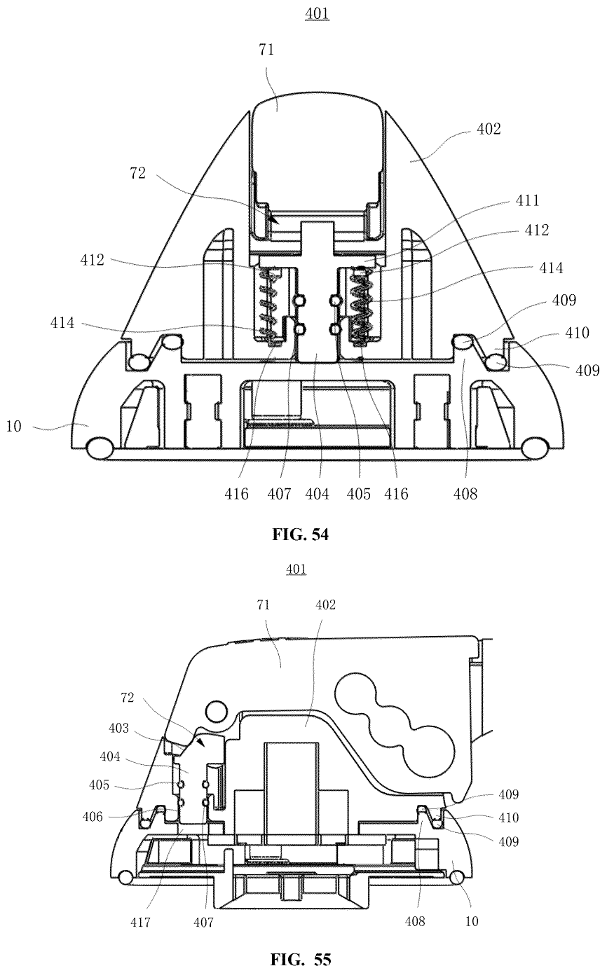

Referring to FIG. 53 and FIG. 54, optionally, in an achievable embodiment of the present disclosure, the reset member is the first spring 414, and the direction of expansion or contradiction of the first spring 414 is parallel to the movement direction of the stopper 72.

Exemplarily, two first springs 414 are provided, wherein two first springs 414 are symmetrically arranged on two sides of the sealing structure to apply an equal rebound force to the stopper 72, so as to realize a stable and reliable resetting process for the stopper 72 with the minimum amounts of first springs 414.

Optionally, in an achievable manner of an embodiment of the present disclosure, the stopper 72 includes a cylinder part 404 and a restoring part 411 arranged at the top of the cylinder part 404; the restoring part 411 is provided with the first protrusion 412; and the operation handle 402 is provided with the limiting groove 416 corresponding to the first protrusion 412, wherein one end of the first spring 414 is sleeved on the first protrusion 412, and the other end is inserted into the limiting groove 416, so as to ensure the reliable assembly for the first spring 414.

Referring to FIG. 51 and FIG. 1, the embodiment further provides an isolation switch 01, including the operation mechanism, the contact unit (which can be the switch unit 1031 in the foregoing embodiment), and the airtight handle assembly 401 as in any one of the above. The operation mechanism is drivingly connected to the contact unit, and the operation handle 402 in the airtight handle assembly 401 can drive the contact unit to be switching-on or switching-off by driving the operation mechanism to move.

The operation mechanism and contact unit of the isolation switch 01 are mounted in the machine cabinet, and the airtight handle assembly 401 is mounted outside the machine cabinet. The operation handle 402 in the airtight handle assembly 401 can be drivingly connected to the operation mechanism 204 by square shaft 418 (which can be the handle shaft 234 or main shaft 17 in other embodiments), so as to manually control the isolation switch 01 outside the machine cabinet.

The isolation switch 01 has the same structure and beneficial effects as the airtight handle assembly 401 in the foregoing embodiments. The structure and the beneficial effects of the airtight handle assembly 401 have been described in detail in the foregoing embodiments and will not be repeated herein.

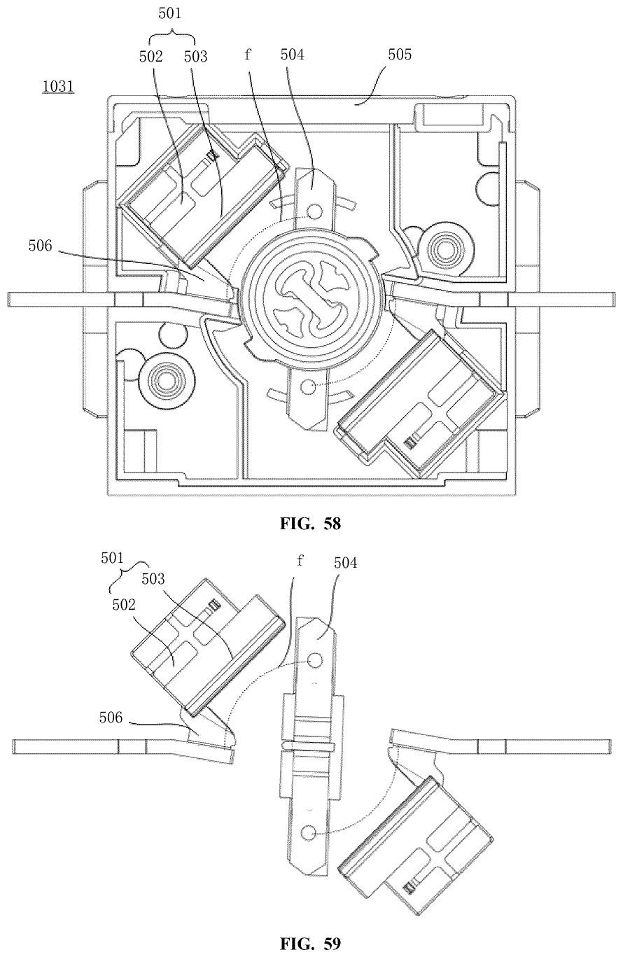

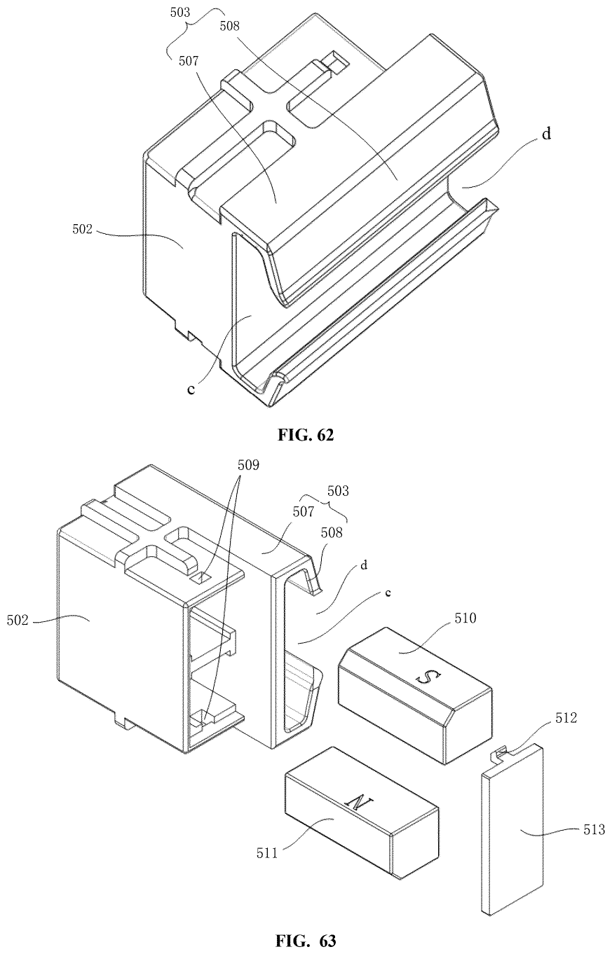

In conjunction with FIG. 1, and FIG. 57 to FIG. 65, a switch appliance is provided. The switch appliance can be the foregoing isolation switch 01, and the switch appliance includes the operation mechanism and the switch unit 1031, so that the operation mechanism controls the switching-off and switching-on actions for the switch unit 1031, so as to improve the accuracy and reliability of the switching-off and switching-on actions of the switch unit 1031. Exemplarily, the switch appliance can be a rotary switch, the isolation switch 01, or a circuit breaker. During the actual manufacturing process, the switch unit 1031 can be fixedly arranged on one side of the operation mechanism. The fixing method between the operation mechanism and the switch unit 1031 can be a detachable connection or a non-detachable connection. Exemplarily, the detachable connection can be a screw connection, a snap connection, and a splicing connection. It should be understood that the operation mechanism in the embodiment can be the foregoing operation mechanism 102 capable of being operated at multiple sides. Therefore, when it is without conflict, the foregoing description (e.g., FIG. 1 to FIG. 18) relative to the operation mechanism 102 capable of being operated at multiple sides can be incorporated into the embodiment; the foregoing descriptions (e.g., FIG. 19 to FIG. 35) relative to the electrical operation structure 201 can also be incorporated into the embodiment; the foregoing descriptions (e.g., FIG. 36 to FIG. 43) relative to the signal triggering structure 313 can also be incorporated into the embodiment; the foregoing descriptions (e.g., FIG. 44 to FIG. 50) relative to the operation handle 402 can also be incorporated into the embodiment; and the foregoing descriptions (e.g., FIG. 51 to FIG. 56) relative to the airtight handle assembly 401 can also be incorporated into the embodiment.

When a plurality of switch units 1031 are provided, and the plurality of switch units 1031 are sequentially arranged in the stacked manner. Each switch unit 1031 is provided with an independent contact assembly 601 therein, so that each switch unit 1031 can access one circuit, and carry out the on/off control for the accessed circuit. During the process that the operation mechanism controls the switching-off and switching-on actions for the switch unit 1031, the operation mechanism needs to be drivingly connected to the moving contact 504 of each switch unit 1031, so that the operation mechanism drives the moving contacts 504 of the plurality of switch units 1031 to move synchronously, so as to realize the consistency of the switching-off and switching-on states for each switch unit 1031, i.e., under the control of the operation mechanism, all switch units 1031 are in the switching-off state at the same time, or all switch units 1031 are in the switching-on state at the same time. As for the actual amounts of switch units 1031, the person skilled in the art can make a reasonable selection and design according to the actual situations, and it only needs that the switch units 1031 can satisfy the actual needs of the accessed circuit. For example, the amounts of the switch units 1031 can be 4, 6, 8, 10, or 12, which is not specifically limited herein.

As for the actual amounts of contact assemblies 601 arranged inside each switch unit 1031, it can be 1 group, 2 groups, 3 groups, or multiple groups (each group of contact assemblies 601 includes one moving contact 504 and one static contact 506). As for different numbers of groups, the accessed circuit can correspondingly form a single breakpoint, double breakpoints, triple breakpoints, and multiple breakpoints when disconnected. The person skilled in the art shall make a reasonable selection and design according to the actual situations, and it only needs that the switch units 1031 can satisfy the actual needs of the accessed circuit, which is not specifically limited herein. Exemplarily, as shown in FIG. 57 to FIG. 61, in the embodiment, each switch unit 1031 includes two groups of contact assemblies 601, wherein the moving contacts 504 of two groups of contact assemblies 601 are integrated on the same support frame of the moving contact 504. The static contacts 506 of two groups of contact assemblies 601 are arranged in a centrally symmetric manner on opposite sides of the unit housing 505 respectively, so that moving contact 504 cooperates with the static contact 506 located on one side of the housing, and the other moving contact 504 cooperates with the static contact 506 located on the other side of the housing, so as to form a double-breakpoint structure.

Specifically, as shown in FIG. 57 to FIG. 65, the switch unit 1031 provided by the embodiments of the present disclosure includes the unit housing 505, the moving contact 504 rotationally arranged in the unit housing 505, and the static contact 506 and the magnetic assembly 501 fixedly arranged in the unit housing 505 respectively; the moving contact 504 rotates relative to the unit housing 505 to form the curved rotation path f cooperating with the switching off and the switching on of the static contact 506; and the magnetic assembly 501 is located at the outer side of the curved rotation path f, wherein the magnetic assembly 501 includes the first housing 502 and the magnet fixedly arranged in the first housing 502; the bending plate 503 is arranged on the first housing 502; and the outer wall of the first housing 502 cooperates with the inner wall of the bending plate 503 to form the airflow channel c, wherein the airflow channel c is located on the curved rotation path f for blowing away the airflow of the electric arc between the moving contact 504 and the static contact 506. The switch unit 1031 can improve the arc extinguishing effect through the cooperative action of the magnetic field and the airflow, so as to effectively improve the performances of the switch unit 1031 and the switch appliance.

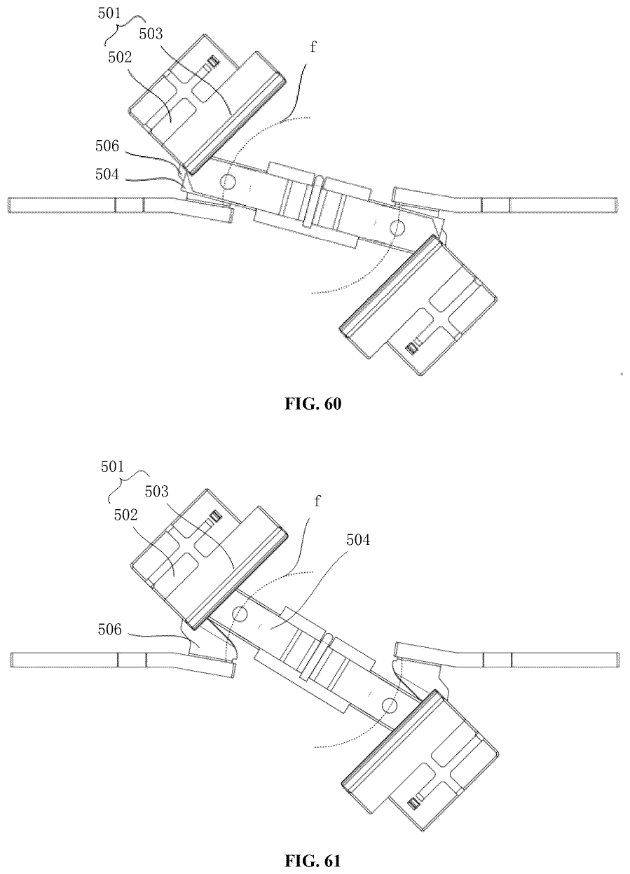

It is to be noted that as shown in FIG. 59 to FIG. 61, when the moving contact 504 rotates relative to the unit housing 505 toward one side away from the static contact 506, it can cooperate with the static contact 506 to realize the switching off; and when the moving contact 504 rotates relative to the unit housing 505 toward one side close to the static contact 506, it can cooperate with the static contact 506 to realize the switching on. The static contact 506 needs to include a part located on the curved rotation path f, so as to realize the above switching-off and switching-on processes. During the switching-off and switching-on processes between the moving contact 504 and the static contact 506, the moving contact 504 forms the curved rotation path f. The curved rotation path f formed by the moving contact 504 should include the curved rotation path f when switching off and the curved rotation path f when switching on. Both of them can be connected and not coincide, so as to correspond to the unidirectional rotation of the moving contact 504; or both of them can completely coincide, so as to correspond to the bidirectional rotation (or reciprocal rotation) of the moving contact 504. The person skilled in the art shall make a reasonable selection and design according to the actual situations, and it only needs that the switch units 1031 can satisfy the actual needs of the accessed circuit, which is not specifically limited herein.

As shown in FIG. 59 to FIG. 61, the magnetic assembly 501 is arranged on the outer side of the curved rotation path f. In other words, the magnetic assembly 501 is located on one side of the curved rotation path f departing from the rotation center of the curved rotation path f. The magnetic assembly 501 includes the magnet, so as to correspond to the region of the electric arc generated by the moving contact 504 and the static contact 506 by the magnetic field generated by the magnet, so that the magnetic field generated by the magnet can direct and stretch the electric arc, and thereby it can be extinguished. Additionally, as shown in FIG. 62 to FIG. 65, the magnetic assembly 501 further includes the first housing 502 (i.e., the housing for accommodating the magnet). On the one hand, the first housing 502 can provide a support effect on the magnet, so that the magnet can be mounted and fixed in the unit housing 505; and on the other hand, the first housing 502 is provided with the bending plate 503, wherein the outer wall of the first housing 502 cooperates with the inner wall (i.e., the wall surface of the bending plate 503 toward the first housing 502) of the bending plate 503 to form the airflow channel c. The airflow channel c is located on the curved rotation path f for blowing away the airflow of the electric arc between the moving contact 504 and the static contact 506, so that the airflow cooperates with the magnetic field to further direct and stretch the electric arc, and thereby it can be accelerated to extinguish. The first housing 502 can be made of a non-magnetic material that can produce gas and resist high temperatures, so that the first housing produces the gas blowing out the electric arc; it can further avoid the first housing 502 from burning out since the temperature rise is too high when the moving contact 504 and the static contact 506 are switching-off or switching-on; and it can further avoid the material of the first housing 502 from interfering with the magnetic field generated by the magnet. Additionally, the first housing 502 can further be made of the insulating material, so as to avoid the contact of the electric arc between the magnet and the moving contact 504 and the static contact 506.

As for the correspondence relationship for the actual amounts between the contact assemblies 601 and magnetic assemblies 501 arranged in each switch unit 1031, as shown in FIG. 57 to FIG. 61, in the embodiment, each switch unit 1031 includes two groups of contact assemblies 601, wherein the moving contacts 504 of two groups of contact assemblies 601 are integrated on the same support frame of the moving contact 504, and the static contacts 506 of two groups of contact assemblies 601 are arranged in a centrally symmetric manner on opposite sides of the unit housing 505 respectively, so that one moving contact 504 cooperates with the static contact 506 located on one side of the housing, and the other moving contact 504 cooperates with the static contact 506 located on the other side of the housing. At this time, two magnetic assemblies 501 are also provided, wherein magnetic assemblies 501 correspondingly cooperate with two groups of the contact assemblies 601. In other words, the actual amounts of magnetic assemblies 501 and the actual amounts of contact assemblies 601 shall be set in one-to-one correspondence.

As shown in FIG. 62 to FIG. 65, in the embodiment, two bending plates 503 are provided, wherein two bending plates 503 are oppositely arranged on two sides of the first housing 502 along the rotation axial direction e of the moving contact 504, and two adjacent side edges of two bending plates 503 cooperate to form the rotation channel d for the moving contact 504 to pass through. On the one hand, it can avoid the bending plates 503 from interfering with the switching-off and switching-on movement processes of the moving contact 504 and the static contact 506, and on the other hand, it can ensure that the airflow can be gathered in the airflow channel c as much as possible, which avoid gaps between the other components flowing into the unit housing 505 or gaps between the other components and the unit housing 505.

Specifically, as shown in FIG. 62 to FIG. 65, in the embodiment, each bending plate 503 includes the first plate body 507 fixedly connected to the first housing 502 and the second plate body 508 fixedly connected to the first plate body 507, wherein the first plate bodies 507 of two bending plates 503 both extend toward one side close to the rotation axial direction e of the moving contact 504, and the second plate bodies 508 of two bending plates 503 both extend toward one side close to each other.

It is to be noted that since the first housing 502 and the magnet of the magnetic assembly 501 are both located on the outer side of the curved rotation path f, the first plate bodies 507 of two bending plates 503 both extend toward one side close to the rotation axial direction e of the moving contact 504, so as to ensure that the airflow channel c cooperatively formed by the first housing 502 and the bending plates 503 can be located on the curved rotation path f. The second plate bodies 508 of two bending plates 503 both extend toward one side close to each other. Therefore, through providing the rotation channel d cooperatively formed by two bending plates 503, it can ensure the smooth switching off and switching on for the moving contact 504 and the static contact 506, and can ensure that the airflow in the airflow channel c flows out as little as possible via the rotation channel d.

In the direction from the first housing 502 to the rotation center of the curved rotation path f, the width of the airflow channel c is determined by the width of the first plate body 507; in the rotation axial direction e of the moving contact 504, the width of the rotation channel d is determined by the spacing between two adjacent side edges of two second plate bodies 508; and in the direction of the curved rotation path f, the lengths of the airflow channel c and the rotation channel d are determined by the lengths of the first housing 502, the first plate body 507, and the second plate body 508. The person skilled in the art shall make a reasonable selection and design according to the actual situations, and it only needs that the switch units 1031 can satisfy the actual needs of the accessed circuit, which is not specifically limited herein.

As shown in FIG. 63, in the embodiment, the magnet includes the first magnet 510 and the second magnet 511, wherein the first magnet 510 and the second magnet 511 are arranged in the first housing 502 in the stacked manner along the rotation axial direction e of the moving contact 504, and the magnetic pole of the first magnet 510 close to the second magnet 511 has the same magnetism with the magnetic pole of the second magnet 511 close to the first magnet 510, or the magnetic pole of the first magnet 510 close to the second magnet 511 has the opposite magnetism with the magnetic pole of the second magnet 511 close to the first magnet 510. The arrangement manner of the magnetic poles of the first magnet 510 and the second magnet 511 is only for illustrative purposes only and does not serve as a limitation.

Optionally, one side of the magnet close to the curved rotation path f is curved or planar, and the sides of the first housing 502 and the bending plate 503 close to the curved rotation path f both need to match to one side of the magnet close to the curved rotation path f. When one side of the magnet close to the curved rotation path f is an arc surface, the magnetic field generated by the magnet can more comprehensively cover the electric arc region generated by the moving contact 504 and the static contact 506, so as to accelerate the speed of the electric arc extinguishing.

As shown in FIG. 57 to FIG. 61, in the embodiment, the magnetic assembly 501 is located on one side close to the static contact 506, and the static contact 506 includes the extension part extending into the airflow channel c and being located on the curved rotation path f. In other words, the static contact 506 includes the extension part, wherein the extension part extends into the airflow channel c, and the extension part is located on the curved rotation path f. The extension part is located on the curved rotation path f, which ensures that the moving contact 504 and the static contact 506 can be smoothly switching-off and switching-on. The extension part extends into the airflow channel c, so that the static contact 506 and the moving contact 504, which moves about to come into contact with (or about to come out of contact with) the static contact 506, can be close to magnetic assembly 501 as possible, so that the electric arc generated by moving contact 504 and static contact 506 can smoothly enter into the airflow channel c by the entrance of the airflow channel c (one end of the airflow channel c close to the static contact 506), and thereby the airflow can accurately act on the electric arc to accelerate its extinction. It is to be noted that the arrangement position of the magnetic assembly 501 further needs to avoid interference with the movement process of the switching off and switching on of the moving contact 504 and the static contact 506. Exemplarily one side of the static contact 506 close to the magnetic assembly 501 and one side of the moving contact 504 that moves about to come into contact with (or about to come out of contact with) the static contact 506 close to the magnetic assembly 501 can be attached to one side of the airflow channel c close to magnetic as possible.

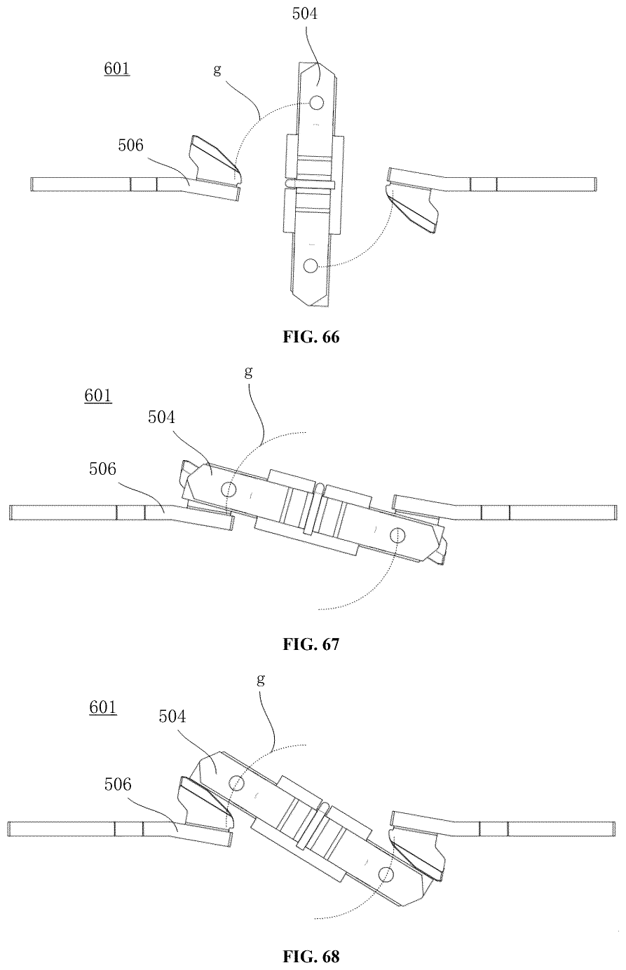

As shown in FIG. 65, in the embodiment, the position limitation part 41 is arranged in the first housing 502, wherein the position limitation part 41 is configured to limit the movement of the magnet inserted into the first housing 502. The shape of the magnet needs to be matched with that of the accommodation chamber in the first housing 502, so that the operator can accurately assemble the magnet into the first housing 502 under the action of the position limitation part 41, so as to satisfy the requirement of the magnetism between the magnetic poles close to each other of two magnets.

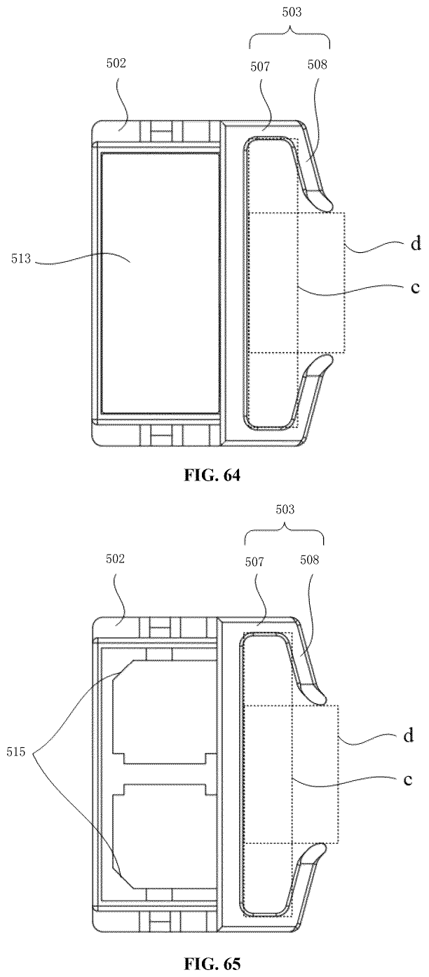

As shown in FIG. 63 and FIG. 64, in the embodiment, the magnetic assembly 501 further includes the cover plate 513, and the first housing 502 is provided with the opening, wherein the magnet passes through the opening to be accommodated in the first housing 502, and the cover plate 513 covers the first housing 502 to seal the opening, so that the first housing 502 and the cover plate 513 can cooperate to protect the magnet from being damaged.

As shown in FIG. 63, in the embodiment, the first housing 502 is provided with the first snapping part 509; the cover plate 513 is provided with the second snapping part 512; and the second snapping part 512 is snapped to the first snapping part 509, so that the cover plate 513 is snapped and fixed to the first housing 502, so that the first housing 502 and the cover plate 513 can be easily disassembled, which is facilitate to the disassembling and replacing of the magnet and the first housing 502.

Referring to FIG. 1, and FIG. 66 to FIG. 73, a switch appliance, a switch unit 1031 that can be applied to the switch appliance, and a contact structure applied to the switch unit 1031 are provided. The switch appliance can be the foregoing isolation switch 01, and the switch appliance includes the operation mechanism and the switch unit 1031, so that the operation mechanism controls the switching-off and switching-on actions for the switch unit 1031, so as to improve the accuracy and reliability of the switching-off and switching-on actions of the switch unit 1031. Exemplarily, the switch appliance can be the rotary switch, the isolation switch 01, or the circuit breaker. During the actual manufacturing process, the switch unit 1031 can be fixedly arranged on one side of the operation mechanism. The fixing method between the operation mechanism and the switch unit 1031 can be the detachable connection or the non-detachable connection. Exemplarily, the detachable connection can be the screw connection, snap connection, and splicing connection. It should be understood that the operation mechanism in the embodiment can be the foregoing operation mechanism 102 capable of being operated at multiple sides. Therefore, without conflict, the foregoing descriptions (e.g., FIG. 1 ho FIG. 18) relative to the operation mechanism 102 capable of being operated at multiple sides can be incorporated into the embodiment; the foregoing descriptions (e.g., FIG. 19 to FIG. 35) relative to the electrical operation structure 201 can also be incorporated into the embodiment; the foregoing descriptions (e.g., FIG. 36 to FIG. 43) relative to the signal triggering structure 313 can also be incorporated into the embodiment; the foregoing descriptions (e.g., FIG. 44 to FIG. 50) relative to the operation handle 402 can also be incorporated into the embodiment; the foregoing descriptions (e.g., FIG. 51 to FIG. 56) relative to the airtight handle assembly 401 can also be incorporated into the embodiment; and the foregoing descriptions (e.g., FIG. 57 to FIG. 65) relative to the magnetic assembly 501 of the switch unit 1031) can further be combined with the present example.

When the plurality of switch units 1031 are provided, and the plurality of switch units 1031 are sequentially arranged in the stacked manner. Each switch unit 1031 is provided with the independent contact assembly 601 therein, so that each switch unit 1031 can access one circuit, and carry out the on/off control for the accessed circuit. During the process that the operation mechanism controls the switching-off and switching-on actions for the switch unit 1031, the operation mechanism needs to be drivingly connected to the moving contact 504 of each switch unit 1031, so that the operation mechanism drives the moving contacts 504 of the plurality of switch units 1031 to move synchronously, so as to realize the consistency of the switching-off and switching-on states for each switch unit 1031, i.e., under the control of the operation mechanism, all switch units 1031 are in the switching-off state at the same time, or all switch units 1031 are in the switching-on state at the same time. As for the actual amounts of switch units 1031, the person skilled in the art can make a reasonable selection and design according to the actual situations, and it only needs that the switch units 1031 can satisfy the actual needs of the accessed circuit. For example, the number of the switch units 1031 can be 4, 6, 8, 10, or 12, which is not specifically limited herein.

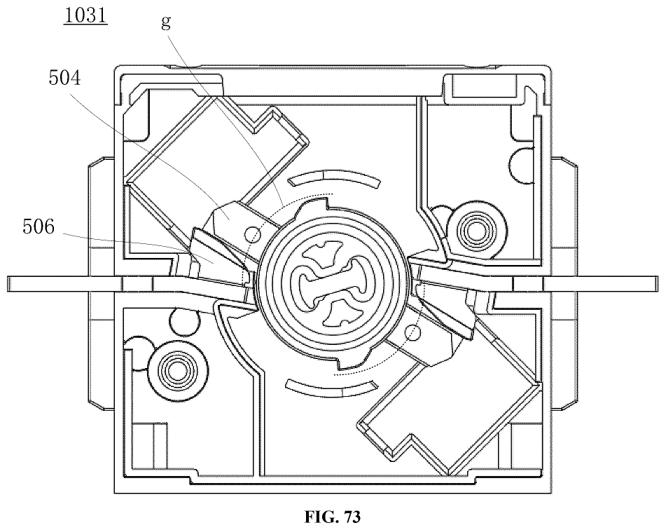

As for the actual amounts of contact assemblies 601 arranged inside each switch unit 1031, it can be 1 group, 2 groups, 3 groups, or multiple groups (each group of contact assemblies 601 includes one moving contact 504 and one static contact 506). As for different numbers of groups, the accessed circuit can correspondingly form the single breakpoint, double breakpoints, triple breakpoints, and multiple breakpoints when disconnected. The person skilled in the art shall make a reasonable selection and design according to the actual situations, and it only needs that the switch units 1031 can satisfy the actual needs of the accessed circuit, which is not specifically limited herein. Exemplarily, as shown in FIG. 73, in the embodiment, each switch unit 1031 includes the housing (which can be the unit housing 505 in the foregoing embodiment) and 2 groups of contact assemblies 601, wherein the moving contacts 504 of 2 groups of contact assemblies 601 are integrated on the same support frame of the moving contact 504, so that moving contacts 504 is rotationally mounted in the housing; and the static contacts 506 of 2 groups of contact assemblies 601 are fixedly mounted on opposite two sides of the housing, so that one moving contact 504 cooperates with the static contact 506 located on one side of the housing, and the other moving contact 504 cooperates with the static contact 506 located on the other side of the housing, so as to form the double-breakpoint structure.

Specifically, as shown in FIG. 66 to FIG. 72, the contact assembly 601 provided by the embodiments of the present disclosure includes the moving contact 504 and the static contact 506, and the moving contact 504 is driven to rotate to cooperate with the static contact 506 for switching on and switching off, wherein when the moving contact 504 and the static contact 506 switch between the states of the switching off and the switching on, one side of the moving contact 504 contacting the static contact 506 and one side of the static contact 506 contacting the moving contact 504 are parallel to each other or basically parallel. The contact assembly 601 can increase the contact area between the moving contact 504 and the static contact 506 when they are in the switching-off or switching-on state, so as to avoid the fusion welding phenomenon due to the problems of excessive current density and rapid temperature rise at the contact point, thereby effectively improving the performances of the contact assembly 601, the switch unit 1031, and the switch appliance.

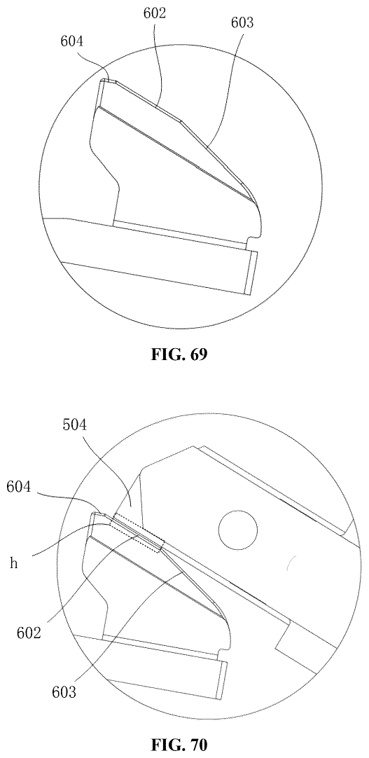

It should be noted that as shown in FIG. 66, when rotating clockwise along the rotation direction g of the moving contact 504, the moving contact 504 moves relative to static contact 506 to the position away from the static contact 506, so as to cooperate with static contact 506 to realize the switching off. As shown in FIG. 67, when rotating counterclockwise along the rotation direction g of the moving contact 504, the moving contact 504 moves relative to static contact 506 to the position close to the static contact 506, so as to cooperate with static contact 506 to realize the switching on. During the above switching process between the switching-off and switching-on states of the moving contact 504 and the static contact 506, the contact assembly 601 further includes two critical states. One critical state is that the moving contact 504 and the static contact 506, which were originally in the switching-off state, are about to be switching-on; and the other critical state is that the moving contact 504 and the static contact 506, which were originally in the switching-on state, are about to be switching-off, wherein the position relationship between the moving contact 504 and the static contact 506 is shown in FIG. 68.

In the existing products, the contact surface of the moving contact 504 and the static contact 506 protrudes toward one side close to each other respectively. Therefore, when the moving contact 504 and static contact 506 switch between the switching-off state and the switching-on state, the contact manner between them is a “point contact”, which has a problem of the excessive current density at the contact point, thereby resulting in the rapid temperature rise at the contact point. It is very easy to occur the fusion welding phenomenon, thereby affecting the performance of the switch appliance.

In order to solve this problem, the present disclosure provides the contact assembly 601. When the moving contact 504 and static contact 506 switch between the switching-off state and the switching-on state, one side of the moving contact 504 contacting the static contact 506 and one side of the static contact 506 contacting the moving contact 504 are parallel to each other or substantially parallel to each other. Therefore, when the moving contact 504 and static contact 506 switch between the switching-off state and the switching-on state, the contact manner between them changes from the “point contact” to the “surface contact”, so that the contact area of the contact region h is increased, so as to avoid the fusion welding phenomenon due to the problems of excessive current density and rapid temperature rise at the contact point, thereby effectively improving the performances of the contact assembly 601, the switch unit 1031, and the switch appliance.

It is worth noting that in the actual production and manufacturing process, one side of the moving contact 504 contacting the static contact 506 and one side of the static contact 506 contacting the moving contact 504 can be absolutely parallel, or can be basically parallel (or approximately parallel), which can both increase the contact area of the contact region h between them, so as to solve the problems in the prior art of the excessive current density and rapid temperature rise at the contact point, The person skilled in the art shall make a reasonable selection and design according to the actual situations, it only needs that one side of the moving contact 504 contacting the static contact 506 and one side of the static contact 506 contacting the static contact 504 are both in the error range allowed by the production process, which is not limited herein.

As shown in FIGS. 69 and FIG. 70, in the embodiment, one side of the static contact 506 contacting the moving contact 504 includes the first contact segment 602 and the second contact segment 603 connected to the first contact segment 602, wherein when the moving contact 504 and the static contact 506 switch between the states of the switching off and the switching on, one side of the moving contact 504 contacting the static contact 506 and the first contact segment 602 are parallel to each other or basically parallel, and spacing between one side of the second contact segment 603 close to the first contact segment 602 and the moving contact 504 is smaller than spacing between one side of the second contact segment 603 away from the first contact segment 602 and the moving contact 504, so as to avoid that the break electric arc between the moving contact 504 and the static contact 506 appears on the second contact segment 603.

The longer the length of the first contact segment 602 is, the larger the contact area between the moving contact 504 and the static contact 506 is when they switch between the switching-off state and the switching-on state. As for the actual length of the first contact segment 602, the person skilled in the art shall make a reasonable selection and design according to the actual situations, which is not limited herein.

Further, as shown in FIG. 69 to FIG. 71, in the embodiment, one side of the static contact 506 contacting the moving contact 504 further includes the third contact segment 604 connected to the first contact segment 602, wherein the third contact segment 604 is located on one side of the first contact segment 602 away from the second contact segment 603. In other words, one side of the first contact segment 602 away from the second contact segment 603 is further provided with the third contact segment 604. When the moving contact 504 and static contact 506 switch between the switching-off state and the switching-on state, the spacing between one end of the third contact segment 604 close to the first contact segment 602 and the moving contact 504 is smaller than the spacing between one side of the third contact segment 604 away from the second contact segment 603 and the moving contact 504, so as to avoid the tip discharge phenomenon since the static contact 506 is too tip.

As shown in FIG. 70, in the embodiment, the spacing between the second contact segment 603 and the moving contact 504 is gradually increased along one side of the second contact segment 603 close to the first contact segment 602 to one side of the second contact segment 603 away from the first contact segment 602. Optionally, one side of the second contact segment 603 close to the moving contact 504 is a plane or an arc surface. Optionally, the arc surface protrudes toward one side close to the moving contact 504, so as to avoid the electric arc reignition between the second contact segment 603 and the moving contact segment 504 just after the switching off of the moving contact 504 and the static contact 506 which were originally in the switching-on state.

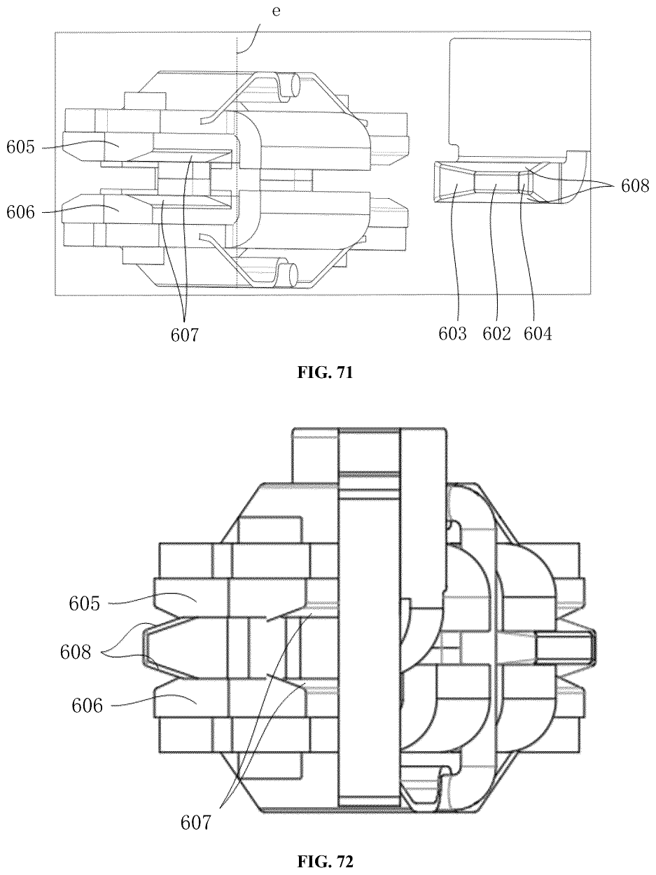

As shown in FIG. 71, in the embodiment, the moving contact 504 includes the first contact sheet 605 and the second contact sheet 606, and the first contact sheet 605 and the second contact sheet 606 are arranged in a stacked manner in the rotation axial direction e of the moving contact 504. The moving contact 504 is driven to rotate, so that the static contact 506 is clamped between the first contact sheet 605 and the second contact sheet 606, so that the contact between the moving contact 504 and the static contact 506 is more stable and reliable.

In the existing product, the spacing between the first contact sheet 605 and the second contact sheet 606 of the moving contact 504 is equal to the thickness of the static contact 506 in the rotation axial direction e of the moving contact 504, so that when the moving contact 504 and static contact 506 switch between the switching-off state and the switching-on state, they are easy to bounce, which affects the performance of the switch appliance.

As shown in FIG. 71 and FIG. 72, in the embodiment, the first guide part 607 is arranged on one side of the first contact sheet 605 close to the second contact sheet 606 and/or on one side of the second contact sheet 606 close to the first contact sheet 605, wherein the first guide part 607 is configured to guide the static contact 506 extending between the first contact sheet 605 and the second contact sheet 606. The spacing between two first guide parts 607, between the first guide part 607 on the first contact sheet 605 and one side of the second contact sheet 606 close to the first contact sheet 605, or between one side of the first contact sheet 605 close to the second contact sheet 606 and the first guide part 607 on the second contact sheet 606, is larger than the thickness of the static contact 506 in the rotation axial direction e of the moving contact 504, so that the static contact 506 can smoothly extend between the first contact sheet 605 and the second contact sheet 606, so as to avoid the bounce phenomenon between the moving contact 504 and the static contact 506, which affects the on-off control of the switch unit 1031 to the accessed circuit.

As shown in FIG. 71 and FIG. 72, in the embodiment, the second guide part 608 is arranged on one side of the static contact 506 close to the first contact sheet 605 and/or one side of the static contact 506 close to the second contact sheet 606, wherein the second guide part 608 is adapted to the first guide part 607, so as to cooperate together to guide the static contact 506 when extends between the first contact sheet 605 and the second contact sheet 606. The spacing between two second guide parts 608, the second guide part 608 arranged on one side of the static contact 506 close to the first contact sheet 605 and one side of the static contact 506 close to the second contact sheet 606, or between one side of the static contact 506 close to the first contact sheet 605 and the second guide part 608 arranged on one side of the static contact 506 close to the second contact sheet 606, is smaller than the spacing between the first contact sheet 605 (the first guide part 607) and the second contact sheet 606 (the first guide part 607), so that the static contact 506 can smoothly extend between the first contact sheet 605 and the second contact sheet 606, so as to further avoid the bounce phenomenon between the moving contact 504 and the static contact 506, which affects the on-off control of the switch unit 1031 to the accessed circuit.

Referring to FIG. 1 to FIG. 73, an isolation switch 01 and each assembly applied to the isolation switch 01 are provided, wherein the isolation switch 01 includes the operation mechanism 102 capable of being operated at multiple sides. The operation mechanism 102 capable of being operated at multiple sides includes the holding assembly, the base 105, and the front operation assembly 104 and the side operation assembly 101 rotationally arranged on the base 105, wherein the front operation assembly 104 is in linkage with the side operation assembly 101 by the transmission member 110 to be synchronously on the switching-off or switching-on position. It should be understood that the operation mechanism 102 capable of being operated at multiple sides in the embodiment can be the foregoing operation mechanism 102 capable of being operated at multiple sides. Therefore, when it is without conflict, the foregoing description (e.g., FIG. 1 to FIG. 18) relative to the operation mechanism 102 capable of being operated at multiple sides can be incorporated into the embodiment; the foregoing descriptions (e.g., FIG. 19 to FIG. 35) relative to the electrical operation structure 201 can also be incorporated into the embodiment; the foregoing descriptions (e.g., FIG. 36 to FIG. 43) relative to the signal triggering structure 313 can also be incorporated into the embodiment; the foregoing descriptions (e.g., FIG. 44 to FIG. 50) relative to the operation handle 402 can also be incorporated into the embodiment; the foregoing descriptions (e.g., FIG. 51 to FIG. 56) relative to the airtight handle assembly 401 can also be incorporated into the embodiment; and the foregoing descriptions (e.g., FIG. 57 to FIG. 65) relative to the magnetic assembly 501 of the switch unit 1031) can further be combined with the present example; and the foregoing descriptions (e.g., FIG. 66 to FIG. 73) relative to the magnetic assembly 601 of the switch unit 1031) can further be combined with the present example.

The foregoing is merely preferable embodiments of the present disclosure, and is not intended to limit the present disclosure. For those skilled in the art, the present disclosure may have various changes and variations. Any modifications, equivalent substitutions, improvements, etc. made within the spirit and principles of the present disclosure shall be included in the scope of protection of the present disclosure.

### INDUSTRIAL APPLICABILITY

The present disclosure provides an operation mechanism capable of being operated at multiple sides, an isolation switch, and a switch appliance, wherein the user can perform corresponding operation on the operation mechanism capable of being operated at multiple sides on different sides of the isolation switch, so as to realize the switching-on and switching-off control of the isolation switch. On this basis, each operation assembly and transmission member in the operation mechanism capable of being operated at multiple sides can keep a stable and reliable transmission relationship in the present disclosure, and then the problem of transmission failure or even jamming caused by the fact that the transmission member moves excessively to be separated from the operation assembly is avoided. The operation mechanism capable of being operated at multiple sides, isolation switch and switch appliance in the present disclosure can be applied to the construction field, the electric power field, and the industrial field.

1. An isolation switch, comprising an operation mechanism capable of being operated at multiple sides, wherein the operation mechanism capable of being operated at multiple sides comprises a holding assembly, a base, and a front operation assembly and a side operation assembly rotationally arranged on the base, wherein the front operation assembly and the side operation assembly are synchronously in a switching-off or switching-on position by a linkage of a transmission member, and the holding assembly limits the transmission member and the side operation assembly to keep a transmission relationship.

2. The isolation switch according to claim 1, wherein the isolation switch further comprises a switch unit, and the switch unit comprises a unit housing, a moving contact rotationally arranged in the unit housing, and a static contact and a magnetic assembly fixedly arranged in the unit housing respectively, wherein the moving contact rotates relative to the unit housing to form a curved rotation path that cooperates with the static contact to be switching-off and switching-on, and the magnetic assembly is located at an outer side of the curved rotation path, wherein the magnetic assembly comprises a first housing and a magnet fixedly arranged in the first housing; a bending plate is arranged on the first housing; and an outer wall of the first housing cooperates with an inner wall of the bending plate to form an airflow channel, wherein the airflow channel is located on the curved rotation path for blowing away an airflow of electric arc between the moving contact and the static contact.

3. The isolation switch according to claim 2, wherein two bending plates are provided, wherein the two bending plates are oppositely arranged on two sides of the first housing along a rotation axial direction of the moving contact, and two adjacent side edges of the two bending plates cooperate to form a rotation channel for the moving contact to pass through.

4. The isolation switch according to claim 3, wherein each of the bending plates comprises a first plate body fixedly connected to the first housing and a second plate body fixedly connected to the first plate body, wherein first plate bodies of the two bending plates both extend toward one side close to the rotation axial direction of the moving contact, and second plate bodies of the two bending plates both extend toward one side close to each other.

5. The isolation switch according to claim 2, wherein the magnet comprises a first magnet and a second magnet, wherein the first magnet and the second magnet are arranged in the first housing in a stacked manner along the rotation axial direction of the moving contact, and a magnetic pole of the first magnet close to the second magnet has the same magnetism with a magnetic pole of the second magnet close to the first magnet.

6. The isolation switch according to claim 2, wherein the magnetic assembly is located on one side close to the static contact, and the static contact comprises an extension part extending into the airflow channel and being located on the curved rotation path.

7. The isolation switch according to claim 2, wherein a position limitation part is arranged in the first housing, wherein the position limitation part is configured to limit a movement of the magnet inserted into the first housing; the magnetic assembly further comprises a cover plate; and the first housing is provided with an opening, wherein the magnet passes through the opening to be accommodated in the first housing, and the cover plate covers the first housing to seal the opening.

8. The isolation switch according to claim 1, wherein the isolation switch further comprises the switch unit comprising a second housing and a contact assembly, wherein a moving contact of the contact assembly is rotationally mounted in the second housing, and a static contact of the contact assembly is fixedly mounted in the second housing, wherein the contact assembly comprises the moving contact and the static contact, and the moving contact is driven to rotate to cooperate with the static contact for switching off and switching on, wherein when the moving contact and the static contact switch between states of the switching off and the switching on, one side of the moving contact for contacting the static contact and one side of the static contact for contacting the moving contact are parallel to each other or basically parallel.

9. The isolation switch according to claim 8, wherein the one side of the static contact for contacting the moving contact comprises a first contact segment and a second contact segment connected to the first contact segment, wherein when the moving contact and the static contact switch between the states of the switching off and the switching on, the one side of the moving contact for contacting the static contact and the first contact segment are parallel to each other or basically parallel, and spacing between one side of the second contact segment close to the first contact segment and the moving contact is smaller than spacing between one side of the second contact segment away from the first contact segment and the moving contact.

10. (canceled)

11. The isolation switch according to claim 9, wherein the one side of the static contact for contacting the moving contact further comprises a third contact segment connected to the first contact segment, wherein the third contact segment is located on one side of the first contact segment away from the second contact segment, and when the moving contact and the static contact switch between the states of the switching off and the switching on, spacing between one end of the third contact segment close to the first contact segment and the moving contact is smaller than spacing between one side of the third contact segment away from the second contact segment and the moving contact.

12. The isolation switch according to claim 1, wherein the isolation switch further comprises an electrical operation module sequentially connected to the operation mechanism, wherein the electrical operation module drives the operation mechanism to act; the electrical operation module is in transmission with the operation mechanism by a splicing structure; and the electrical operation module comprises a motor, a gear assembly, and a shaft assembly connected sequentially, wherein the shaft assembly comprises a second shaft connected to the gear assembly and a first shaft connected to the operation mechanism, and the first shaft and the second shaft are coaxially connected; the motor drives the operation mechanism to act by the gear assembly, the second shaft, and the first shaft sequentially; and the first shaft is in linkage with a first microswitch and a second microswitch respectively, wherein when the isolation switch is switching-off or switching-on, the first microswitch or the second microswitch is configured to output signals to the motor, and the motor stops running.

13. The isolation switch according to claim 1, wherein the isolation switch further comprises a signal triggering structure, and the signal triggering structure comprises a third housing, and a rotary shaft and a third microswitch arranged in the third housing, wherein the third microswitch is fixedly connected to a side wall of the third housing; the rotary shaft is provided with a boss in a radial direction; and the third microswitch is provided with a button on a side surface for controlling opening and closing of the third microswitch, wherein the rotary shaft is driven to rotate the boss, and the boss pushes the button to press the button; a first sliding plate is arranged on one side of the rotary shaft corresponding to the boss; a side surface of the first sliding plate is provided with a pressing part; and the boss presses the button by the pressing part, wherein the boss is driven to rotate to push the first sliding plate to move in a direction away from the rotary shaft, so that the pressing part presses the button; and an elastic member is arranged between one side of the first sliding plate away from the rotary shaft and the housing, wherein when the boss pushes the first sliding plate to move in the direction away from the rotary shaft, the elastic member accumulates an elastic potential energy.

14. The isolation switch according to claim 1, wherein the isolation switch further comprises an operation handle, and the operation handle comprises a base, a first sealing member, a second sealing member, and a body rotationally connected to the base, wherein the base is fixedly connected to a cabinet body at one side away from the body and sealed by the first sealing member, and the second sealing member is arranged between the body and the base; one side of the body close to the base is provided with a limiting hole adapted to a main shaft of the isolation switch, and the base is provided with a first through hole communicated with the limiting hole and for the main shaft to pass through; and the body is driven to rotate on the base, and the main shaft can drive the isolation switch to switch on or switch off.

15. The isolation switch according to claim 14, wherein the operation handle further comprises a locking mechanism arranged on the body, and the locking mechanism is configured to lock or unlock the body; a blind hole is concavely arranged on one surface of the base close to the body, wherein when the isolation switch is at the switching-on position, a stopper of the locking mechanism passes through the body and is located outside the blind hole; and when the isolation switch is at the switching-off position, the stopper passes through the body and can at least partially extend into the blind hole to lock the body when driven, wherein the body is provided with an accommodation chamber and a stop hole communicated with the accommodation chamber; and the locking mechanism comprises a latch located in the accommodation chamber and rotationally connected to the body and the stopper passing through the stop hole, wherein when the isolation switch is at the switching-on position, one end of the stopper abuts against the latch, and the other end abuts against one surface of the base facing the body; when the body is driven to rotate so that the stop hole is corresponding to the blind hole, the latch is driven to rotate relative to the body; and when the isolation switch is at the switching-off position, the latch can drive the stopper to move towards the base and the stopper is partially snapped in the blind hole.

16. The isolation switch according to claim 1, wherein the isolation switch further comprises an airtight handle assembly, and the airtight handle assembly comprises an operation handle, a stopper, and at least two reset members, wherein one end of the reset members is fixed on the stopper and the other end is fixed on the operation handle; the operation handle is configured to drivingly connect to the operation mechanism, and the operation handle is provided with a through hole; and the stopper reciprocally slides in the through hole, and two ends of a sliding path of the stopper correspond to a first position and a second position respectively, wherein when the stopper is at the first position, the reset member is in a natural state, and the operation handle can rotate reciprocally, so as to switch between a switching-on state and a switching-off state; and
when the stopper leaves the first position, the reset member is compressed, and the operation handle is fixed by the stopper, wherein the stopper switches between the first position and the second position, so as to switch between a switching-off state and a switching-off padlock state, wherein a sealing structure is arranged between the stopper and the through hole, and the at least two reset members are evenly arranged around the sealing structure, wherein when the stopper switches between the first position and the second position, the sealing structure is at least partially located in the through hole and wraps the stopper, so to seal a gap between the stopper and the through hole.

17. An operation mechanism capable of being operated at multiple sides, comprising a base and a front operation assembly and a side operation assembly rotationally arranged on the base, wherein the front operation assembly is in linkage with the side operation assembly by a transmission member to be synchronously on a switching-off or switching-on position; and the base is provided with an elastic assembly cooperating with the transmission member, wherein the elastic assembly deforms to provide a force to the transmission member, so that the transmission member and the side operation assembly keep a transmission relationship.

18. The operation mechanism capable of being operated at multiple sides according to claim 17, wherein the side operation assembly is provided with a first transmission part, and the transmission member is provided with a first mating part cooperating with the first transmission part, wherein the side operation assembly is configured to drive the transmission member to slide relative to the base via the first transmission part and the first mating part cooperating with each other, and the elastic assembly is configured to abut against the transmission member to deform when the side operation assembly is at a switching-off position or a switching-on position, so that the first mating part cooperates with the first transmission part.

19. The operation mechanism capable of being operated at multiple sides according to claim 18, wherein the elastic assembly comprises a switching-on elastic assembly and a switching-off elastic assembly arranged on the base, wherein the switching-on elastic assembly is configured to provide a force to the transmission member when the side operation assembly is at the switching-on position, and the switching-off elastic assembly is configured to provide a force to the transmission member when the side operation assembly is at the switching-off position.

20. The operation mechanism capable of being operated at multiple sides according to claim 19, wherein the switching-on elastic assembly and the switching-off elastic assembly are separately located on two opposite sides of the transmission member, and both the switching-on elastic assembly and the switching-off elastic assembly are located on a sliding path of the transmission member.

21. The operation mechanism capable of being operated at multiple sides according to claim 18, wherein the first transmission part is a transmission groove arranged on the side operation assembly, and the first mating part is a protrusion arranged on the transmission member, wherein the side operation assembly drives the protrusion via a groove wall of the transmission groove, so as to drive the transmission member to slide relative to the base.

22. (canceled)

23. (canceled)

24. An operation mechanism capable of being operated at multiple sides, comprising a base and a front operation assembly and a side operation assembly rotationally arranged on the base, wherein the front operation assembly is in linkage with the side operation assembly by a transmission member to be synchronously on a switching-off or switching-on position; and the side operation assembly is provided with an abutting part cooperating with the transmission member, and the abutting part limits the transmission member and the side operation assembly to keep a transmission relationship.

25. The operation mechanism capable of being operated at multiple sides according to claim 24, wherein the side operation assembly is provided with a first transmission part with a transmission wall; the transmission member is provided with a first mating part; and the first mating part is provided with a mating wall cooperating with the transmission wall, wherein the side operation assembly is configured to drive the transmission member to slide relative to the base via the transmission wall and the mating wall cooperating with each other, and the abutting part is configured to abut against the transmission member when the side operation assembly is at the switching-off position or the switching-on position, so as to limit the mating wall to locate at a rotation path of the transmission wall.

26. The operation mechanism capable of being operated at multiple sides according to claim 25, wherein the abutting part comprises a switching-on abutting part and a switching-off abutting part separately arranged on the side operation assembly, wherein the switching-on abutting part is configured to abut against one end of the transmission member to limit a position when the side operation assembly is at the switching-on position, and the switching-off abutting part is configured to abut against the other end of the transmission member to limit a position when the side operation assembly is at the switching-off position.

27. (canceled)

28. The operation mechanism capable of being operated at multiple sides according to claim 24, wherein the abutting part is a protrusion lug, and an accommodating hole for accommodating the protrusion lug is arranged on the transmission member, wherein the protrusion lug is configured to abut against a hole wall of the accommodating hole when the side operation assembly is at the switching-off position or the switching-on position, so as to limit the transmission member and the side operation assembly to be in transmission.

29. The operation mechanism capable of being operated at multiple sides according to claim 24, wherein a rotation axis of the front operation assembly is perpendicular to that of the side operation assembly, and the front operation assembly comprises a rotary shaft rotationally arranged on the base and an extension member fixedly arranged on the rotary shaft, wherein the extension member is provided with a second transmission part, and the transmission member is provided with a second mating part cooperating with the second transmission part.

30-45. (canceled)
